(19) United States
(12) Patent Application Publication
(10) Pub. No.: US 2024/0027928 A1
(43) Pub. Date: Jan. 25, 2024

(54) ELECTROPHOTOGRAPHIC PHOTORECEPTOR, ELECTROPHOTOGRAPHIC PHOTORECEPTOR CARTRIDGE, AND IMAGE FORMING APPARATUS

(71) Applicant: Mitsubishi Chemical Corporation, Tokyo (JP)

(72) Inventors: Akira Ando, Tokyo (JP); Chiyoko Sato, Tokyo (JP)

(73) Assignee: Mitsubishi Chemical Corporation, Tokyo (JP)

(21) Appl. No.: 18/373,804

(22) Filed: Sep. 27, 2023

Related U.S. Application Data
(63) Continuation of application No. PCT/JP2022/014214, filed on Mar. 25, 2022.

(30) Foreign Application Priority Data
Mar. 30, 2021 (JP) 2021-056805

(51) Int. Cl. G03G 5/147; C08F 20/06

(52) U.S. Cl. CPC G03G 5/14734; G03G 5/14704; C08F 20/06

(57) ABSTRACT

An electrophotographic photoreceptor includes: a conductive support; a photosensitive layer on the conductive support; and a protective layer, for example, an outermost layer on a side opposite to the conductive support, wherein the protective layer contains a polymer having a structure represented by the following formula (a):

A¹-L¹-X-L²-A² (a).

### TECHNICAL FIELD

The present invention relates to an electrophotographic photoreceptor to be used in a copier, a printer, and the like, and a cartridge and an image forming apparatus using the same.

### BACKGROUND ART

In a printer, a copier, and the like, when a charged organic photoreceptor (OPC) drum is irradiated with light, a charge is eliminated from the portion to generate an electrostatic latent image, and a toner adheres to the electrostatic latent image, whereby an image can be obtained. In devices using such electrophotography, a photoreceptor is a basic member.

In this type of organic photoreceptor, a “function separate photoreceptor” in which functions of generating and moving negative charges are in the charge of separate compounds has been becoming mainstream because there is much room for material selection and characteristics of the photoreceptor are easy to control. For example, there has been known a single-layered electrophotographic photoreceptor (hereinafter, referred to as a “single-layered photoreceptor”) with a charge generation material (CGM) and a charge transport material (CTM) in the same layer, and a multi-layered electrophotographic photoreceptor (hereinafter, referred to as a multi-layered photoreceptor) in which a charge generation layer containing a charge generation material (CGM) and a charge transport layer containing a charge transport material (CTM) are laminated. Examples of a charging method for a photoreceptor include a negative charging method by which a photoreceptor surface is negatively charged and a positive charging method by which a photoreceptor surface is positively charged.

Examples of a combination of a layer configuration and a charging method for a photoreceptor currently in practical use include a “negatively charged multi-layered photoreceptor” and a “positively charged single-layered photoreceptor”. The “negatively charged multi-layered photoreceptor” generally has a configuration in which an undercoat layer (UCL) made of a resin, and the like is provided on a conductive substrate such as an aluminum tube, a charge generation layer (COL) made of a charge generation material (COM), a resin, and the like is provided thereon, and a charge transport layer (CTL) made of a hole transport material (HTM), a resin, and the like is further provided thereon.

On the other hand, the “positively charged single-layered photoreceptor” generally has a configuration in which an undercoat layer (UCL) made of a resin, and the like is provided on a conductive substrate such as an aluminum tube, and a single-layered photosensitive layer made of a charge generation material (COM), a hole transport material (HTM), an electron transport material (ETM), a resin, and the like is provided thereon (see, for example, PTL¹).

In any of the photoreceptors, the photoreceptor surface is charged by a corona discharging method or a contact method, and then the photoreceptor is exposed to light to neutralize the charge on the surface, thereby forming an electrostatic latent image by a potential difference with a surrounding surface. Thereafter, a toner is brought into contact with the photoreceptor surface to form a toner image corresponding to the electrostatic latent image, and the toner image is transferred to paper or the like and heat-melted and fixed to complete printing.

As described above, the electrophotographic photoreceptor includes, as a basic configuration, a conductive support and a photosensitive layer formed on the conductive support, and further includes a protective layer provided on the photosensitive layer for the purpose of improving abrasion resistance and the like.

As technology for improving mechanical strength or abrasion resistance of the photoreceptor surface, there is disclosed a photoreceptor in which a layer containing a chain polymerizable functional group-containing compound as a binder resin is formed on an outermost layer of the photoreceptor, and is polymerized by applying energy such as heat, light, or radiation to form a cured resin layer (for example, see PTLs 1 and 2).

Further, PTL³ discloses an electrophotographic photoreceptor having a layer configuration, in which at least one of outermost layers of the layer contains a polymer having a structure in which at least one carbonyl group is bonded to an aromatic group and a structure represented by the following formula (A). In the following formula (A), at least two among R¹¹ to R¹³ are groups represented by the following formula (2). In the following formula (2), R²¹ represents a hydrogen atom or a methyl group, and R²² and R²³ each independently represent a hydrogen atom, a hydrocarbon group, or an alkoxy group.

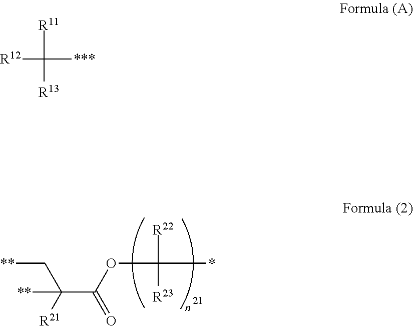

### CITATION LIST

### Patent Literature

PTL¹: US9,417, 538B specification
PTL²: WO 2010/035683
PTL³: WO 2020/218259

### SUMMARY OF INVENTION

### Technical Problem

A related-art photoreceptor including a (meth)acrylic monomer-curable protective layer containing a cured product of a (meth)acrylic monomer as an outermost layer of the photoreceptor has a problem that image deletion (image blur) occurs under a high-humidity environment.

As a means for preventing such image deletion, it is conceivable to select and use a monomer having a low hygroscopic (meth)acrylic monomer structure, for example, a structure with a bonded substituent having a (meth)acryloyl group. However, it has been found that some monomers having such a structure may deteriorate electrical characteristics when used.

An object of the present invention is to provide an electrophotographic photoreceptor capable of achieving both prevention of image deletion and maintenance of electrical characteristics and having a good Martens hardness and a good elastic deformation ratio, and an electrophotographic photoreceptor cartridge and an image forming apparatus using the electrophotographic photoreceptor.

### Solution to Problem

For the above purpose, the present inventors propose an electrophotographic photoreceptor including: a conductive support; a photosensitive layer on the conductive support; and a protective layer, for example, an outermost layer on a side opposite to the conductive support, in which the protective layer contains a polymer having a specific structure.

A gist of the present invention lies in the following [1] to [21].

[1] An electrophotographic photoreceptor including:

a conductive support; and

at least a photosensitive layer and a protective layer sequentially on the conductive support, in which

the protective layer contains a polymer having a structure represented by the following formula (a).

A¹-L¹-X-L²-A² (a)

In the formula (a), X represents a hydrocarbon structure having 4 or more and 20 or less carbon atoms, and the hydrocarbon structure is an alkylene structure, an alkenylene structure, or an alkynylene structure. L¹ and L² each independently represent —O—, —CO—, —O(C═O)—, —(C═O)—O—, or —O(C═O)O—. A¹ and A² each independently represent the following formula (A).

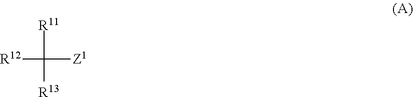

In the formula (A), R¹¹ to R¹³ are each independently a hydrogen atom, a hydrocarbon group, an alkoxy group, a methylol group, or a group represented by the following formula (2), and at least two among R¹¹ to R¹³ are the group represented by the following formula (2). Z¹ represents a bond to any atom.

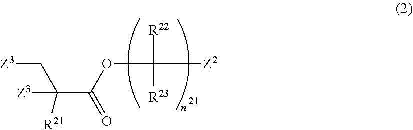

In the formula (2), R²¹ represents a hydrogen atom or a methyl group. R²² and R²³ each independently represent a hydrogen atom, a hydrocarbon group, or an alkoxy group. n²¹ represents an integer of 1 or more and 10 or less. Z² represents a bond to a carbon atom to which R¹¹ to R¹³ in the formula (A) are bonded. Z³ represents a bond to any atom.

[2] An electrophotographic photoreceptor including:

a conductive support;

a photosensitive layer on the conductive support; and

an outermost layer on a side opposite to the conductive support, in which

the outermost layer contains a polymer having a structure represented by the formula (a). [3] The electrophotographic photoreceptor according to the above [1] or [2], in which

the polymer is a polymer of a compound represented by the following formula (a′).

A¹-L¹-X-L²-A² (a′)

In the formula (a′), X represents a hydrocarbon structure having 4 or more and 20 or less carbon atoms, and the hydrocarbon structure is an alkylene structure, an alkenylene structure, or an alkynylene structure. L¹ and L² each independently represent —O—, —CO—, —O(C═O)—, —(C═O)—O—, or —O(C═O)O—. A¹ and A² each independently represent the following formula (A′).

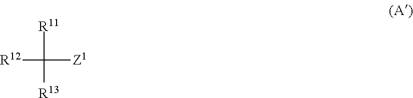

In the formula (A′), R¹¹ to R¹³ each independently represent a hydrogen atom, a hydrocarbon group, an alkoxy group, a methylol group, or a group represented by the following formula (2′), and at least two among R¹¹ to R¹³ represent the group represented by the following formula (2′). Z¹ represents a bond to any atom.

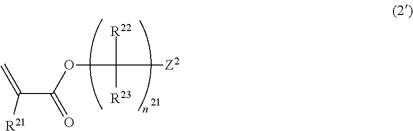

In the formula (2′), R²¹ represents a hydrogen atom or a methyl group. R²² and R²³ each independently represent a hydrogen atom, a hydrocarbon group, or an alkoxy group. n²¹ represents an integer of 1 or more and 10 or less. Z² represents a bond to a carbon atom to which R¹¹ to R¹³ in the formula (A′) are bonded.

[4] An electrophotographic photoreceptor including:

a conductive support; and

at least a photosensitive layer and a protective layer sequentially on the conductive support, in which

the protective layer contains a polymer having a partial structure represented by the following formula (b) and a partial structure represented by the following formula (A).

—CO—X—CO— (b)

In the formula (b), X represents a hydrocarbon structure having 4 or more and 20 or less carbon atoms, and the hydrocarbon structure is an alkylene structure, an alkenylene structure, or an alkynylene structure.

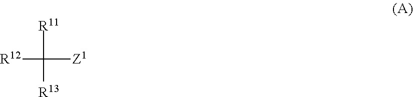

In the formula (A), R¹¹ to R¹³ are each independently a hydrogen atom, a hydrocarbon group, an alkoxy group, a methylol group, or a group represented by the following formula (2), and at least two among R¹¹ to R¹³ are the group represented by the following formula (2). Z¹ represents a bond to any atom.

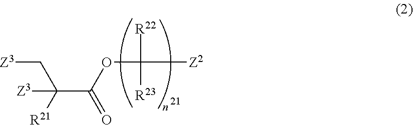

In the formula (2), R²¹ represents a hydrogen atom or a methyl group. R²² and R²³ each independently represent a hydrogen atom, a hydrocarbon group, or an alkoxy group. n²¹ represents an integer of 1 or more and 10 or less. Z² represents a bond to a carbon atom to which R¹¹ to R¹³ in the formula (A) are bonded. Z³ represents a bond to any atom.

[5] An electrophotographic photoreceptor including:

a conductive support;

a photosensitive layer on the conductive support; and

an outermost layer on a side opposite to the conductive support, in which

the outermost layer contains a polymer having a partial structure represented by the formula (b) and a partial structure represented by the formula (A).

[6] The electrophotographic photoreceptor according to the above [4] or [5], in which

the polymer is a polymer of a compound having the partial structure represented by the formula (b) and a partial structure represented by the following formula (A′) in a same molecule.

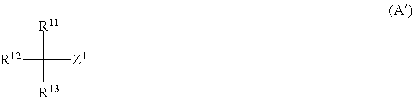

In the formula (A′), R¹¹ to R¹³ each independently represent a hydrogen atom, a hydrocarbon group, an alkoxy group, a methylol group, or a group represented by the following formula (2′), and at least two among R¹¹ to R¹³ represent the group represented by the following formula (2′). Z¹ represents a bond to any atom.

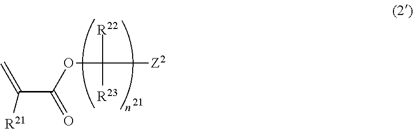

In the formula (2′), R²¹ represents a hydrogen atom or a methyl group. R²² and R²³ each independently represent a hydrogen atom, a hydrocarbon group, or an alkoxy group. n²¹ represents an integer of 1 or more and 10 or less. Z² represents a bond to a carbon atom to which R¹¹ to R¹³ in the formula (A′) are bonded.

[7] An electrophotographic photoreceptor including:

a conductive support; and

at least a photosensitive layer and a protective layer sequentially on the conductive support, in which

the protective layer contains a polymer having the following partial structure X and a partial structure represented by the following formula (B).

X represents a hydrocarbon structure having 4 or more and 20 or less carbon atoms, and the hydrocarbon structure is an alkylene structure, an alkenylene structure, or an alkynylene structure.

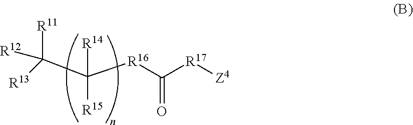

In the formula (B), R¹¹ to R¹³ each independently represent a hydrogen atom, a hydrocarbon group, an alkoxy group, a methylol group, a group represented by the following formula (2), or a group represented by the following formula (3), and at least two among R¹¹ to R¹³ are the group represented by the following formula (2) or the group represented by the following formula (3). R⁴⁴ and R¹⁵ each independently represent a hydrogen atom, a hydrocarbon group, or an alkoxy group. R¹⁶ is a single bond or an oxygen atom. R¹⁷ is a single bond. n¹¹ represents an integer of 1 or more and 10 or less. Z⁴ represents a bond to any atom.

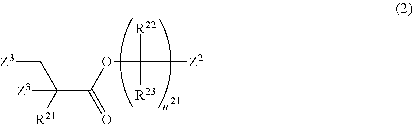

In the formula (2), R²¹ represents a hydrogen atom or a methyl group. R²² and R²³ each independently represent a hydrogen atom, a hydrocarbon group, or an alkoxy group. n²¹ represents an integer of 1 or more and 10 or less. Z² represents a bond to a carbon atom to which R¹¹ to R¹³ in the formula (B) are bonded. Z³ represents a bond to any atom.

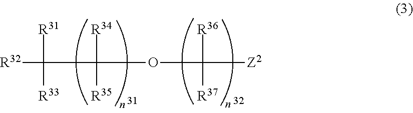

In the formula (3), R³¹ to R³³ each independently represent a hydrogen atom, a hydrocarbon group, an alkoxy group, a methylol group, or a group represented by the formula (2), and at least two among R³¹ to R³³ represent the group represented by the formula (2). R³⁴ to R³⁷ each independently represent a hydrogen atom, a hydrocarbon group, or an alkoxy group. n³¹ and n³² each independently represent an integer of 1 or more and 10 or less. Z² represents a bond to a carbon atom to which R¹¹ to R¹³ in the formula (B) are bonded.

[8] The electrophotographic photoreceptor according to any one of the above [1] to [7], in which

the polymer is a polymer having a structure represented by the following formula (1).

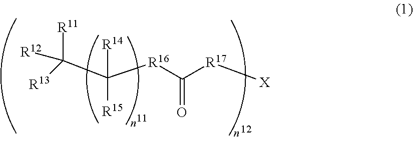

In the formula (1), X is a hydrocarbon structure having 4 or more and 20 or less carbon atoms, and the hydrocarbon structure is an alkylene structure, an alkenylene structure, or an alkynylene structure. R¹¹ to R¹³ are each independently a hydrogen atom, a hydrocarbon group, an alkoxy group, a methylol group, a group represented by the following formula (2), or a group represented by the following formula (3). At least two among R¹¹ to R¹³ are the group represented by the following formula (2) or the group represented by the following formula (3). R¹⁴ and R¹⁵ each independently represent a hydrogen atom, a hydrocarbon group, or an alkoxy group. R¹⁶ is a single bond or an oxygen atom. R¹⁷ is a single bond. n¹² is 2, and n¹¹ represents an integer of 1 or more and 10 or less.

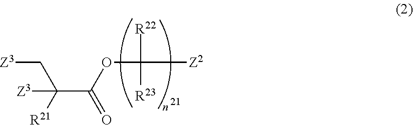

In the formula (2), R²¹ represents a hydrogen atom or a methyl group, R²² and R²³ each independently represent a hydrogen atom, a hydrocarbon group, or an alkoxy group, and n²¹ represents an integer of 1 or more and 10 or less. Z² represents a bond to a carbon atom to which R¹¹ to R¹³ in the formula (1) are bonded. Z³ represents a bond to any atom.

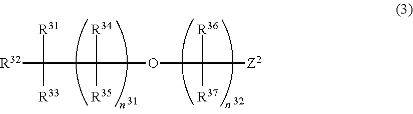

In the formula (3), R³¹ to R³³ each independently represent a hydrogen atom, a hydrocarbon group, an alkoxy group, a methylol group, or a group represented by the formula (2), and at least two among R³¹ to R³³ represent the group represented by the formula (2). R³⁴ to R³⁷ each independently represent a hydrogen atom, a hydrocarbon group, or an alkoxy group. n³¹ and n³² each independently represent an integer of 1 or more and 10 or less. Z² represents a bond to a carbon atom to which R¹¹ to R¹³ in the formula (1) are bonded.

[9] The electrophotographic photoreceptor according to the above [1], [2], [4], [5] or [7], in which

all of the R¹¹, R¹², and R¹³ represent the group represented by the following formula (2).

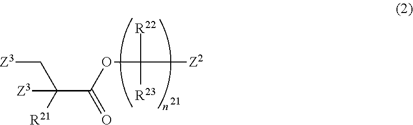

In the formula (2), R²¹ represents a hydrogen atom or a methyl group. R²² and R²³ each independently represent a hydrogen atom, a hydrocarbon group, or an alkoxy group. n²¹ represents an integer of 1 or more and 10 or less. Z² represents a bond to a carbon atom to which R¹¹ to R¹³ in the formula (A) are bonded. Z³ represents a bond to any atom.

[10] The electrophotographic photoreceptor according to the above [3] or [6], in which

all of the R¹¹, R¹², and R¹³ represent the group represented by the following formula (2′).

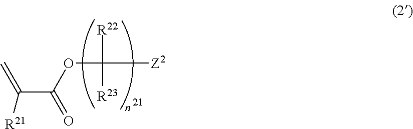

In the formula (2′), R²¹ represents a hydrogen atom or a methyl group. R²² and R²³ each independently represent a hydrogen atom, a hydrocarbon group, or an alkoxy group. n²¹ represents an integer of 1 or more and 10 or less. Z² represents a bond to a carbon atom to which R¹¹ to R¹³ in the formula (A′) are bonded.

[11] The electrophotographic photoreceptor according to any one of the above [1] to [10], in which

the X has 10 or less carbon atoms.

[12] The electrophotographic photoreceptor according to any one of the above [1] to [11], in which

the X is a chain structure composed of carbon and hydrogen.

[13] An electrophotographic photoreceptor including:

a conductive support; and

at least a photosensitive layer and a protective layer sequentially on the conductive support, in which the protective layer contains a polymer obtained by polymerizing a reaction product of an aliphatic dicarboxylic acid or an aliphatic dicarboxylic acid chloride, a polyhydric alcohol, and at least one selected from the group consisting of acrylic acid, methacrylic acid, acrylic acid chloride, and methacrylic acid chloride.

[14] The electrophotographic photoreceptor according to any one of the above [1] to [13], in which

the protective layer or the photosensitive layer in contact with the outermost layer contains a charge transport material, and a concentration of the charge transport material in the photosensitive layer is 30 mass % or more and 70 mass % or less.

[15] The electrophotographic photoreceptor according to any one of the above [1] to [14], in which

the protective layer or the photosensitive layer in contact with the outermost layer has a glass transition temperature of 50° C. or higher and 130° C. or lower.

[16] The electrophotographic photoreceptor according to any one of the above [1] to [15], in which

the protective layer or the outermost layer is a layer cured by irradiation with ultraviolet light and/or visible light.

[17] The electrophotographic photoreceptor according to any one of the above [1] to [16], in which the protective layer or the outermost layer contains metal oxide particles.

[18] The electrophotographic photoreceptor according to the above [17], in which

a content of the metal oxide particles in the protective layer or the outermost layer is 300 parts by mass or less with respect to 100 parts by mass of the polymer in the protective layer or the outermost layer.

[19] The electrophotographic photoreceptor according to any one of the above [1] to [18], in which

the photosensitive layer is a multi-layered photosensitive layer.

[20] An electrophotographic photoreceptor cartridge including:

the electrophotographic photoreceptor according to any one of the above [1] to [19].

[21] An image forming apparatus including:

the electrophotographic photoreceptor according to any one of the above [1] to [19].

### Advantageous Effects of Invention

The electrophotographic photoreceptor according to the present invention can achieve both prevention of image deletion and maintenance of electrical characteristics by an action of the polymer contained in the protective layer (the outermost layer), and further can have a good Martens hardness and a good elastic deformation ratio.

### BRIEF DESCRIPTION OF DRAWINGS

FIG. 1 is a scanning electron microscopic image (an SEM image) of a cross section of a multi-layered photoreceptor obtained in Comparative Example 4.

FIG. 2 is a graph showing a model of a load curve with respect to an indentation depth of an indenter when measuring a Martens hardness and an elastic deformation ratio of a binder resin forming a photosensitive layer in contact with a protective layer (an outermost layer) or when measuring a Martens hardness and an elastic deformation ratio of a photoreceptor surface.

### DESCRIPTION OF EMBODIMENTS

Hereinafter, embodiments for carrying out the present invention (hereinafter, embodiments of the invention) will be described in detail. The present invention is not limited to the following embodiments, and various modifications can be made within the scope of the gist of the present invention.

In the present invention, the term “(meth)acrylic” means acrylic or methacrylic. The term “(meth)acryloyl” means acryloyl or methacryloyl.

<<Present Electrophotographic Photoreceptor>>

An electrophotographic photoreceptor according to an example of an embodiment of the present invention (referred to as “the present electrophotographic photoreceptor”) includes: a conductive support; and at least a photosensitive layer and a protective layer sequentially on the conductive support, in which the protective layer contains a polymer having a specific structure.

In the present electrophotographic photoreceptor, a side opposite to the conductive support is an upper side or a front surface side, and the conductive support side is a lower side or a back surface side. Accordingly, the protective layer (an outermost layer) is located on the side opposite to the conductive support.

The present electrophotographic photoreceptor can have a layer configuration similar to a layer configuration of a general electrophotographic photoreceptor. Examples of the layer configuration of the general electrophotographic photoreceptor include a structure including a conductive support and at least a photosensitive layer and a protective layer (an outermost layer) sequentially provided on the conductive support.

From the viewpoint of further obtaining the effect of the present invention, the protective layer is preferably the outermost layer, that is, the outermost layer located on the side opposite to the conductive support. However, the effect of the present invention can be obtained even when the protective layer is not necessarily the outermost layer. For example, in the case where some segregation layer is present on the outermost layer of the photoreceptor, the effect can also be obtained even when the protective layer is not the outermost layer. Therefore, in the present description, the expression “protective layer (outermost layer)” encompasses the meaning that the protective layer is not necessarily the outermost layer, but is preferably a protective layer as the outermost layer.

<Conductive Support>

The present electrophotographic photoreceptor includes the conductive support under the photosensitive layer to be described later.

The conductive support is not particularly limited as long as it can support the photosensitive layer located thereon and exhibits conductivity.

As the conductive support, for example, a metal material such as aluminum, an aluminum alloy, stainless steel, copper, or nickel, a resin material provided with conductivity by allowing a conductive powder of a metal, carbon, tin oxide, or the like to coexist, a resin obtained by depositing or applying a conductive material such as aluminum, nickel, or an indium tin oxide alloy (ITO) on a surface thereof, glass, paper and the like can be used.

The conductive support can be in a form of, for example, a drum, sheet, belt, or the like.

When a metal material such as an aluminum alloy is used as the conductive support, an anodized film may be applied to the metal material before use.

When applying an anodized film to the metal material, it is preferred to perform a sealing treatment. The sealing treatment can be performed by a known method.

An average film thickness of the anodized film is generally preferably 20 μm or less, and particularly preferably 7 μm or less.

The surface of the conductive support may be smooth, or may be roughened by using a special cutting method or by performing a grinding treatment. The surface may be roughened by mixing particles having an appropriate particle diameter with the material constituting the support.

An undercoat layer to be described later may be provided between the conductive support and the photosensitive layer in order to improve adhesion, blocking properties, and the like.

<Photosensitive Layer>

The present electrophotographic photoreceptor includes the photosensitive layer on the conductive support.

The photosensitive layer may be a single-layered photosensitive layer with a charge generation material (COM), a hole transport material (HTM), an electron transport material (ETM), and a binder resin in the same layer, or may be a multi-layered photosensitive layer separated into a charge generation layer and a charge transport layer.

The multi-layered photosensitive layer may have a form in which a charge generation layer and a charge transport layer are sequentially laminated from the conductive support side, or a form in which a charge transport layer and a charge generation layer are sequentially laminated from the conductive support side.

In the present electrophotographic photoreceptor, regardless of the single-layered photosensitive layer or the multi-layered photosensitive layer, the photosensitive layer in contact with the protective layer (the outermost layer) preferably contains a charge transport material. A concentration of the charge transport material in the photosensitive layer is preferably 30 mass % or more, more preferably 35 mass % or more, and even more preferably 40 mass % or more, from the viewpoint of electrical characteristics. On the other hand, the concentration is preferably 70 mass % or less, more preferably 65 mass % or less, and even more preferably 62 mass % or less, from the viewpoint of preventing mixing with the protective layer (the outermost layer).

A glass transition temperature of the photosensitive layer in contact with the protective layer (the outermost layer) is preferably 50° C. or higher, more preferably 60° C. or higher, and even more preferably 70° C. or higher, from the viewpoint of preventing mixing with the protective layer (the outermost layer). On the other hand, the glass transition temperature is preferably 130° C. or lower, more preferably 120° C. or lower, and even more preferably 110° C. or lower, from the viewpoint of reducing residual stress.

A Martens hardness of the photosensitive layer in contact with the protective layer (the outermost layer) is preferably 160 N/mm² or more, more preferably 170 N/mm² or more, and even more preferably 180 N/mm² or more, from the viewpoint of improving abrasion resistance of the protective layer (the outermost layer). On the other hand, the Martens hardness is preferably 260 N/mm² or less, more preferably 250 N/mm² or less, and even more preferably 240 N/mm² or less, from the viewpoint of crack prevention.

An elastic deformation ratio of the photosensitive layer in contact with the protective layer (the outermost layer) is preferably 35% or more, more preferably 37% or more, and even more preferably 39% or more, from the viewpoint of improving the abrasion resistance of the protective layer (the outermost layer). On the other hand, the elastic deformation ratio is preferably 50% or less, more preferably 47% or less, and even more preferably 44% or less, from the viewpoint of the crack prevention.

The Martens hardness and the elastic deformation ratio of the photosensitive layer in contact with the protective layer (the outermost layer) mean values obtained by a method to be described later for a photoreceptor without a protective layer (an outermost layer), that is, having a photosensitive layer being an outermost surface layer.

The method for measuring the Martens hardness and the elastic deformation ratio of the photosensitive layer in contact with the protective layer (the outermost layer) is the same as a method for measuring a Martens hardness and an elastic deformation ratio of the binder resin forming the photosensitive layer, which will be described later.

(Multi-layered Photosensitive Layer)

First, a configuration of the multi-layered photosensitive layer will be described.

(Charge Generation Layer (CGL))

The charge generation layer (CGL) generally contains a charge generation material (CGM) and a binder resin.

As for a content proportion of the charge generation material to the binder resin, the content proportion of the charge generation material is preferably 10 parts by mass or more, and more preferably 30 parts by mass or more with respect to 100 parts by mass of the binder resin. On the other hand, the content proportion is preferably 1000 parts by mass or less, and more preferably 500 parts by mass or less. The content proportion is even more preferably 300 parts by mass or less, and still more preferably 200 parts by mass or less, from the viewpoint of film strength.

A thickness of the charge generation layer is preferably 0.1 μm or more, and more preferably 0.15 μm or more. On the other hand, the thickness is preferably 10 μm or less, and more preferably 0.6 μm or less.

(Charge Transport Layer (CTL))

The charge transport layer (CTL) generally contains a hole transport material (HTM) and a binder resin. An electron transport material (ETM) may be further contained.

In the charge transport layer (CTL), as for a content proportion of the hole transport material (HTM) to the binder resin, the content proportion of the hole transport material (HTM) is preferably 20 parts by mass or more with respect to 100 parts by mass of the binder resin. Among them, the content proportion of the hole transport material (HTM) is more preferably 30 parts by mass or more with respect to 100 parts by mass of the binder resin from the viewpoint of reducing a residual potential, and is even more preferably 40 parts by mass or more further from the viewpoint of stability and charge mobility during repeated use. On the other hand, the content proportion of the hole transport material (HTM) is preferably 200 parts by mass or less with respect to 100 parts by mass of the binder resin from the viewpoint of thermal stability of the photosensitive layer, is more preferably 150 parts by mass or less further from the viewpoint of compatibility between the hole transport material (HTM) and the binder resin, and is particularly preferably 120 parts by mass or less from the viewpoint of the glass transition temperature.

When the charge transport layer (CTL) further contains the electron transport material (ETM), as for a content proportion of the electron transport material (ETM) to the binder resin, the content proportion of the electron transport material (ETM) is preferably 0.5 parts by mass or more, more preferably 1 part by mass or more, and even more preferably 2 parts by mass or more with respect to 100 parts by mass of the binder resin, from the viewpoint of electron transportability of the charge transport layer. On the other hand, the content proportion is preferably 30 parts by mass or less, more preferably 20 parts by mass or less, and even more preferably 10 parts by mass or less, from the viewpoint of hole transportability of the charge transport layer.

In the charge transport layer (CTL), as for a content ratio (a mass ratio) of the electron transport material (ETM) to the hole transport material (HTM), the content ratio of the electron transport material (ETM) to the hole transport material (HTM) is preferably 0.005 or more, more preferably 0.01 or more, and even more preferably 0.02 or more, from the viewpoint of the electron transportability. On the other hand, the content ratio is preferably 0.2 or less, more preferably 0.1 or less, and even more preferably 0.05 or less, from the viewpoint of the hole transportability.

A thickness of the charge transport layer is not particularly limited. The thickness is preferably 5 μm or more and 50 μm or less, more preferably 10 μm or more or 35 μm or less, and even more preferably 15 μm or more or 25 μm or less, from the viewpoint of the electrical characteristics and image stability and further from the viewpoint of high resolution.

(Single-layered Photosensitive Layer)

The single-layered photosensitive layer generally contains a charge generation material (COM), a hole transport material (HTM), an electron transport material (ETM), and a binder resin.

In the single-layered photosensitive layer, as for a content proportion of the charge generation material to the binder resin, the content proportion of the charge generation material is preferably 1 part by mass or more, more preferably 1.5 parts by mass or more, and even more preferably 2 parts by mass or more with respect to 100 parts by mass of the binder resin. On the other hand, the content proportion is preferably 10 parts by mass or less, more preferably 5 parts by mass or less, and even more preferably 3 parts by mass or less.

In the single-layered photosensitive layer, as for a content proportion of the hole transport material (HTM) to the binder resin, the content proportion of the hole transport material (HTM) is preferably 40 parts by mass or more, more preferably 70 parts by mass or more, and even more preferably 90 parts by mass or more with respect to 100 parts by mass of the binder resin, from the viewpoint of the hole transportability. On the other hand, the content proportion is preferably 200 parts by mass or less, more preferably 150 parts by mass or less, and even more preferably 120 parts by mass or less, from the viewpoint of preventing mixing with the protective layer (the outermost layer).

In the single-layered photosensitive layer, as for a content proportion of the electron transport material (ETM) to the binder resin, the content proportion of the electron transport material (ETM) is preferably 20 parts by mass or more, more preferably 35 parts by mass or more, and even more preferably 50 parts by mass or more with respect to 100 parts by mass of the binder resin, from the viewpoint of the electron transportability. On the other hand, the content proportion is preferably 100 parts by mass or less, more preferably 90 parts by mass or less, and even more preferably 80 parts by mass or less, from the viewpoint of preventing mixing with the protective layer (the outermost layer).

In the single-layered photosensitive layer, as for a content ratio (a mass ratio) of the electron transport material (ETM) to the hole transport material (HTM), the content ratio of the electron transport material (ETM) to the hole transport material (HTM) is preferably 0.2 or more, more preferably 0.4 or more, and even more preferably 0.5 or more, from the viewpoint of the electron transportability. On the other hand, the content ratio is preferably 1.2 or less, more preferably 1 or less, and even more preferably 0.8 or less, from the viewpoint of the hole transportability.

A thickness of the single-layered photosensitive layer is generally 15 μm or more, preferably 20 μm or more, and more preferably 25 μm or more. On the other hand, the thickness is generally 50 μm or less, preferably 40 μm or less, and more preferably 35 μm or less.

[Charge Generation Material (CGM)]

Examples of the charge generation material used in the photosensitive layer (including both the single-layered and the multi-layered) include various photoconductive materials such as: selenium and an alloy thereof, cadmium sulfide, and other inorganic photoconductive materials; and organic pigments such as a phthalocyanine pigment, an azo pigment, a perylene pigment, and a polycyclic quinone pigment. Among them, organic pigments are particularly preferred, and further, a phthalocyanine pigment and an azo pigment are more preferred.

In particular, in the case of using a phthalocyanine pigment as the charge generation material, specifically, metal-free phthalocyanines and phthalocyanines to which a metal such as copper, gallium, tin, or titanium, or an oxide, halide or the like of such a metal is coordinated can be used. Among them, in particular, X-form and ti-form metal-free phthalocyanines, A-form, B-form, and D-form titanyl phthalocyanines, chlorogallium phthalocyanines, and hydroxygallium phthalocyanines, which have high sensitivity, are suitable.

In the case of using an azo pigment, various known bisazo pigments and trisazo pigments are suitably used.

The charge generation material may be used alone or in any combination of two or more kinds thereof in any ratio. Further, in the case of using two or more kinds of charge generation materials, the charge generation materials to be used in combination may be mixed and used later, or may be mixed and used in charge generation material production and treatment steps such as synthesis, pigmentation, and crystallization.

It is desirable that a particle diameter of the charge generation material in the photosensitive layer is sufficiently small. Specifically, the particle diameter is generally preferably 1 μm or less, and more preferably 0.5 μm or less.

Further, a content of the charge generation material in the photosensitive layer is generally preferably 0.1 mass % or more, and more preferably 0.5 mass % or more, from the viewpoint of sensitivity. The content is generally preferably 50 mass % by mass or less, and more preferably 20 mass % or less, from the viewpoint of sensitivity and chargeability.

[Charge Transport Material]

The charge transport material used in the photosensitive layer (including both the single-layered and the multi-layered) is classified into a hole transport material (HTM) mainly having a hole transporting ability and an electron transport material (ETM) mainly having an electron transporting ability. Either one of the hole transport material and the electron transport material may be used alone, or both may be used in combination.

[Hole Transport Material (HTM)]

The hole transport material is not particularly limited as long as it is a known material. Examples thereof include electron-donating materials such as heterocyclic compounds such as a carbazole derivative, an indole derivative, an imidazole derivative, an oxazole derivative, a pyrazole derivative, a thiadiazole derivative, and a benzofuran derivative, an aniline derivative, a hydrazone derivative, an arylamine derivative, a stilbene derivative, a butadiene derivative, and an enamine derivative, a compound in which a plurality of these compounds are bonded together, and a polymer having, in a main chain or a side chain thereof, a group constituted of at least one of these compounds. Among them, a carbazole derivative, an arylamine derivative, a stilbene derivative, a butadiene derivative, an enamine derivative, or a compound in which a plurality of these compounds are bonded together is preferred. Further, among them, an arylamine derivative or an enamine derivative is more preferred from the viewpoint of the electrical characteristics.

[Electron Transport Material (ETM)]

The electron transport material is not particularly limited as long as it is a known material. Examples thereof include electron-attracting materials such as aromatic nitro compounds such as 2,4,7-trinitrofluorenone, cyano compounds such as tetracyanoquinodimethane, and quinone compounds such as diphenoquinone, known cyclic ketone compounds, or perylene pigments (perylene derivatives). Among them, quinone compounds and perylene pigments (perylene derivatives) are preferred, and quinone compounds are more preferred, from the viewpoint of the electrical characteristics.

Examples of the quinone compounds include benzoquinone, nap hthoquinone, anthraquinone, dip henoquinone, and dinaphthoquinone. Among them, diphenoquinone and dinaphthoquinone are preferred from the viewpoint of the electron transportability.

[Binder Resin]

The binder resin used in the photosensitive layer (including both the single-layered and the multi-layered) is not particularly limited. Examples thereof include: an acrylate resin; a methacrylate resin; a polyvinyl butyral resin; a polyarylate resin; a polyamide resin; a polycarbonate resin; a polyester resin; a polyester carbonate resin; a phenoxy resin; an epoxy resin; a silicone resin; and a partially crosslinked cured product thereof. The above resin may be modified with a silicon reagent or the like. These may be used alone or in any combination of two or more kinds thereof in any ratio. Among the above resin, a polyarylate resin, a polycarbonate resin, and a polyester resin are preferred from the viewpoint of compatibility with the hole transport material and the electron transport material, and a polyarylate resin and a polycarbonate resin are more preferred from the viewpoint of the electrical characteristics.

As the binder resin used in the photosensitive layer, among them, a bisphenol or biphenol component-containing polycarbonate resin or polyarylate resin is preferred from the viewpoint of the sensitivity and the residual potential, a bisphenol component-containing polycarbonate resin or polyarylate resin is preferred from the viewpoint of preventing mixing of the protective layer (the outermost layer) and the photosensitive layer, and a bisphenol component-containing polycarbonate resin is more preferred in terms of mobility.

From the viewpoint of preventing mixing or compatibility of components in the protective layer (the outermost layer) and the photosensitive layer in contact with the protective layer (the outermost layer) at an interface, a difference between an SP value of the compound having the hydrocarbon structure X and the structure represented by the formula (A′) in the same molecule and an SP value of the binder resin forming the photosensitive layer in contact with the protective layer (the outermost layer) is preferably 2 or more, more preferably 3 or more, and even more preferably 4 or more.

A viscosity average molecular weight of the binder resin forming the photosensitive layer in contact with the protective layer (the outermost layer) is preferably 30000 or more, and more preferably 40000 or more, from the viewpoint of preventing mixing of the protective layer (the outermost layer) and the photosensitive layer. On the other hand, the viscosity average molecular weight is preferably 100000 or less, and more preferably 70000 or less, from the viewpoint of coatability.

A Martens hardness of the binder resin forming the photosensitive layer in contact with the protective layer (the outermost layer) is preferably 120 N/mm² or more, more preferably 130 N/mm² or more, and even more preferably 140 N/mm² or more. On the other hand, the Martens hardness is preferably 220 N/mm² or less, more preferably 210 N/mm² or less, and even more preferably 200 N/mm² or less, from the viewpoint of the crack prevention.

An elastic deformation ratio of the binder resin forming the photosensitive layer in contact with the protective layer (the outermost layer) is preferably 36% or more, more preferably 38% or more, and even more preferably 40% or more. On the other hand, the elastic deformation ratio is preferably 55% or less, and more preferably 50% or less, from the viewpoint of the crack prevention.

The Martens hardness and the elastic deformation ratio mean values obtained by the following method.

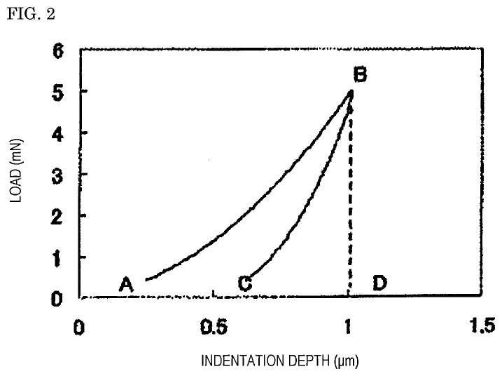

The Martens hardness and the elastic deformation ratio can be measured using a micro hardness tester FISCHERSCOPE HM2000 manufactured by Fischer under an environment of a temperature of 25° C. and a relative humidity of 50%. A Vickers quadrangular pyramid diamond indenter having a facing angle of 136° is used for the measurement. Measurement conditions are set as follows, a load applied to the indenter and an indentation depth under the load are continuously read, and a profile obtained by plotting the load on a Y axis and the indentation depth on an X axis, as shown in FIG. 2, is obtained.

<Measurement Conditions>

Maximum indentation load: 0.2 mN

Loading time: 10 seconds

Loading removing time: 10 seconds

The Martens hardness is a value defined by the following equation based on the indentation depth at this time.

Martens hardness (N/mm²)=test load (N)/surface area of Vickers indenter under test load (mm²)

The elastic deformation ratio is a value defined by the following equation, and is a proportion of a work performed by a film elastically during load removal to a total work required for indentation.

Elastic deformation ratio (%)=(We/Wt)×100

In the above equation, the total work Wt (nJ) is an area surrounded by A-B-D-A in FIG. 2, and the elastic deformation work We (nJ) is an area surrounded by C-B-D-C. The larger the elastic deformation ratio is, the more difficult it is for deformation to remain under a load, and an elastic deformation ratio of 100 means that no deformation remains.

[Other Materials]

The photosensitive layer (including both the single-layered and the multi-layered) may contain, in addition to the above materials, known additives such as an antioxidant, a plasticizer, an ultraviolet absorber, an electron-attracting compound, a leveling agent, and a visible light shielding agent for the purpose of improving film formability, flexibility, coatability, contamination resistance, gas resistance, light resistance, and the like.

In the photosensitive layer, these may be used alone or in any combination of two or more kinds thereof in any ratio as appropriate. In particular, an antioxidant and an electron-attracting compound are preferably contained.

[Antioxidant]

The antioxidant is one kind of stabilizer used for preventing oxidation of the present electrophotographic photoreceptor.

Any antioxidant may be used as long as it functions as a radical scavenger, and specifically, a phenol derivative, an amine compound, or a vitamin is preferred. A hindered phenol or a trialkylamine derivative having a bulky substituent near a hydroxy group is more preferred.

The antioxidant may be used alone or in any combination of two or more kinds thereof in any ratio.

An amount of the antioxidant to be used is not particularly limited, and is parts by mass or more, and preferably 1 part by mass or more with respect to 100 parts by mass of the binder resin in the photosensitive layer. In order to obtain good electrical characteristics and printing durability, the amount is preferably 25 parts by mass or less, and more preferably 20 parts by mass or less.

[Electron-attracting Compound]

The present electrophotographic photoreceptor may contain an electron-attracting compound.

Specific examples of the electron-attracting compound include a sulfonate compound, a carboxylate compound, an organic cyano compound, a nitro compound, and an aromatic halogen derivative. A sulfonate compound and an organic cyano compound are preferred, and a sulfonate compound is particularly preferred. The electron-attracting compound may be used alone or in any combination of two or more kinds thereof in any ratio.

An amount of the electron-attracting compound used in the present electrophotographic photoreceptor is not particularly limited. When the electron-attracting compound is used in the photosensitive layer, the amount is preferably 0.01 parts by mass or more, and more preferably 0.05 parts by mass or more with respect to 100 parts by mass of the binder resin contained in the photosensitive layer. In order to obtain good electrical characteristics, the amount is generally preferably 50 parts by mass or less, more preferably 40 parts by mass or less, and even more preferably 30 parts by mass or less.

(Method for Forming Photosensitive Layer)

A method for forming the photosensitive layer is not particularly limited. For example, the photosensitive layer can be formed by applying a coating liquid obtained by dissolving (or dispersing) a charge generation material, a charge transport material, a binder resin, and other materials in a solvent (or a dispersion medium) onto a conductive support (an intermediate layer such as an undercoat layer to be described later in the case where the intermediate layer is provided).

Hereinafter, the solvent or dispersion medium used for forming the photosensitive layer, and the coating method will be described.

[Solvent or Dispersion Medium]

The solvent or dispersion medium used for forming the photosensitive layer is not particularly limited. Examples thereof include: alcohols such as methanol, ethanol, propanol, and 2-methoxyethanol; ethers such as tetrahydrofuran, 1,4-dioxane, and dimethoxyethane; aromatic hydrocarbons such as benzene, toluene, xylene, and anisole; and chlorinated hydrocarbons such as dichloromethane, chloroform, 1,2-dichloroethane, 1,1,2-trichloroethane, 1,1,1-trichloroethane, tetrachloroethane, 1,2-dichloropropane, and trichlorethylene. These may be used alone or in any combination of two or more kinds thereof in any ratio.

[Coating Method]

Examples of the coating method of the coating liquid for forming the photosensitive layer include a spray coating method, a spiral coating method, a ring coating method, and a dip coating method.

A viscosity of the coating liquid or dispersion liquid is preferably 50 mPas or more, and more preferably 100 mPas or more. The viscosity is preferably 700 mPas or less, and more preferably 500 mPas or less. Accordingly, a photosensitive layer having excellent uniformity in film thickness can be obtained.

It is preferred that after a coating film is formed by the above coating method, the coating film is dried, and a drying temperature and a drying time are adjusted such that necessary and sufficient drying can be performed.

The drying temperature is generally 80° C. or higher, preferably 90° C. or higher, and more preferably 100° C. or higher, from the viewpoint of preventing a residual solvent. From the viewpoint of prevention of bubble generation and the electrical characteristics, the drying temperature is generally 250° C. or lower, preferably 170° C. or lower, and more preferably 140° C. or lower, and the temperature may be changed stepwise.

As a drying method, a hot air dryer, a steam dryer, an infrared dryer, a far infrared dryer, or the like can be used.

In order to provide the protective layer (the outermost layer), only air drying at room temperature may be performed after the photosensitive layer may be coated, and then heat drying may be performed by the above method after the protective layer (the outermost layer) is coated.

<Protective Layer (Outermost Layer)>

Next, the protective layer (the outermost layer) of the present electrophotographic photoreceptor will be described.

The protective layer (the outermost layer) is a layer containing a predetermined polymer, and is preferably a layer cured by irradiation with ultraviolet light and/or visible light.

(Polymer Contained in Protective Layer (Outermost Layer))

### (1) First Embodiment

In a first embodiment of the present invention, the protective layer contains a polymer having a structure represented by the following formula (a).

A¹-L¹-X-L²-A² (a)

In the formula (a), X represents a hydrocarbon structure having 4 or more and 20 or less carbon atoms, and the hydrocarbon structure is an alkylene structure, an alkenylene structure, or an alkynylene structure. L¹ and L² each independently represent —O—, —CO—, —O(C═O)—, —(C═O)—O—, or —O(C═O)O—. A¹ and A² each independently represent the following formula (A).

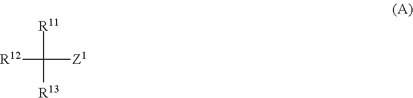

In the formula (A), R¹¹ to R¹³ are each independently a hydrogen atom, a hydrocarbon group, an alkoxy group, a methylol group, or a group represented by the following formula (2), and at least two among R¹¹ to R¹³ are the group represented by the following formula (2). Z¹ represents a bond to any atom.

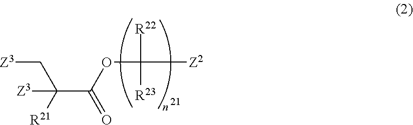

In the formula (2), R²¹ represents a hydrogen atom or a methyl group. R²² and R²³ each independently represent a hydrogen atom, a hydrocarbon group, or an alkoxy group. n²¹ represents an integer of 1 or more and 10 or less. Z² represents a bond to a carbon atom to which R¹¹ to R¹³ in the formula (A) are bonded. Z³ represents a bond to any atom.

### (2) Second Embodiment

In a second embodiment of the present invention, the protective layer contains a polymer having a partial structure represented by the following formula (b) and a partial structure represented by the following formula (A).

—CO—X—CO— (b)

In the formula (b), X represents a hydrocarbon structure having 4 or more and 20 or less carbon atoms, and the hydrocarbon structure is an alkylene structure, an alkenylene structure, or an alkynylene structure.

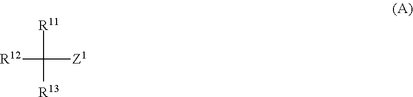

In the formula (A), R¹¹ to R¹³ are each independently a hydrogen atom, a hydrocarbon group, an alkoxy group, a methylol group, or a group represented by the following formula (2), and at least two among R¹¹ to R¹³ are the group represented by the following formula (2). Z¹ represents a bond to any atom.

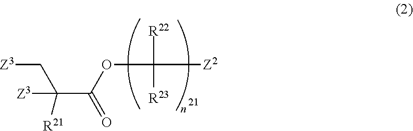

In the formula (2), R²¹ represents a hydrogen atom or a methyl group. R²² and R²³ each independently represent a hydrogen atom, a hydrocarbon group, or an alkoxy group. n²¹ represents an integer of 1 or more and 10 or less. Z² represents a bond to a carbon atom to which R¹¹ to R¹³ in the formula (A) are bonded. Z³ represents a bond to any atom.

### (3) Third Embodiment

In a third embodiment of the present invention, the protective layer contains a polymer having the following partial structure X and a partial structure represented by the following formula (B).

X represents a hydrocarbon structure having 4 or more and 20 or less carbon atoms, and the hydrocarbon structure is an alkylene structure, an alkenylene structure, or an alkynylene structure.

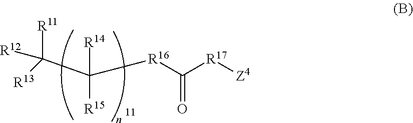

In the formula (B), R¹¹ to R¹³ each independently represent a hydrogen atom, a hydrocarbon group, an alkoxy group, a methylol group, a group represented by the following formula (2), or a group represented by the following formula (3), and at least two among R¹¹ to R¹³ are the group represented by the following formula (2) or the group represented by the following formula (3). R⁴⁴ and R¹⁵ each independently represent a hydrogen atom, a hydrocarbon group, or an alkoxy group. R¹⁶ is a single bond or an oxygen atom. R¹⁷ is a single bond. n¹¹ represents an integer of 1 or more and 10 or less. Z⁴ represents a bond to any atom.

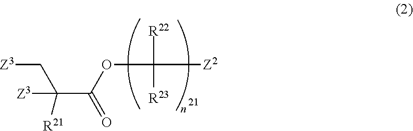

In the formula (2), R²¹ represents a hydrogen atom or a methyl group. R²² and R²³ each independently represent a hydrogen atom, a hydrocarbon group, or an alkoxy group. n²¹ represents an integer of 1 or more and 10 or less. Z² represents a bond to a carbon atom to which R¹¹ to R¹³ in the formula (B) are bonded. Z³ represents a bond to any atom.

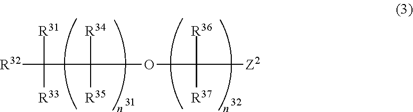

In the formula (3), R³¹ to R³³ each independently represent a hydrogen atom, a hydrocarbon group, an alkoxy group, a methylol group, or a group represented by the formula (2), and at least two among R³¹ to R³³ represent the group represented by the formula (2). R³⁴ to R³⁷ each independently represent a hydrogen atom, a hydrocarbon group, or an alkoxy group. n³¹ and n³² each independently represent an integer of 1 or more and 10 or less. Z² represents a bond to a carbon atom to which R¹¹ to R¹³ in the formula (B) are bonded.

The present electrophotographic photoreceptor according to the first, second, or third embodiment can achieve both prevention of image deletion and maintenance of electrical characteristics, and has a good Martens hardness and a good elastic deformation ratio.

As described above, a related-art photoreceptor including a (meth)acrylic monomer-curable protective layer containing a cured product of a (meth)acrylic monomer as an outermost layer of the photoreceptor has a problem that image deletion (image blur) occurs under a high-humidity environment.

The reason why the related-art (meth)acrylic monomer-curable protective layer causes image deletion under a high-humidity environment is considered as follows. When an acrylic resin portion in the protective layer absorbs moisture, hydrogen ions or hydroxide ions forming water molecules increase ion conductivity and decrease surface resistance of the photoreceptor. Accordingly, it is presumed that charges in an unexposed portion of the photoreceptor surface move and a contrast between an exposed portion and the unexposed portion decreases, resulting in deletion of an electrostatic latent image formed by the charges (image blur).

On the other hand, since the polymer contained in the protective layer (the outermost layer) of the present electrophotographic photoreceptor has the structure X (hereinafter, also referred to as a hydrocarbon structure X), that is, a skeleton having an alkylene structure, an alkenylene structure, or an alkynylene structure having low polarity, a moisture adsorption amount is small even in a high-humidity environment, so that a decrease in surface resistance of the photoreceptor due to moisture absorption can be prevented. Therefore, it is considered that the movement of the charges in the unexposed portion of the photoreceptor surface can be prevented, the contrast between the exposed portion and the unexposed portion does not decrease, and the deletion of the electrostatic latent image can be prevented.

As described above, it has been found that some monomers having a low hygroscopic (meth)acrylic monomer structure, for example, a structure with a bonded substituent having a (meth)acryloyl group, which are present in the protective layer (the outermost layer) may cause deterioration of electrical characteristics. The reason for this is presumed to be that when an affinity between the low hygroscopic structure and a component (for example, a hole transport material, an electron transport material, and a binder resin) contained in the photosensitive layer is high, a layer with components of both layers mixed (referred to as a “mixed layer”) is formed between the two layers, and charge transport from the photosensitive layer to the protective layer (the outermost layer) is inhibited.

The polymer contained in the protective layer (the outermost layer) of the present electrophotographic photoreceptor has a partial structure (the formula (A) or the formula (B)) formed by polymerizing a structure having 2 to 3 (meth)acryloyl groups, and the formula (A) or formula (B) structure is located around the low-polarity skeleton to provide steric protection. Accordingly, it is considered that mixing of the polymer with the components contained in the photosensitive layer can be prevented, formation of the mixed layer can be prevented, and the charge transport from the photosensitive layer to the protective layer (the outermost layer) can be sufficiently performed.

In this case, the polymer is preferably a main component polymer of the protective layer (the outermost layer). That is, the polymer is preferably a polymer having the highest mass proportion among polymers constituting the protective layer (the outermost layer), and preferably accounts for 50% or more, 70% or more, 80% or more, 90% or more, or 95% or more (including 100%) of a total mass of the polymers constituting the protective layer (the outermost layer).

In the polymer contained in the protective layer (the outermost layer), the hydrocarbon structure X is preferably contained in one molecule in a proportion of 6 wt % or more, more preferably contained in a proportion of 10 wt % or more, and even more preferably contained in a proportion of 12 wt % or more, from the viewpoint of preventing hygroscopicity by lowering the polarity. On the other hand, the hydrocarbon structure X is preferably contained in one molecule in a proportion of 30 wt % or less, more preferably contained in a proportion of 22 wt % or less, and even more preferably contained in a proportion of 18 wt % or less, from the viewpoint of preventing mixing with the photosensitive layer.

### (4) Fourth Embodiment

Preferred examples of the protective layer (the outermost layer) of the present electrophotographic photoreceptor shown in the first to third embodiments include a layer containing a polymer obtained by polymerizing a reaction product of an aliphatic dicarboxylic acid or an aliphatic dicarboxylic acid chloride, a polyhydric alcohol, and at least one selected from the group consisting of acrylic acid, methacrylic acid, acrylic acid chloride, and methacrylic acid chloride. More specifically, examples thereof include a layer containing a polymer obtained by radically polymerizing a reaction product obtained by reacting an aliphatic dicarboxylic acid, a polyhydric alcohol, and acrylic acid or methacrylic acid by dehydration condensation. The reaction product to be radically polymerized may be a reaction product obtained by condensing an alcohol body, which is previously obtained by condensing a polyhydric alcohol with acrylic acid, methacrylic acid, acrylic acid chloride or methacrylic acid chloride, with an aliphatic dicarboxylic acid or aliphatic dicarboxylic acid chloride.

In this case, the aliphatic dicarboxylic acid preferably has 4 or more carbon atoms, more preferably has 5 or more carbon atoms, and even more preferably has 7 or more carbon atoms. On the other hand, the aliphatic dicarboxylic acid preferably has 16 or less carbon atoms, more preferably has 12 or less carbon atoms, and even more preferably has 10 or less carbon atoms. Here, the number of carbon atoms does not include the number of carbon atoms constituting the carboxylic acid.

Specific examples of the aliphatic dicarboxylic acid include adipic acid, pimelic acid, suberic acid, azelaic acid, sebacic acid, undecanedioic acid, dodecanedioic acid, tridecanedioic acid, tetradecanedioic acid, pentadecanedioic acid, hexadecanedioic acid, heptadecanedioic acid, octadecanedioic acid, nonadecanedioic acid, icosanedioic acid, henicosanedioic acid, docosanedioic acid, 3-methyl-1,6-butanedicarboxylic acid, 4-methyl-1,7-p entanedicarboxylic acid, dihydromuconic acid, 2,4-hexadiene-1,6-dicarboxylic acid, acetylenedicarboxylic acid, 1,4-cyclohexanedicarboxylic acid, 1,3-cyclohexanedicarboxylic acid, 1,2-cyclohexanedicarb oxylic acid, decahydro-1,4-naphthalenedicarboxylic acid, and cis-4-cyclohexene-1,2-dicarboxylic acid. Among them, adipic acid, pimelic acid, suberic acid, azelaic acid, sebacic acid, undecanedioic acid, dodecanedioic acid, tetradecanedioic acid, and 1,4-cyclohexanedicarboxylic acid are preferred from the viewpoint of the electrical characteristics and preventing the image deletion, and adipic acid, suberic acid, azelaic acid, and sebacic acid are more preferred from the viewpoint of the electrical characteristics.

The aliphatic dicarboxylic acid chloride is preferably a dicarboxylic acid chloride having a structure same as that of the aliphatic dicarboxylic acid.

The polyhydric alcohol preferably has 2 to 12 carbon atoms, more preferably has 3 to 10 carbon atoms, and even more preferably has 4 to 6 carbon atoms, and preferably has 3 or more hydroxy groups, and more preferably has 4 or more hydroxy groups.

Specific examples of the polyhydric alcohol include pentaerythritol, dip entaerythritol, trimethylolethane, and trimethylolpropane. Among them, pentaerythritol or dipentaerythritol is preferred from the viewpoint of preventing mixing of the protective layer (the outermost layer) and the photosensitive layer, and pentaerythritol is more preferred from the viewpoint of preventing the image deletion.

### (5) Fifth Embodiment

As a more preferred example of the polymer which is a main component polymer of the protective layer (the outermost layer) of the present electrophotographic photoreceptor shown in the first to third embodiments, a polymer having a structure represented by the following formula (1) can be exemplified.

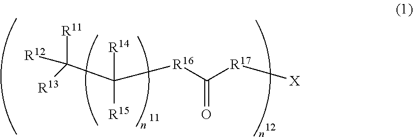

In the formula (1), X is a hydrocarbon structure having 4 or more and 20 or less carbon atoms, and the hydrocarbon structure is an alkylene structure, an alkenylene structure, or an alkynylene structure. R¹¹ to R¹³ are each independently a hydrogen atom, a hydrocarbon group, an alkoxy group, a methylol group, a group represented by the following formula (2), or a group represented by the following formula (3). At least two among R¹¹ to R¹³ are the group represented by the following formula (2) or the group represented by the following formula (3). R¹⁴ and R¹⁵ each independently represent a hydrogen atom, a hydrocarbon group, or an alkoxy group. R¹⁶ is a single bond or an oxygen atom. R¹⁷ is a single bond. n¹² is 2, and n¹¹ represents an integer of 1 or more and 10 or less.

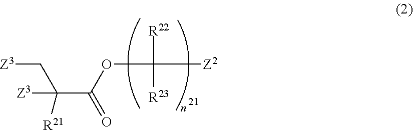

In the formula (2), R²¹ represents a hydrogen atom or a methyl group. R²² and R²³ each independently represent a hydrogen atom, a hydrocarbon group, or an alkoxy group. n²¹ represents an integer of 1 or more and 10 or less. Z² represents a bond to a carbon atom to which R¹¹ to R¹³ in the formula (1) are bonded, and Z³ represents a bond to any atom.

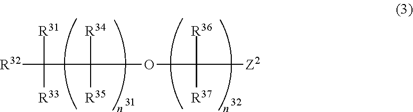

In the formula (3), R³¹ to R³³ each independently represent a hydrogen atom, a hydrocarbon group, an alkoxy group, a methylol group, or a group represented by the formula (2). At least two among R³¹ to R³³ represent the group represented by the formula (2). R³⁴ to R³⁷ each independently represent a hydrogen atom, a hydrocarbon group, or an alkoxy group. n³¹ and n³² each independently represent an integer of 1 or more and 10 or less. Z² represents a bond to a carbon atom to which R¹¹ to R¹³ in the formula (1) are bonded.

Hereinafter, the partial structures and the structural formulae in the first to fifth embodiments will be described in detail.

[Structure X]

The structure X represents a hydrocarbon structure having 4 or more and 20 or less carbon atoms, and the hydrocarbon structure may be an alkylene structure, an alkenylene structure, or an alkynylene structure. Among them, an alkylene structure is preferred from the viewpoint of hydrophobicity.

The hydrocarbon structure X may be a chain structure or a cyclic structure. When the hydrocarbon structure X is a chain structure, the hydrocarbon structure X may be linear or branched having a side chain. From the viewpoint of the hydrophobicity, the hydrocarbon structure X is preferably composed of carbon and hydrogen. When the hydrocarbon structure X is a cyclic structure, the hydrocarbon structure X preferably has a cyclo ring. Among them, a chain structure is preferred, and a linear structure composed of carbon and hydrogen is more preferred.

The number of carbon atoms in the hydrocarbon structure X may be 4 or more and 20 or less, and a lower limit thereof is preferably 5 or more, more preferably 6 or more, and even more preferably 7 or more. On the other hand, an upper limit thereof is preferably 16 or less, more preferably 12 or less, and even more preferably 10 or less.

[Formula (a)]

A preferred aspect of the structure X in the formula (a) is as described above.

L¹ and L² each independently represent —O—, —CO—, —O(C═O)—, —(C═O)—O—, or —O(C═O)O—. Among them, —O(C═O)— and —(C═O)—O— are preferred from the viewpoint of ease of synthesis.

A¹ and A² each independently represent the formula (A). A preferred aspect of the formula (A) is as described below. Since A¹ and A² each independently represent the formula (A), R¹¹ to R¹³ and R²¹ to R²³ in A¹ and A² may be the same as or different from each other. Hereinafter, when a plurality of groups are defined being “each independently”, substituents of the plurality of groups may be the same as or different from each other.

[Formula (b)]

A preferred aspect of the structure X in the formula (b) is as described above.

[Formula (A), Formula (B), and Formula (1)]

Examples of the hydrocarbon group represented by R¹¹, R¹², and R¹³ in the formula (A), formula (B), and formula (1) include an aliphatic hydrocarbon group and an aromatic hydrocarbon group.

Examples of the aliphatic hydrocarbon group include an alkyl group, an alkenyl group, and an alkynyl group. The number of carbon atoms in the aliphatic hydrocarbon group is not particularly limited, is generally 1 or more for the alkyl group, and is generally 2 or more for the alkenyl group and the alkynyl group.

On the other hand, the number of carbon atoms is preferably 20 or less, more preferably 10 or less, and particularly preferably 6 or less for the alkyl group, the alkenyl group, and the alkynyl group. When the number of carbon atoms is in the above range, a high solvent affinity is obtained.

Specific examples of the aliphatic hydrocarbon group include a methyl group, an ethyl group, an n-propyl group, an i-propyl group, an n-butyl group, a sec-butyl group, an i-butyl group, a tert-butyl group, an n-pentyl group, an isopentyl group, a sec-pentyl group, a neopentyl group, a 1-methylbutyl group, a 2-methylbutyl group, a 1,1-dimethylpropyl group, a 1,2-dimethylpropyl group, a vinyl group, a 1-propenyl group, a 2-propenyl group, an isopropenyl group, a 1-butenyl group, a 2-butenyl group, a 3-butenyl group, a 1-pentenyl group, a 2-pentenyl group, a 3-pentenyl group, a 4-pentenyl group, an ethynyl group, a 1-propynyl group, a 2-propynyl group, a 1-butynyl group, a 2-butynyl group, a 3-butynyl group, a 1-pentynyl group, a 2-pentynyl group, a 3-pentynyl group, and a 4-pentynyl group. Among them, a methyl group and an ethyl group are preferred.

Examples of the aromatic hydrocarbon group include an aryl group and an aralkyl group. The number of carbon atoms in the aromatic hydrocarbon group is not particularly limited, and is generally 6 or more, and on the other hand, is generally 20 or less, and preferably 12 or less. When the number of carbon atoms is in the above range, solubility and the electrical characteristics are excellent.

Specific examples of the aromatic hydrocarbon group include a phenyl group, a tolyl group, a xylyl group, an ethylphenyl group, an n-propylphenyl group, an i-propylphenyl group, an n-butylphenyl group, a sec-butylphenyl group, an i-butylphenyl group, a tert-butylphenyl group, a naphthyl group, an anthracene group, a biphenyl group, and a pyrene group.

Examples of the alkoxy group represented by R¹¹, R¹², and R¹³ include a methoxy group, an ethoxy group, a propoxy group, a butoxy group, and a phenoxy group.

In the formula (A), at least two among R¹¹, R¹², and R¹³ are the group represented by the formula (2), and it is preferred that all of R¹¹, R¹², and R¹³ are the group represented by the formula (2) from the viewpoint of film strength after reaction.

In the formulae (B) and (1), at least two among R¹¹, R¹², and R¹³ are the group represented by the formula (2) or the group represented by the formula (3), and it is preferred that all of R¹¹, R¹², and R¹³ are the group represented by the formula (2) or the group represented by the formula (3) from the viewpoint of the film strength after reaction.

The details of the formulae (2) and (3) will be described later.

In the formulae (B) and (1), R¹⁴ and R¹⁵ each independently represent a hydrogen atom, a hydrocarbon group, or an alkoxy group, and specific examples thereof include groups same as those described for R¹¹ to R¹³. R¹⁴ and R¹⁵ are preferably hydrogen atoms from the viewpoint of solvent solubility.

R¹⁶ and R¹⁷ are each a single bond or an oxygen atom, and from the viewpoint of the electrical characteristics, R¹⁶ is preferably an oxygen atom and R¹⁷ is preferably a single bond.

In the formulae (B) and (1), n″ is an integer of 1 or more and 10 or less, and is preferably 6 or less, more preferably 4 or less, and, from the viewpoint of solvent solubility, most preferably 1.

In the formula (1), n¹² is 2 from the viewpoint of the solubility and the film strength after reaction.

In the formula (1), X is a hydrocarbon structure having 4 or more and 20 or less carbon atoms, and the above description can be applied to the hydrocarbon structure and the number of carbon atoms thereof.

[Formula (2) and Formula (3)]

In the formula (2), R²² and R²³ each independently represent a hydrogen atom, a hydrocarbon group, or an alkoxy group, and specific examples thereof include groups same as those described for R¹¹ to R¹³.

In the formulae (2) and (3), n²¹, n³¹, and n³² are each an integer of 1 or more and 10 or less, are generally 1 or more, and are generally 10 or less, preferably 6 or less, and more preferably 4 or less, and, from the viewpoint of the solvent solubility, most preferably 1.

In the formula (3), Re′, R³², and R³³ each independently represent a hydrogen atom, a hydrocarbon group, an alkoxy group, a methylol group, or a group represented by the formula (2), and at least two among R³¹ to R³³ represent the group represented by the formula (2). In this case, examples of the hydrocarbon group and the alkoxy group include groups same as those described for R¹¹ to R¹³.

R³⁴, R³⁵, R³⁶, and R³⁷ each independently represent a hydrogen atom, a hydrocarbon group, or an alkoxy group. Specific examples thereof include groups same as those described for R¹¹ to R¹³.

(Raw Material of Polymer Contained in Protective Layer (Outermost Layer))

A raw material of the polymer in the first, second, or third embodiment of the present invention is not particularly limited.

The polymer in the first embodiment of the present invention is preferably a polymer of a compound represented by a formula (a′) to be described later.

The polymer in the second embodiment of the present invention is preferably a polymer of a compound having a partial structure represented by the formula (b) and a partial structure represented by a formula (A′) to be described later in the same molecule.

In the polymer, the partial structure represented by the formula (b) and the partial structure represented by the formula (A′) may be randomly present in the molecule, and among them, the partial structure represented by the formula (b) is preferably a skeleton of the polymer, that is, a main chain structure rather than a substituent.

The polymer in the third embodiment of the present invention is preferably a polymer of a compound having the hydrocarbon structure X and a partial structure represented by a formula (B′) to be described later in the same molecule.

In the polymer, the hydrocarbon structure X and the partial structure represented by the formula (B′) may be randomly present in the molecule, and among them, the hydrocarbon structure X is preferably a skeleton of the polymer, that is, a main chain structure rather than a substituent. [(a′)]

A¹-L¹-X-L²-A² (a′)

In the formula (a′), X represents a hydrocarbon structure having 4 or more and 20 or less carbon atoms, and the hydrocarbon structure is an alkylene structure, an alkenylene structure, or an alkynylene structure. L¹ and L² each independently represent —O—, —CO—, —O(C═O)—, —(C═O)—O—, or —O(C═O)O—. A¹ and A² each independently represent the following formula (A′).

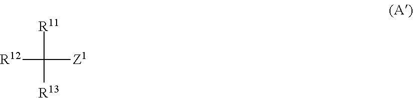

In the formula (A′), R¹¹ to R¹³ are each independently a hydrogen atom, a hydrocarbon group, an alkoxy group, a methylol group, or a group represented by the following formula (2′), and at least two among R¹¹ to R¹³ are the group represented by the following formula (2′). Z¹ represents a bond to any atom.

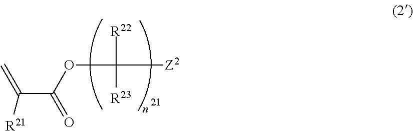

In the formula (2′), R²¹ represents a hydrogen atom or a methyl group. R²² and R²³ each independently represent a hydrogen atom, a hydrocarbon group, or an alkoxy group. n²¹ represents an integer of 1 or more and 10 or less. Z² represents a bond to a carbon atom to which R¹¹ to R¹³ in the formula (A′) are bonded.

Specific examples and preferred examples of R¹¹ to R¹³, R²¹ to R²³, and n²¹ in the above formulae (A′) and (2′) are the same as those for R¹¹ to R¹³, R²¹ to R²³, and n²¹ in the formulae (A) and (2).

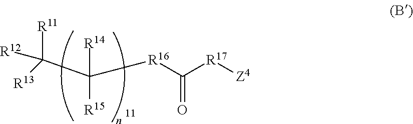

In the formula (B′), R¹¹ to R¹³ each independently represent a hydrogen atom, a hydrocarbon group, an alkoxy group, a methylol group, a group represented by the formula (2′), or a group represented by the following formula (3′), and at least two among R¹¹ to R¹³ are the group represented by the formula (2′), or the group represented by the following formula (3′). R¹⁴ and R¹⁵ each independently represent a hydrogen atom, a hydrocarbon group, or an alkoxy group. R¹⁶ is a single bond or an oxygen atom. R¹⁷ is a single bond. n″ represents an integer of 1 or more and 10 or less. Z⁴ represents a bond to any atom.

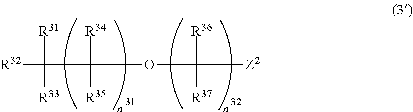

In the formula (3′), Rel, R³², and R³³ each independently represent a hydrogen atom, a hydrocarbon group, an alkoxy group, a methylol group, or a group represented by the formula (2′), and at least two among R³¹ to R³³ represent the group represented by the formula (2′). R³⁴ to R³⁷ each represent a hydrogen atom, a hydrocarbon group, or an alkoxy group, and n³¹ and n³² each independently represent an integer of 1 or more and 10 or less. Z² represents a bond to a carbon atom to which R¹¹ to R¹³ in the formula (1′) are bonded.

Specific examples and preferred examples of R¹¹ to R¹⁷, R²¹ to R²³, R³¹ to R³⁷, n″, n²¹, n³¹, and n³² in the formulae (B′), (2′) and (3′) are the same as those for R¹¹ to R¹⁷, R²¹ to R²³, R³¹ to R³⁷, n″, n²¹, n³¹, and n³² in the formulae (B), (2), and (3).

The raw material of the polymer in the fourth embodiment of the present invention is a reaction product of an aliphatic dicarboxylic acid or an aliphatic dicarboxylic acid chloride, a polyhydric alcohol, and acrylic acid, methacrylic acid, acrylic acid chloride or methacrylic acid chloride. Examples thereof include a compound obtained by reacting an aliphatic dicarboxylic acid, a polyhydric alcohol, and acrylic acid or methacrylic acid by dehydration condensation, and a compound obtained by subjecting an alcohol body, which is previously obtained by condensing a polyhydric alcohol with acrylic acid, methacrylic acid, acrylic acid chloride or methacrylic acid chloride, and an aliphatic dicarboxylic acid or aliphatic dicarboxylic acid chloride to a condensation reaction.

The raw material of the polymer in the fifth embodiment of the present invention, that is, the polymer having a structure represented by the formula (1) is not particularly limited. It is preferred to obtain the polymer by polymerizing a compound having a structure represented by the following formula (1′).

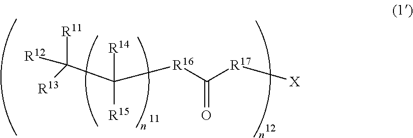

In the formula (1′), X represents an alkylene structure, an alkenylene structure, or an alkynylene structure. R¹¹ to R¹³ are each independently a hydrogen atom, a hydrocarbon group, an alkoxy group, a methylol group, a group represented by the formula (2′), or a group represented by the formula (3′). At least two among R¹¹ to R¹³ are the group represented by the formula (2′) or the group represented by the formula (3′). R¹⁴ and R¹⁵ each independently represent a hydrogen atom, a hydrocarbon group, or an alkoxy group, and R¹⁶ is a single bond or an oxygen atom. R¹⁷ is a single bond. n¹² is 2, and n¹¹ represents an integer of 1 or more and 10 or less.

Specific examples and preferred examples of R¹¹ to R¹⁷, R²¹ to R²³, R³¹ to R³⁷, n¹¹, n²¹, n³¹, and n³² in the formulae (1′), (2′), and (3′) are the same as those for R¹¹ to R¹⁷, R²¹ to R²³, R³¹ to R³⁷, n¹¹, n²¹, n³¹, and n³² in the formulae (B), (2), and (3).

The formula (2′) has an acryloyl group or a methacryloyl group which is a chain polymerizable functional group. Accordingly, each of the above compounds which are raw materials of the polymer contained in the protective layer (the outermost layer) has a plurality of acryloyl groups or methacryloyl groups. From this, it is considered that intermolecular crosslinking by the polymerization reaction occurs at a high density, and a cured film having excellent mechanical strength is formed.

A water absorption rate of each of the above compounds which are raw materials of the polymer contained in the protective layer (the outermost layer) is preferably 0.1% or more, more preferably 0.2% or more, and even more preferably 0.3% or more, from the viewpoint of preventing mixing of the protective layer (the outermost layer) and the photosensitive layer. On the other hand, the water absorption rate is preferably 1.5% or less, more preferably 1.3% or less, and even more preferably 1.0% or less, from the viewpoint of preventing the image deletion.

The water absorption rate can be measured by a method described in Examples to be described later.

Hereinafter, each of the above compounds which are raw materials of the polymer contained in the protective layer (the outermost layer) will be exemplified.

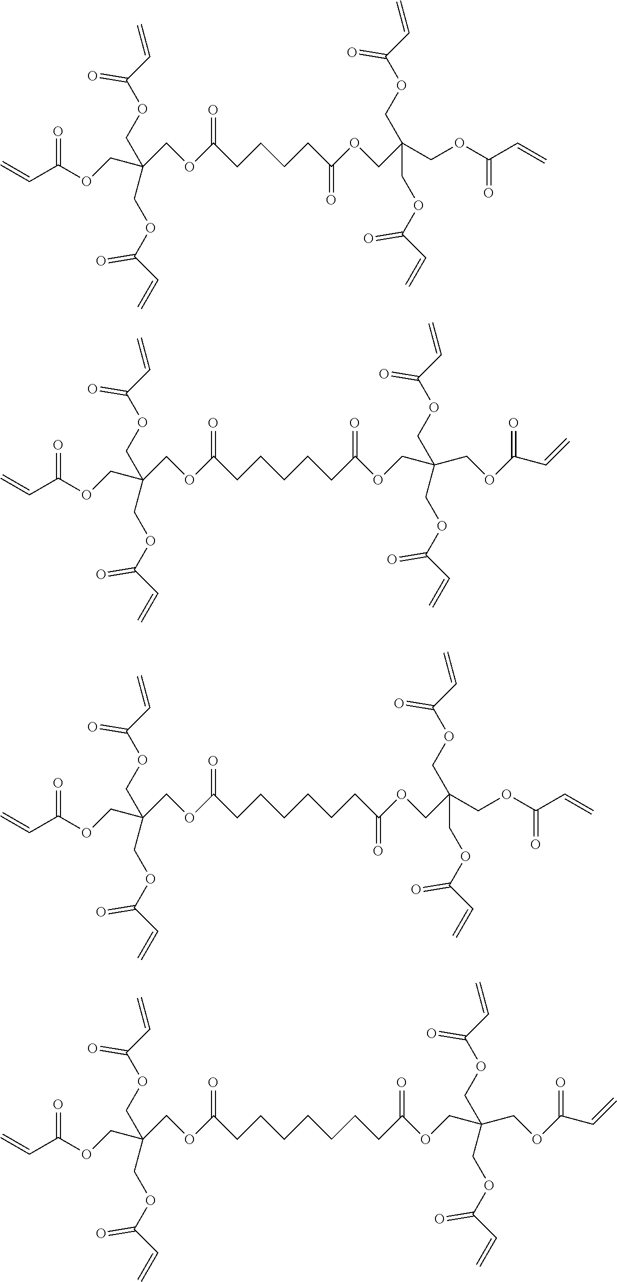

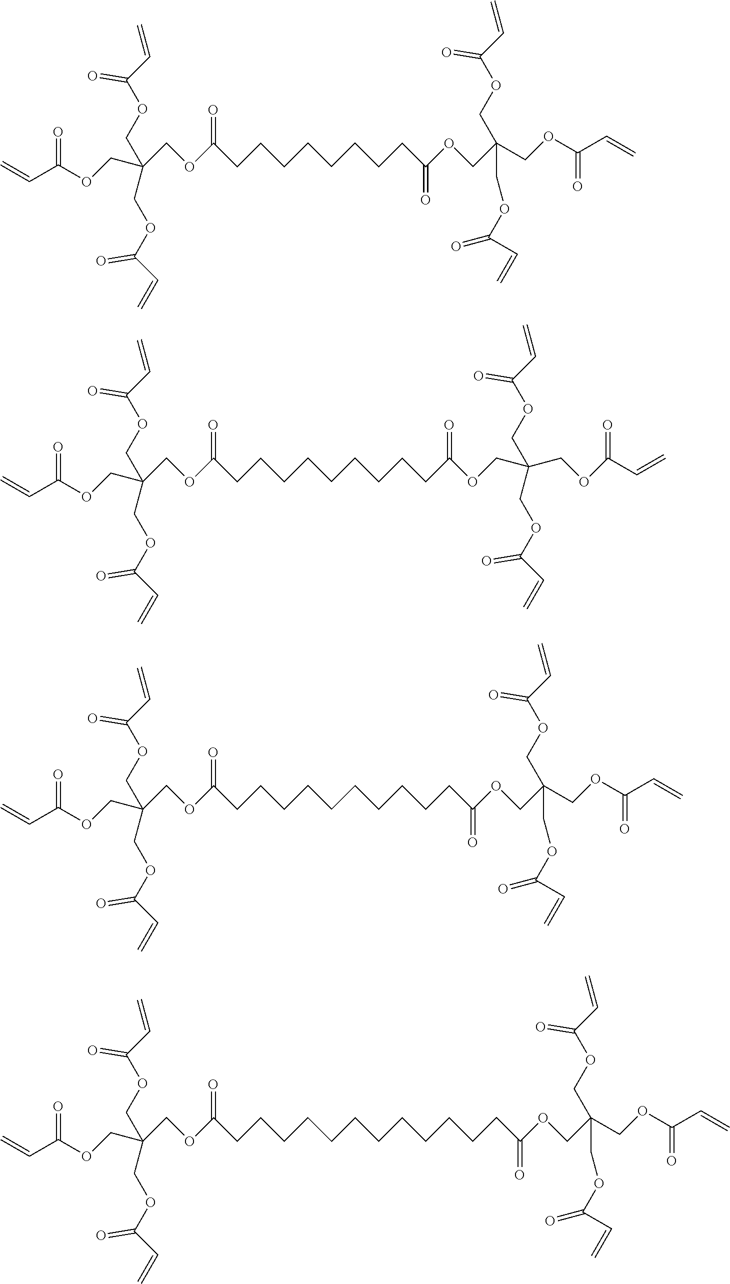

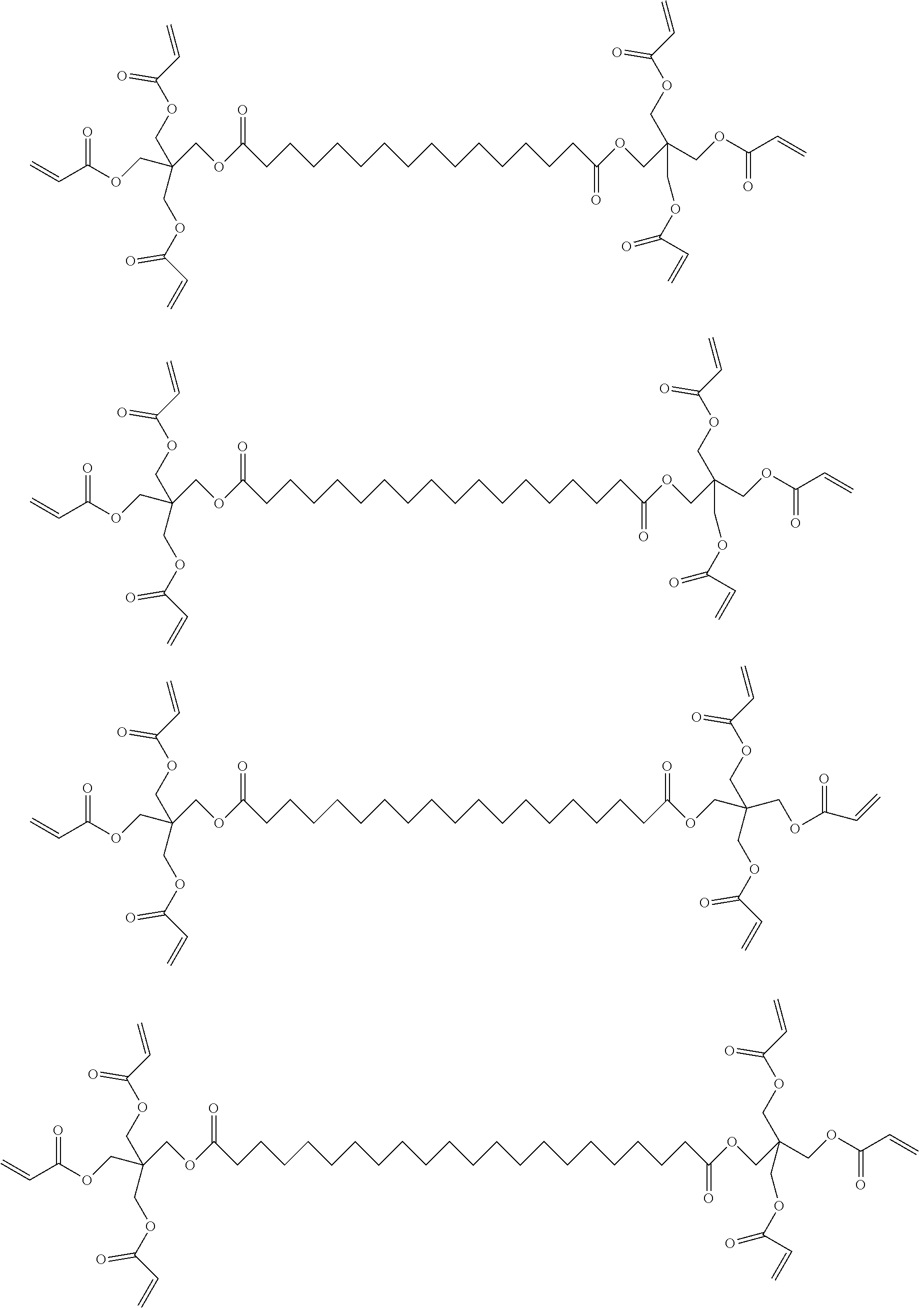

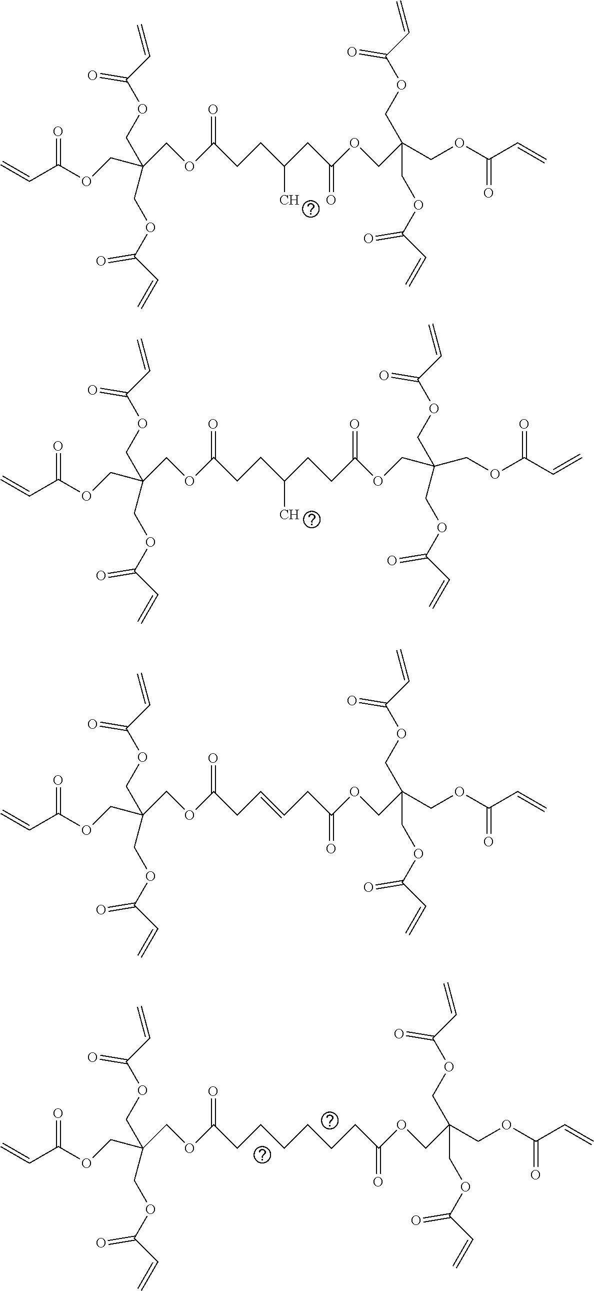

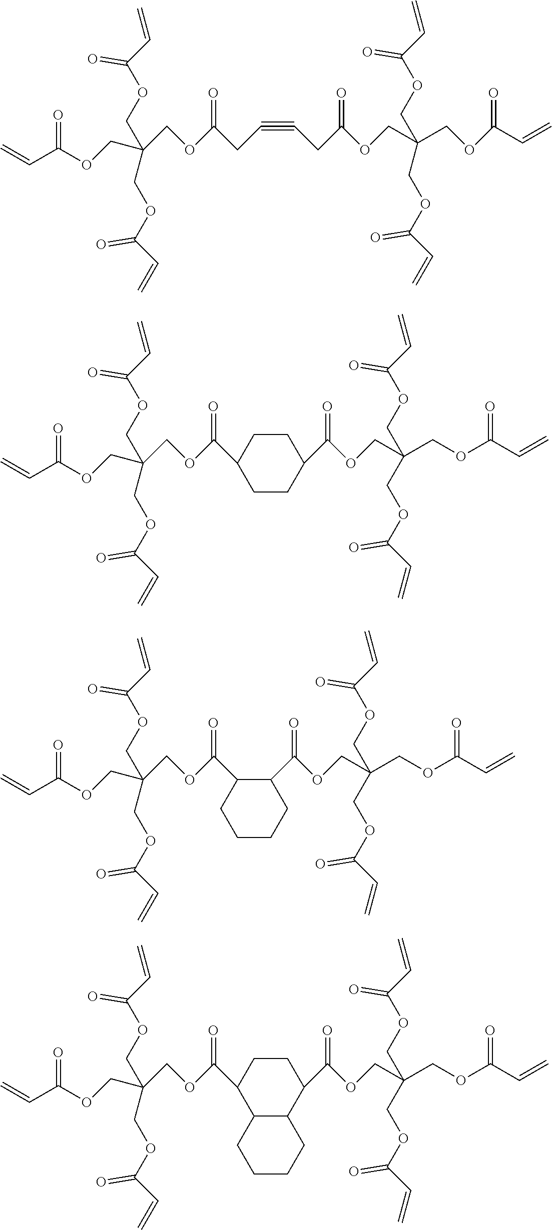

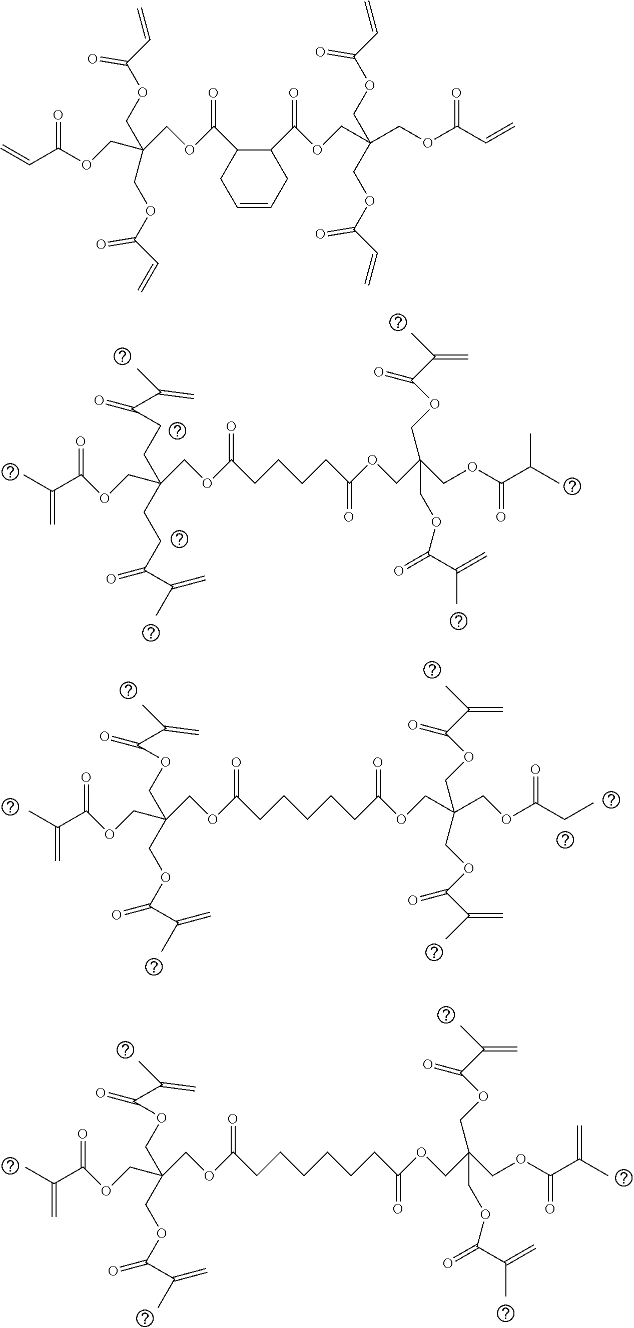

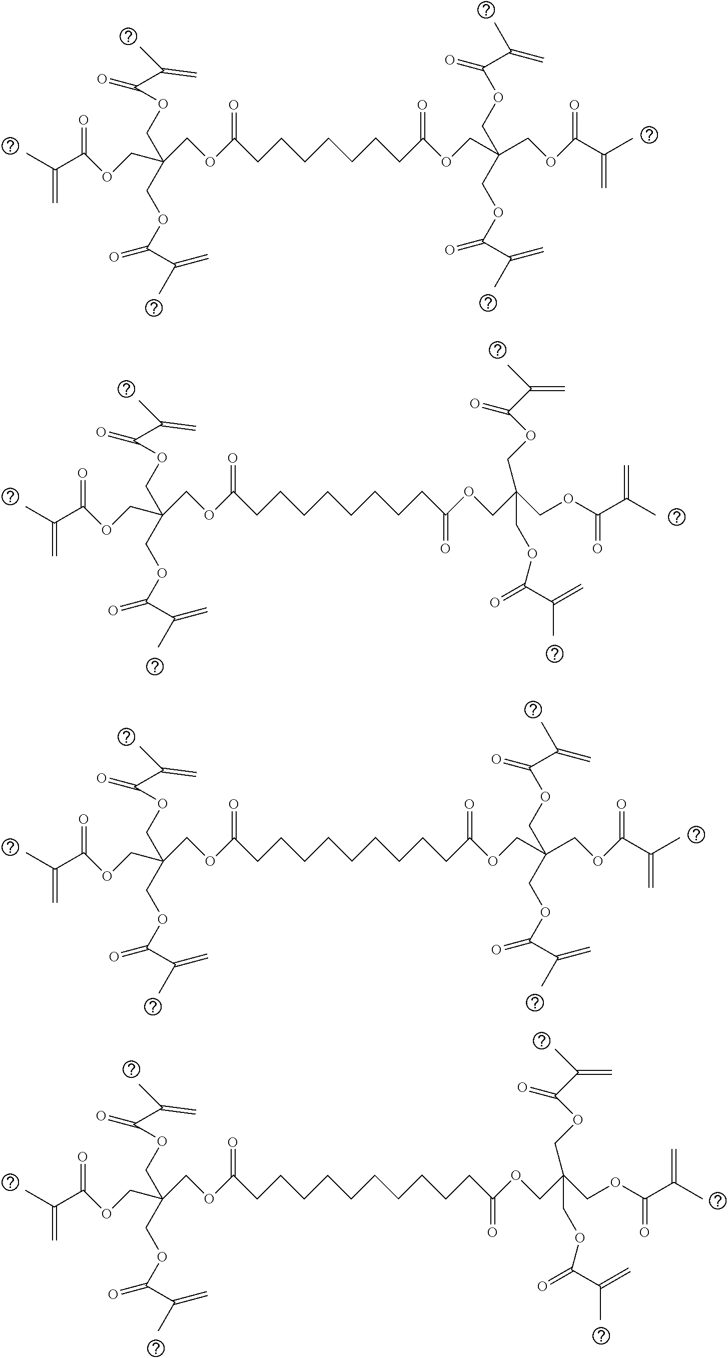

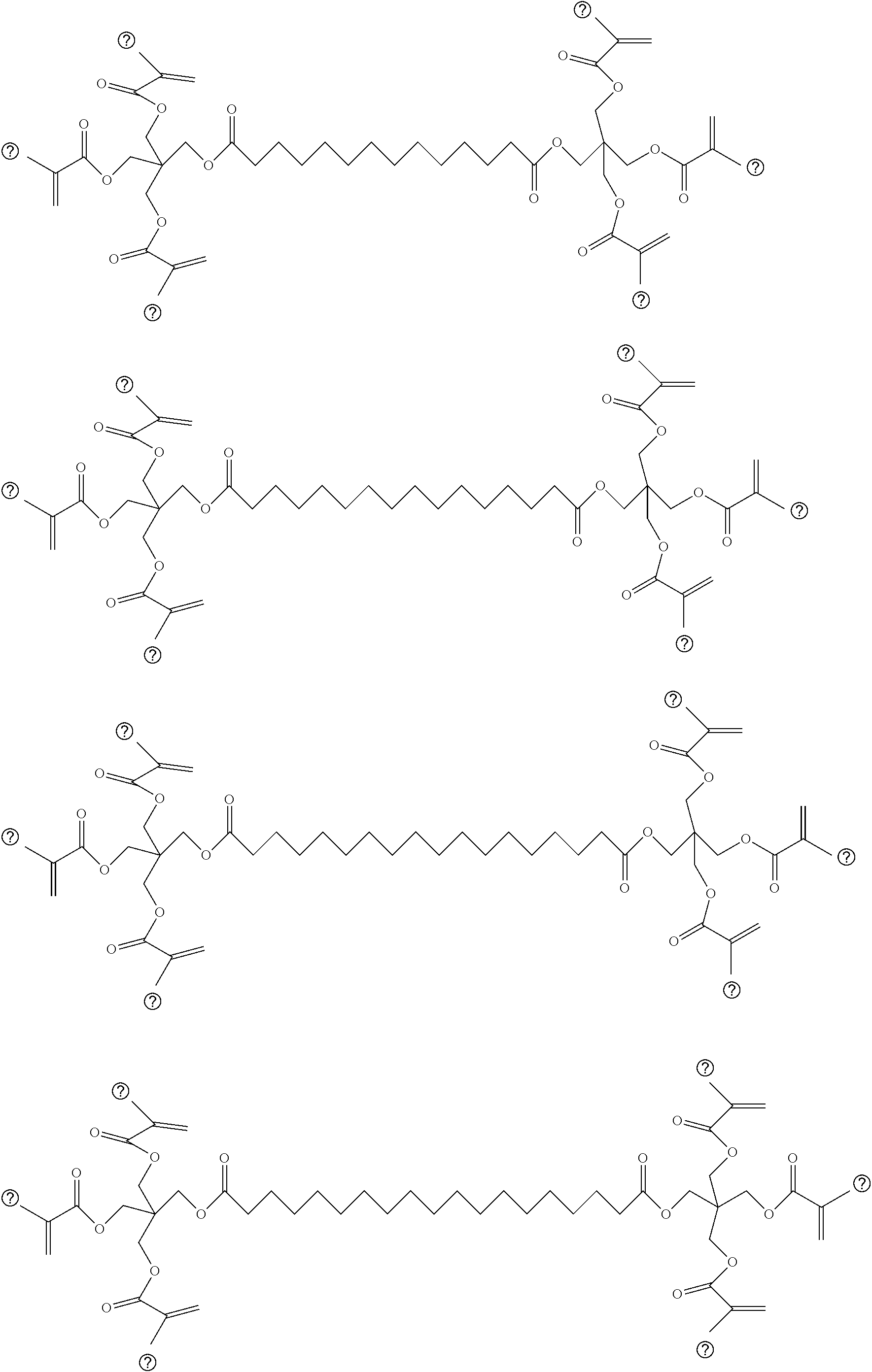

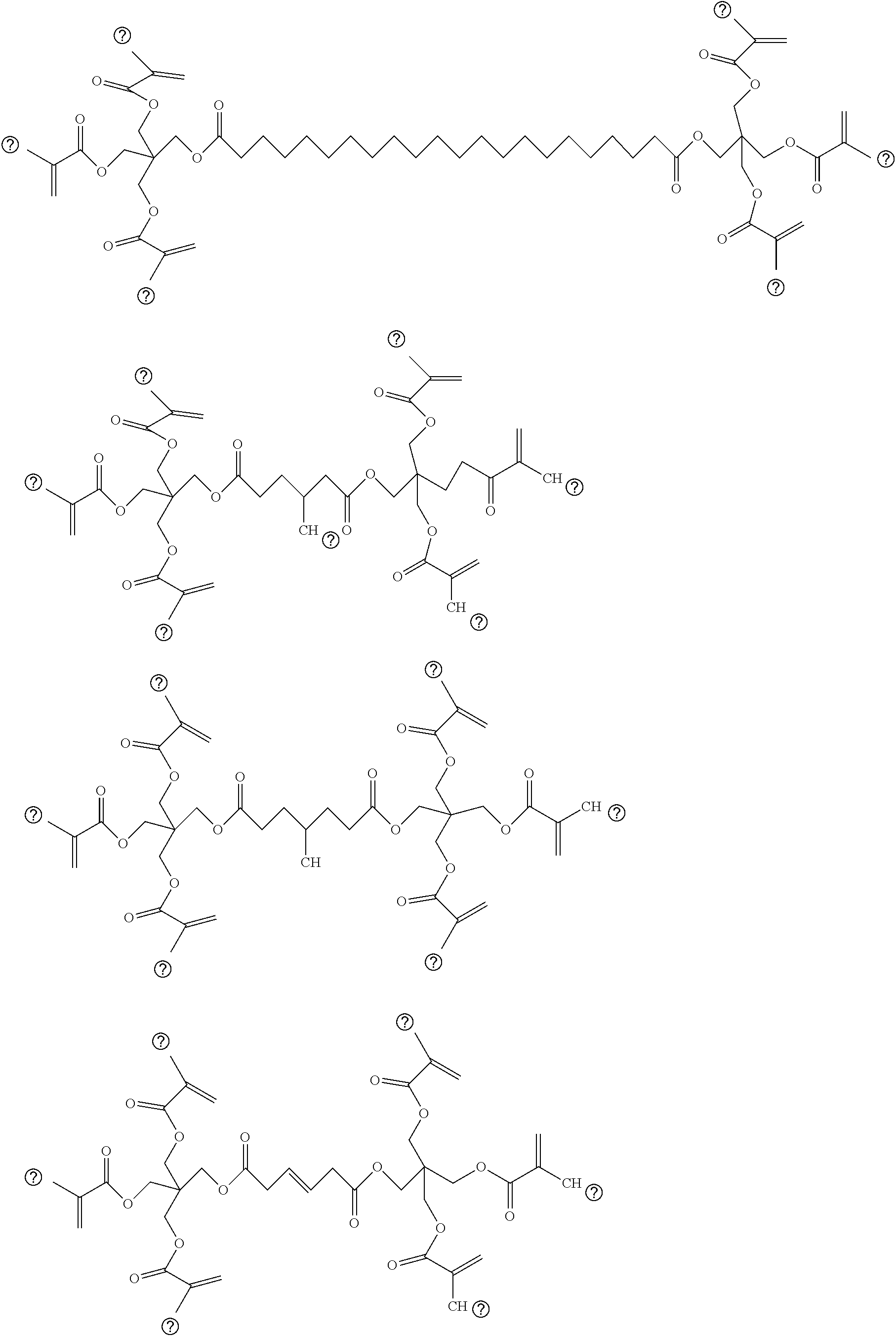

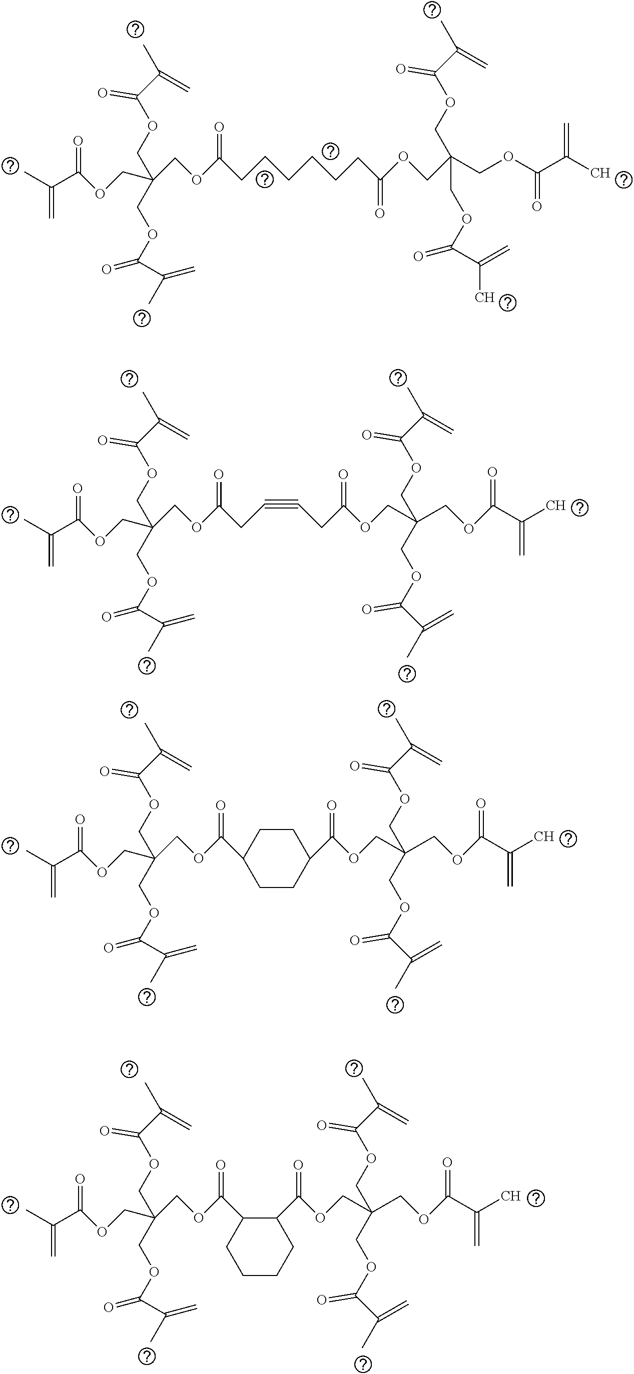

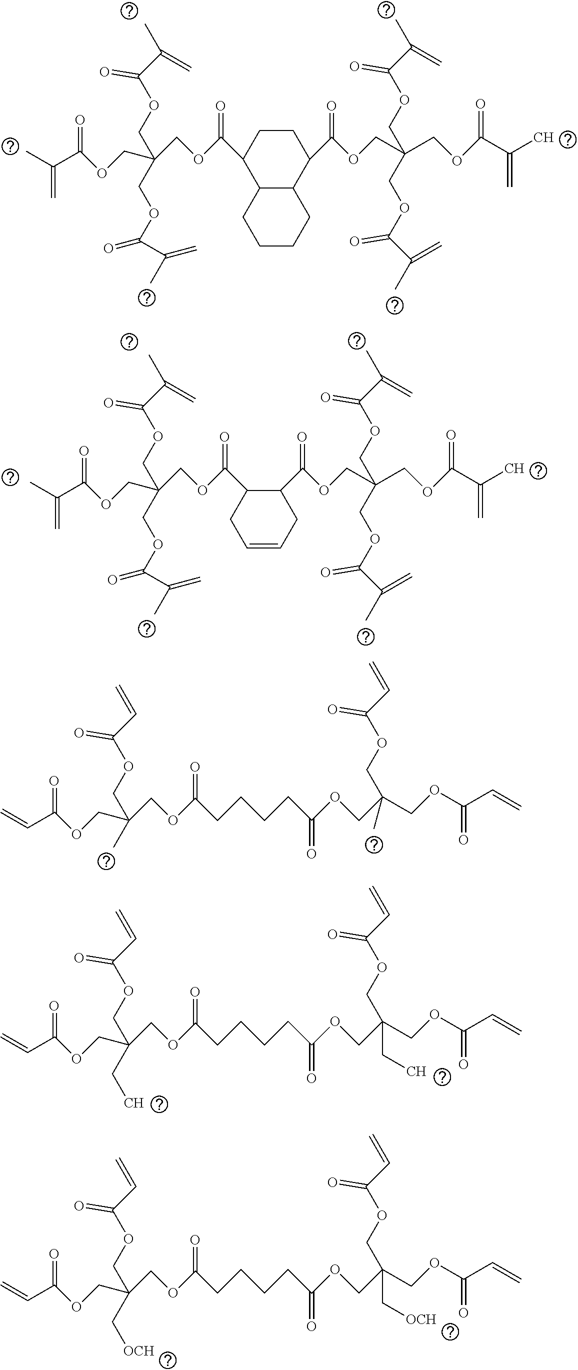

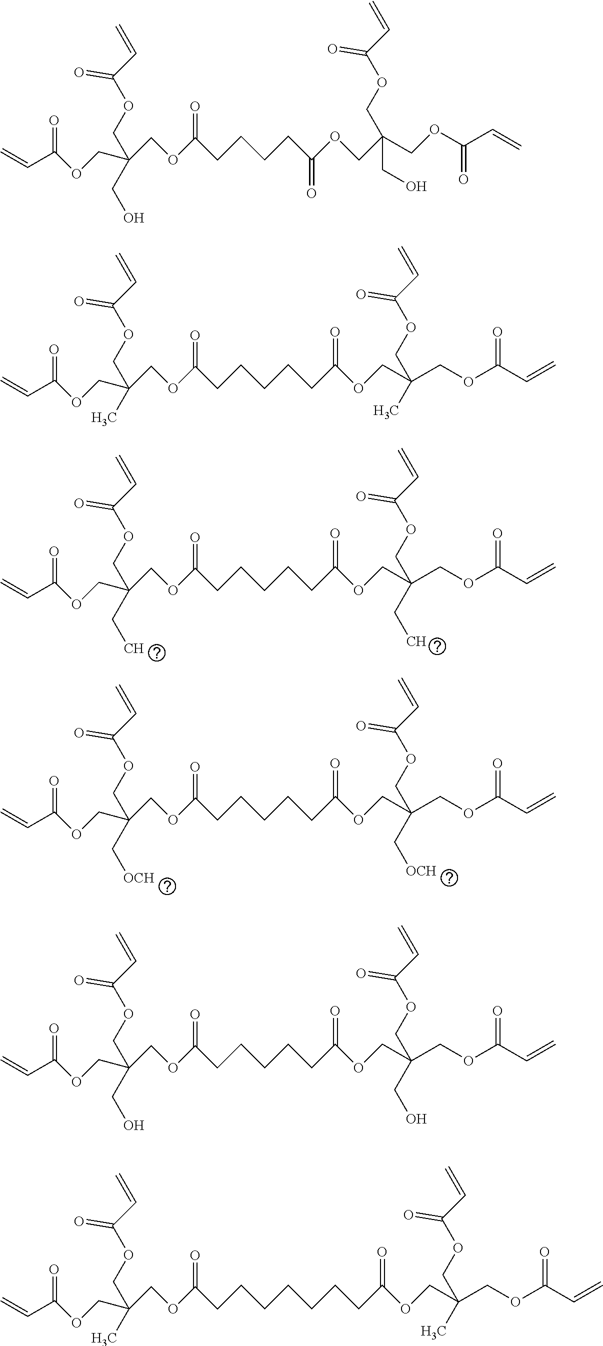

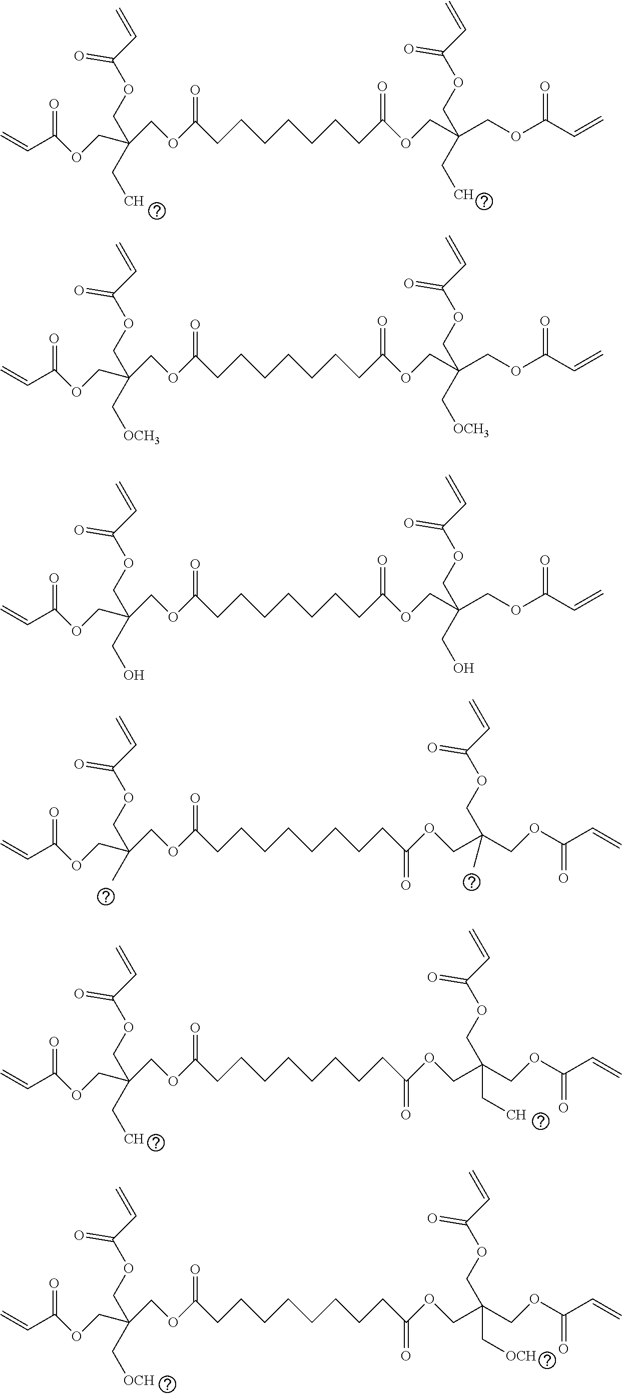

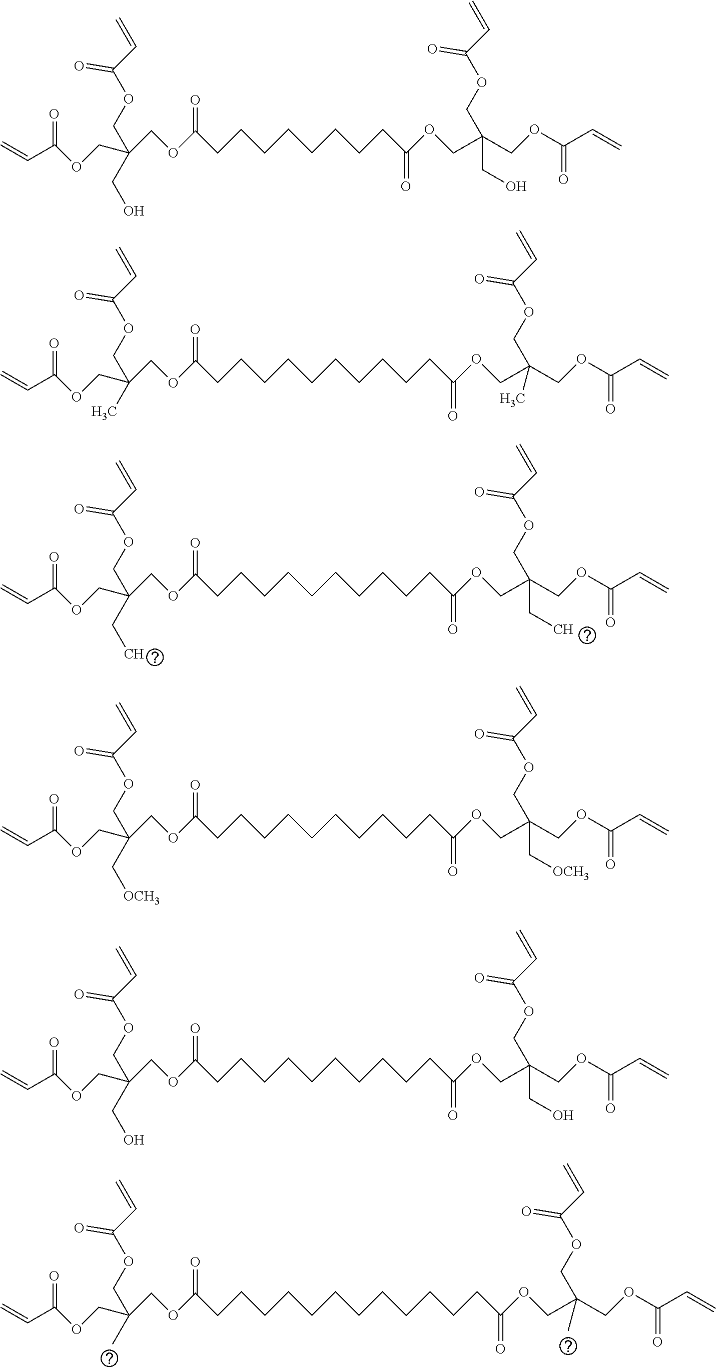

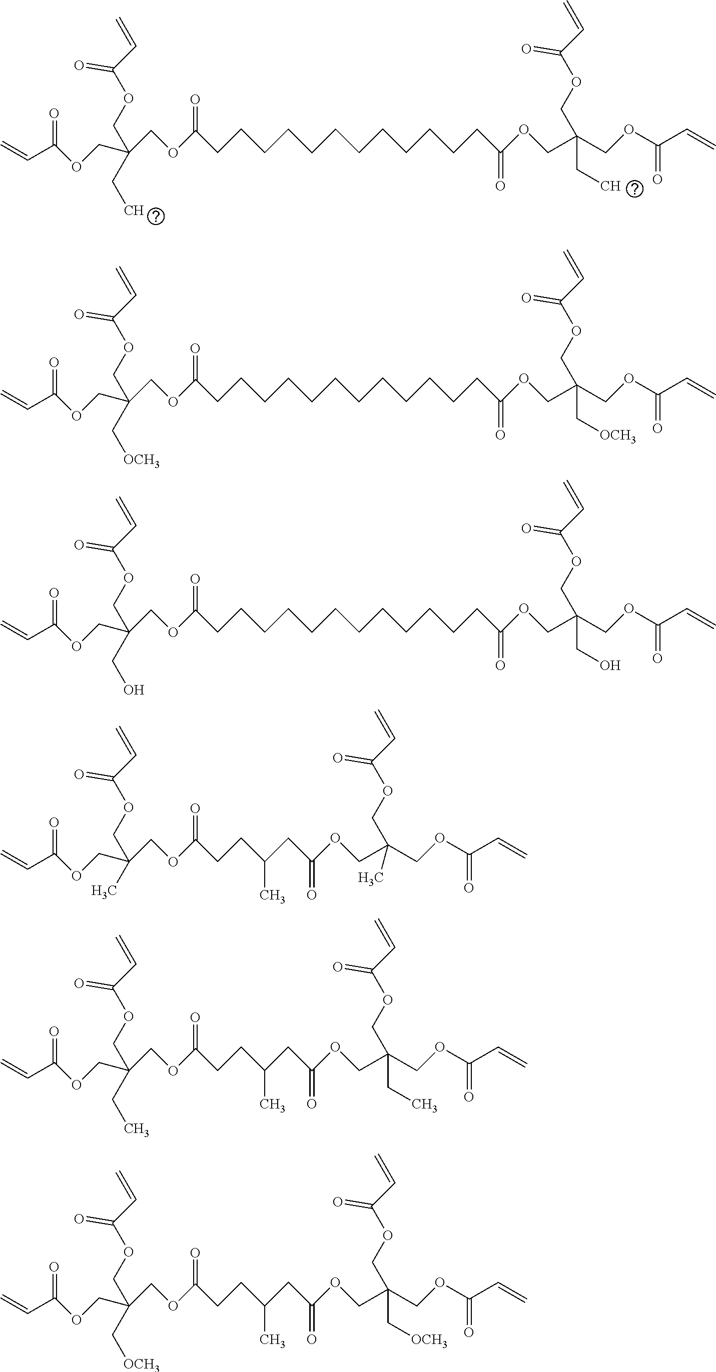

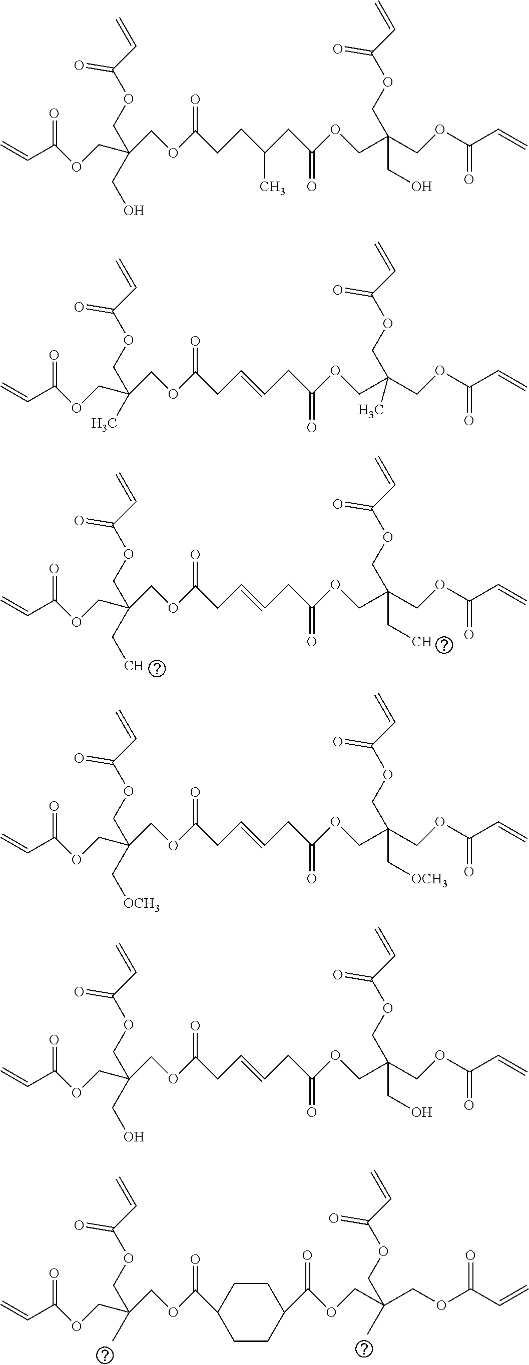

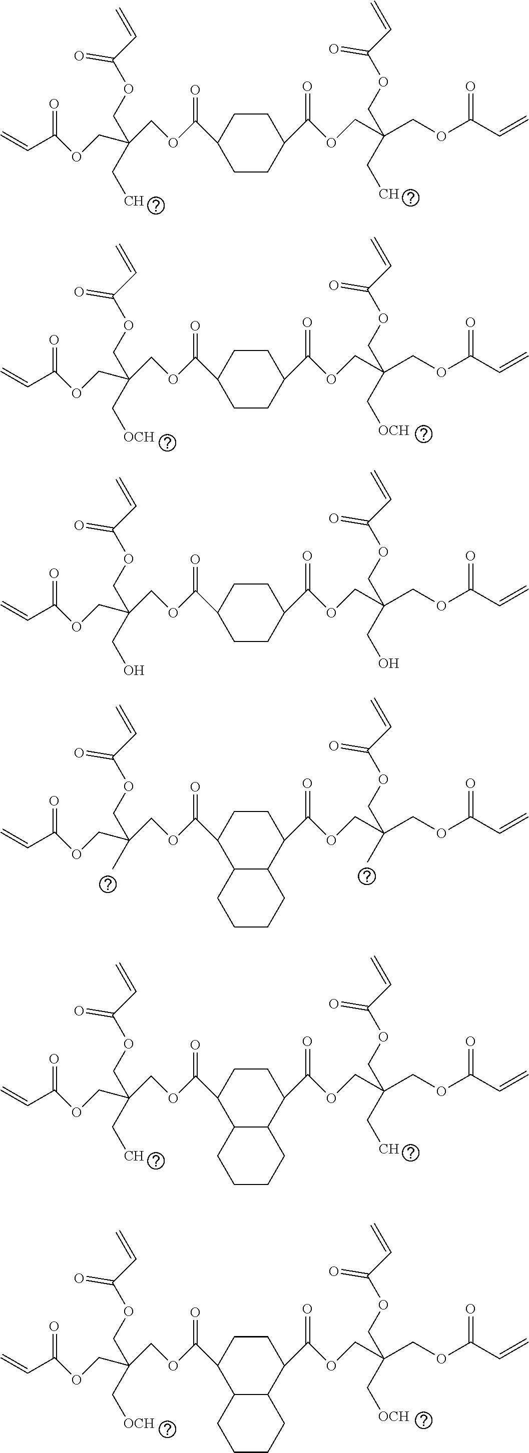

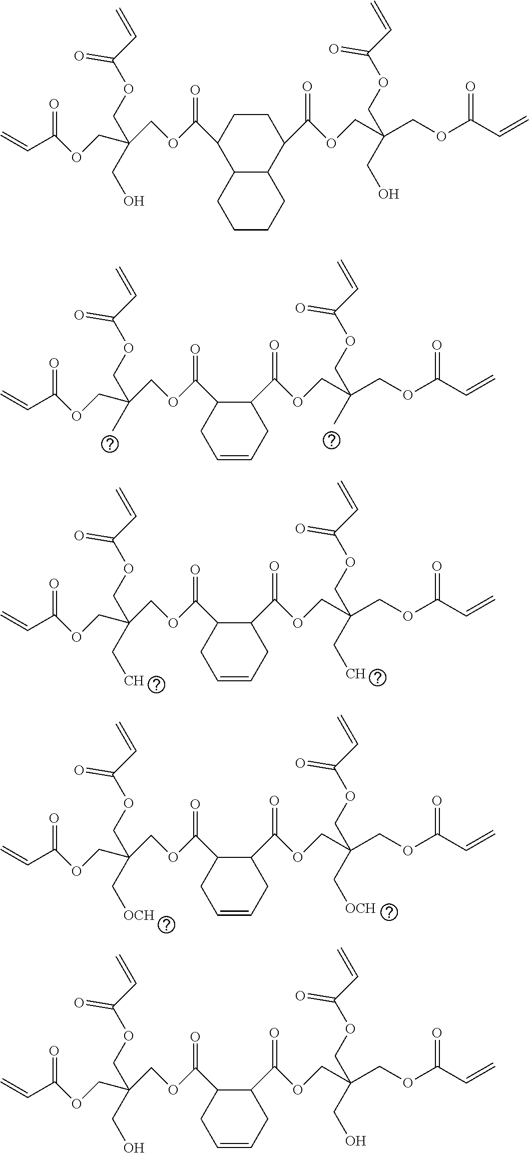

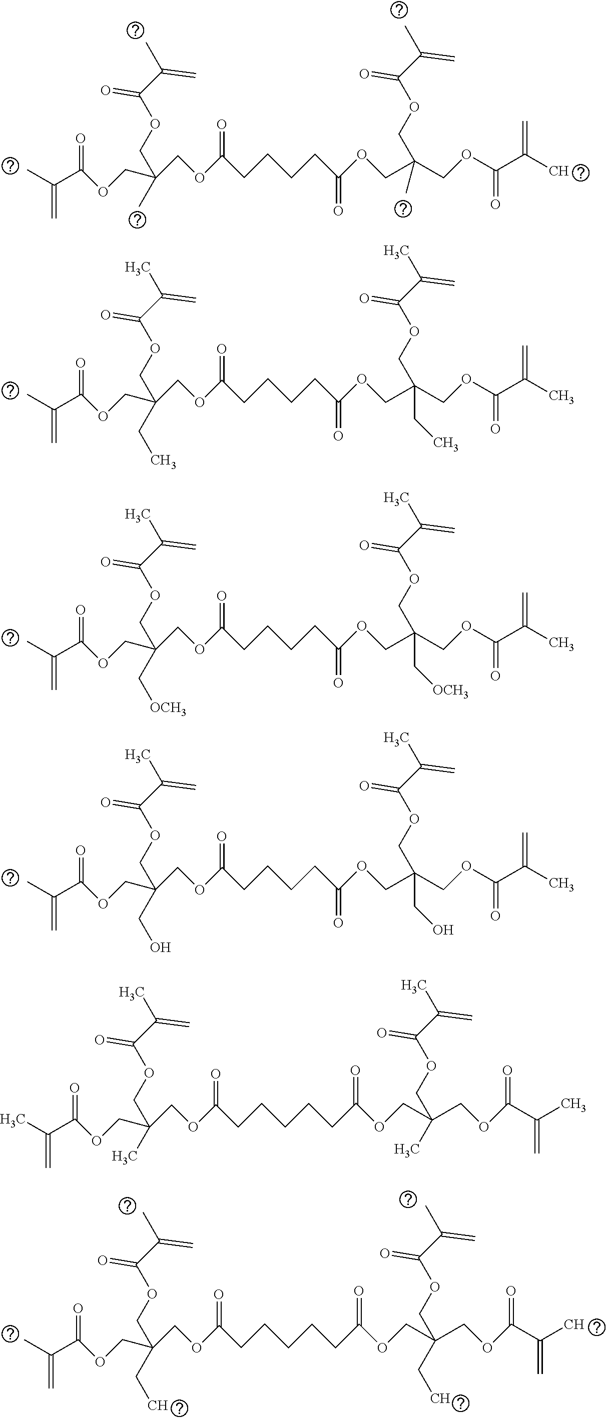

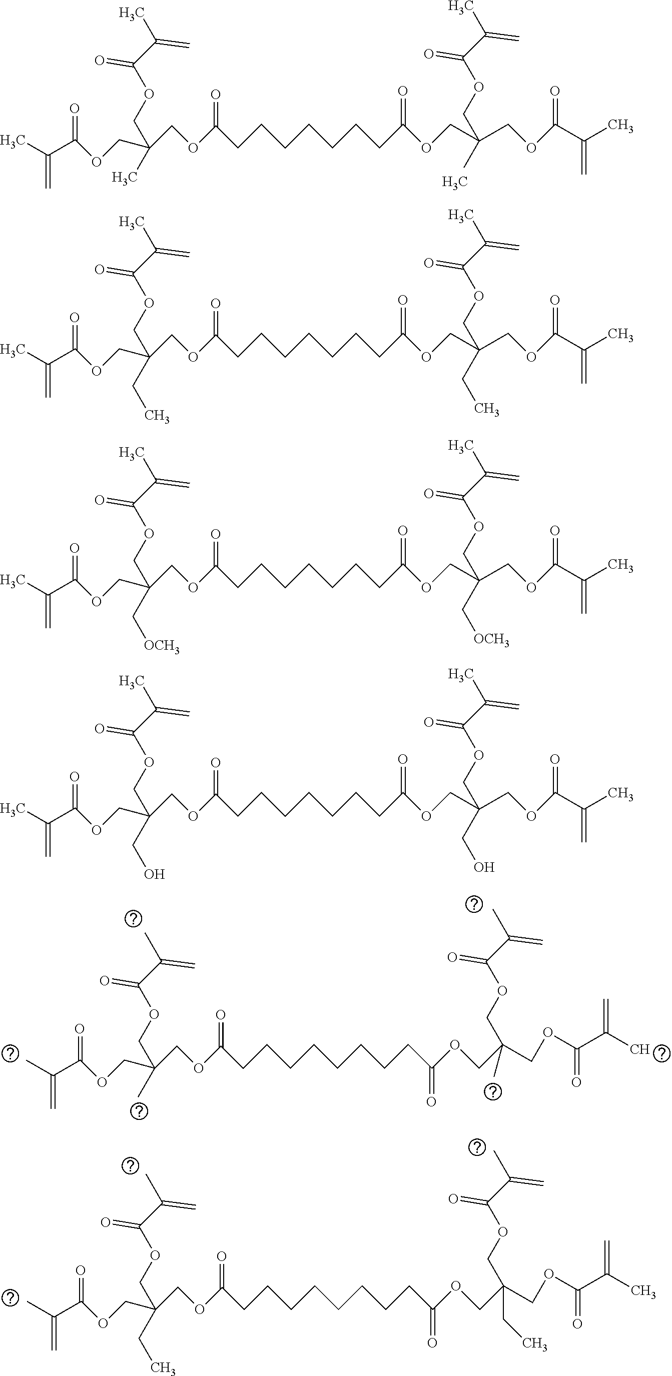

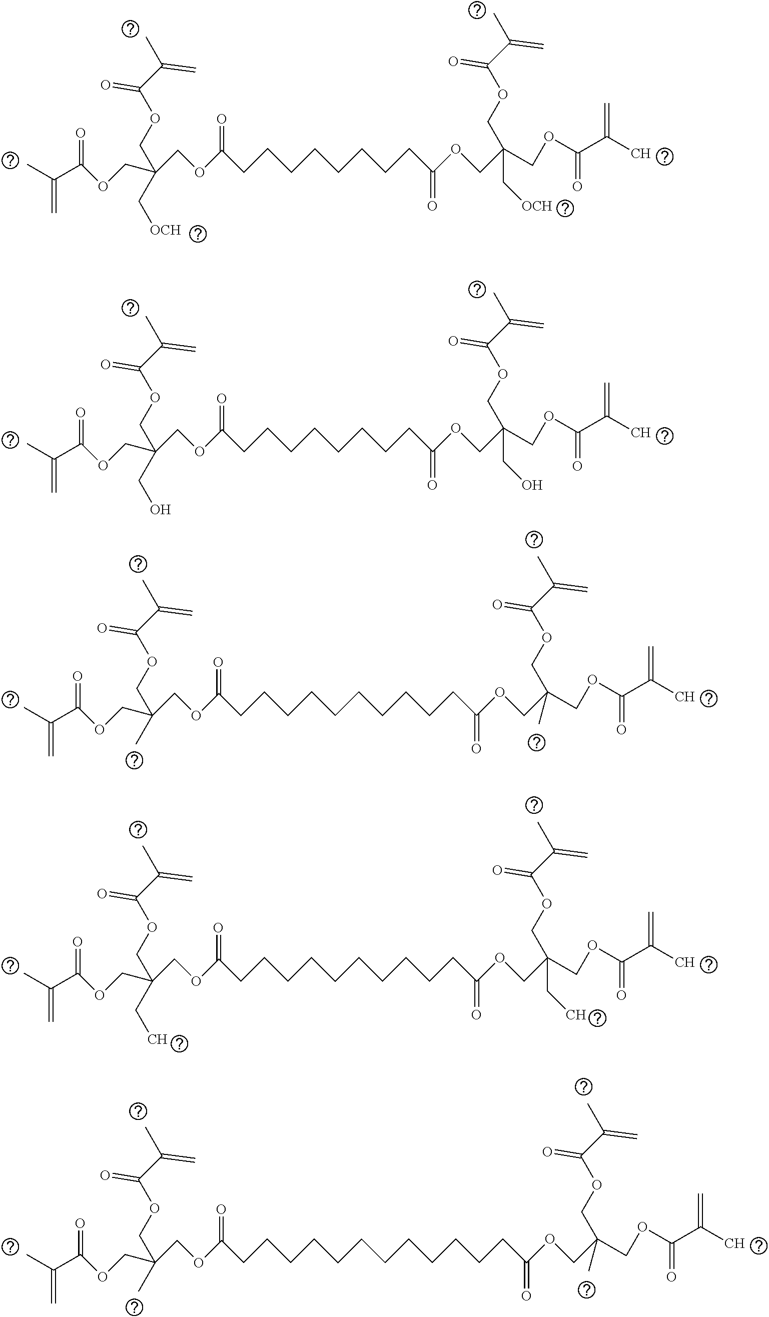

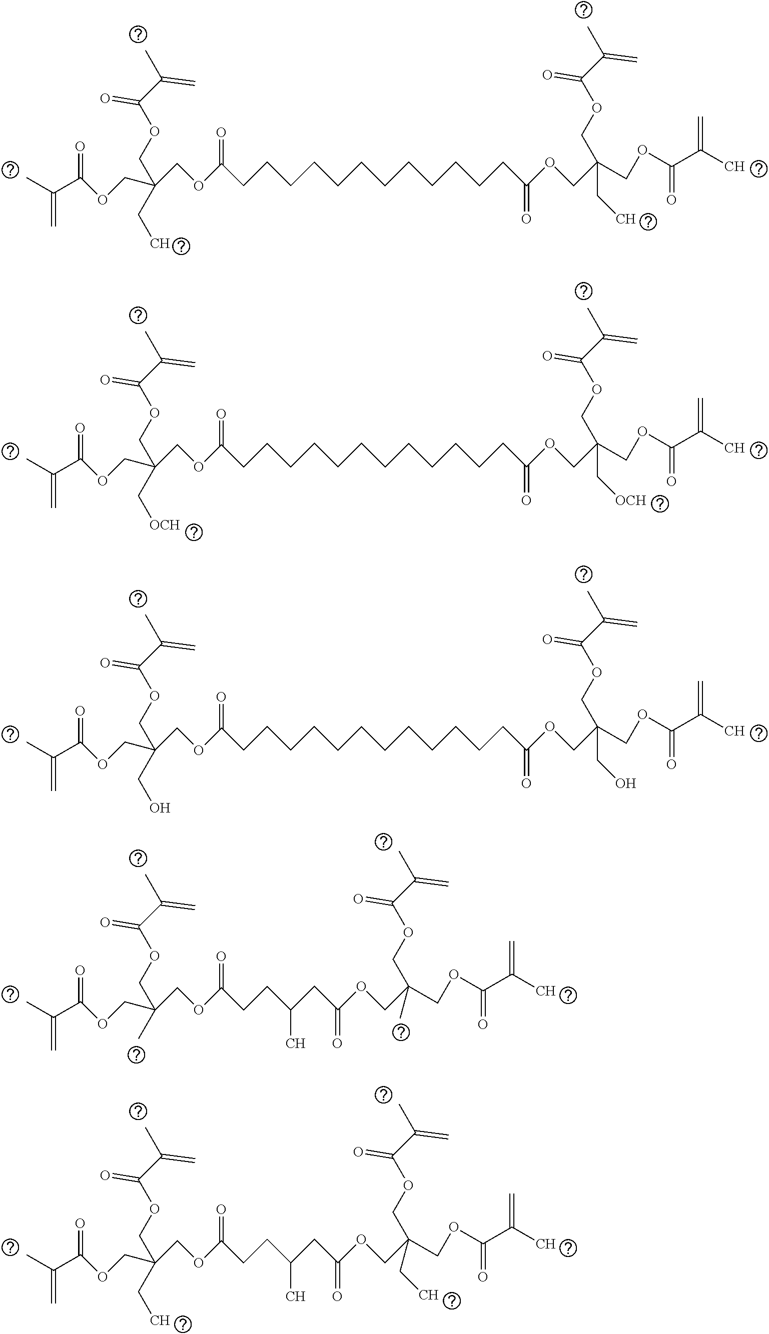

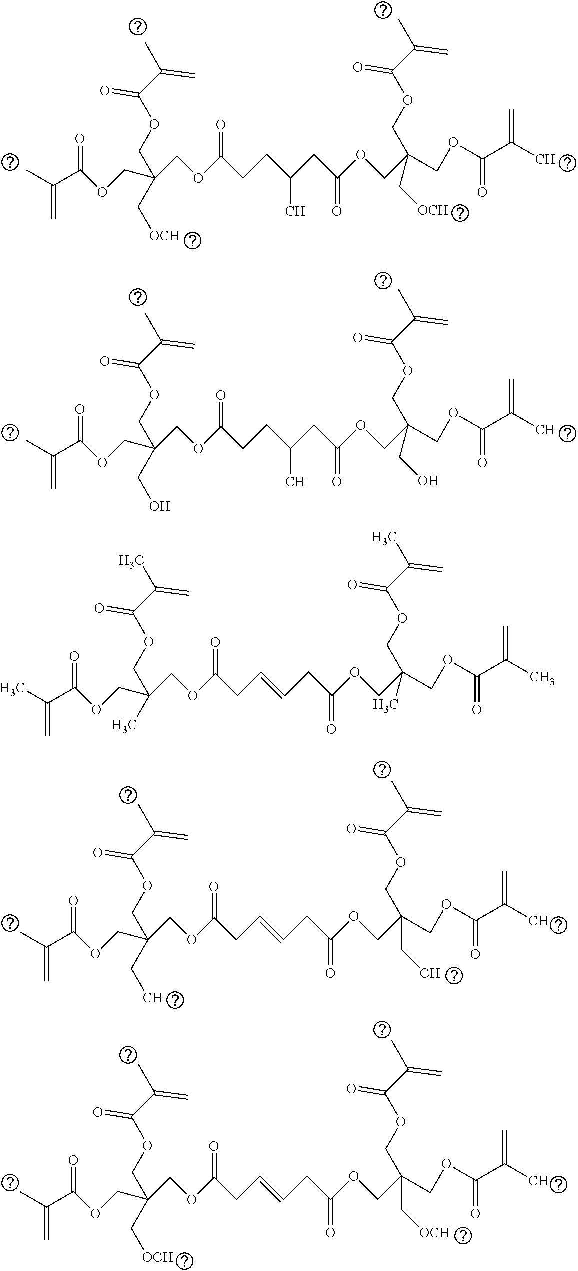

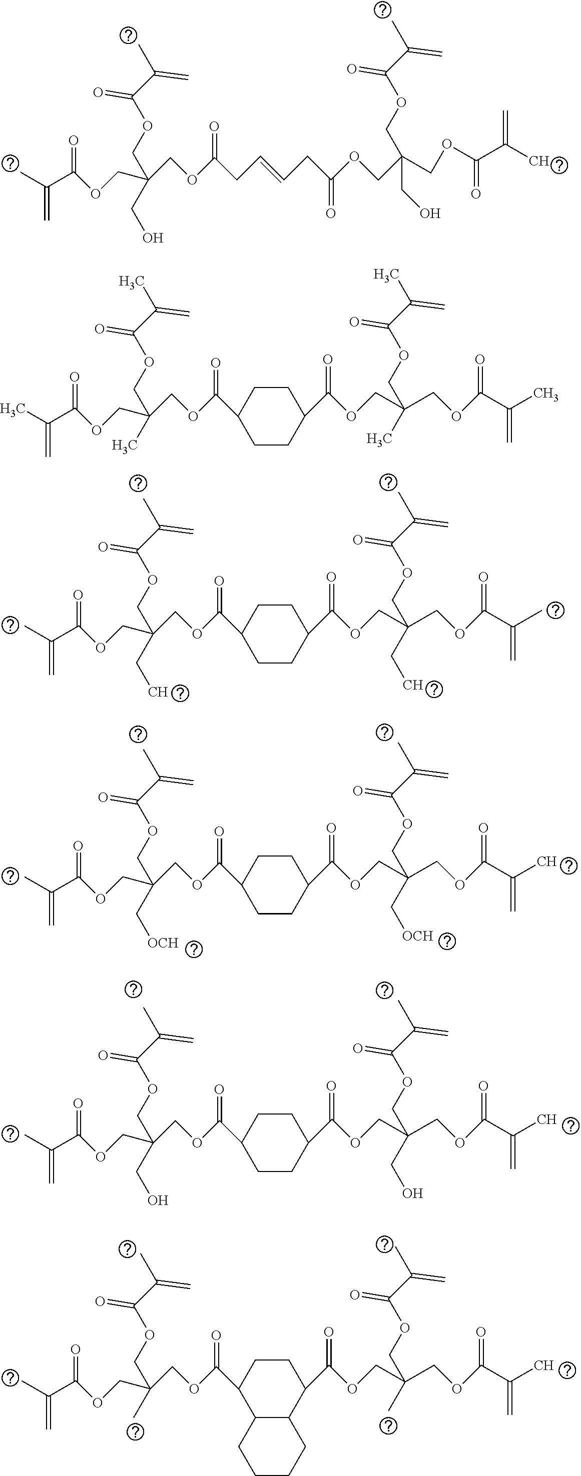

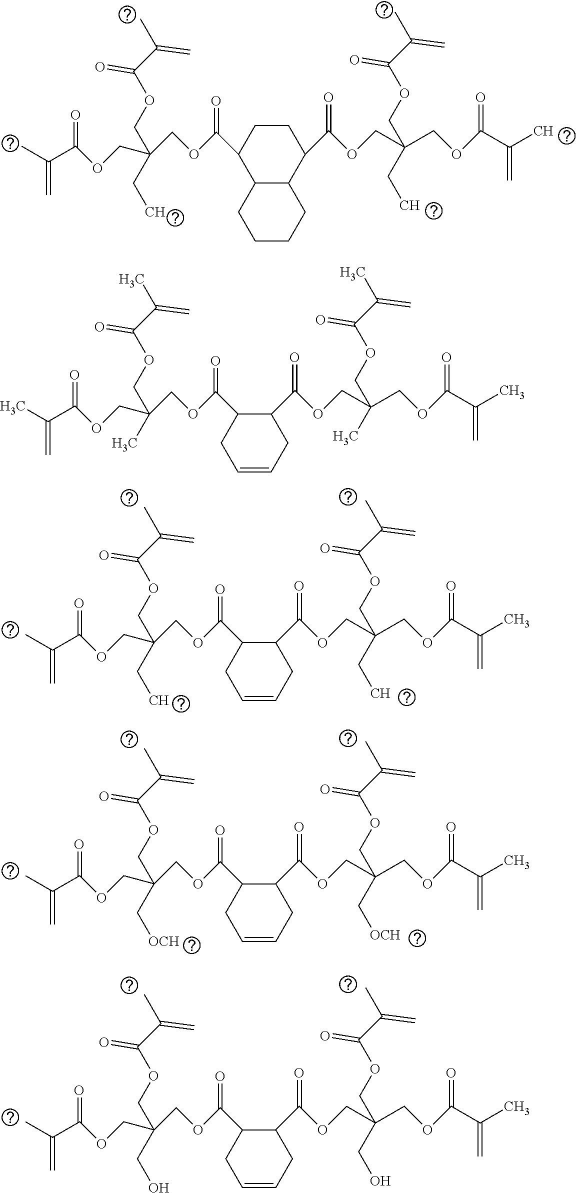

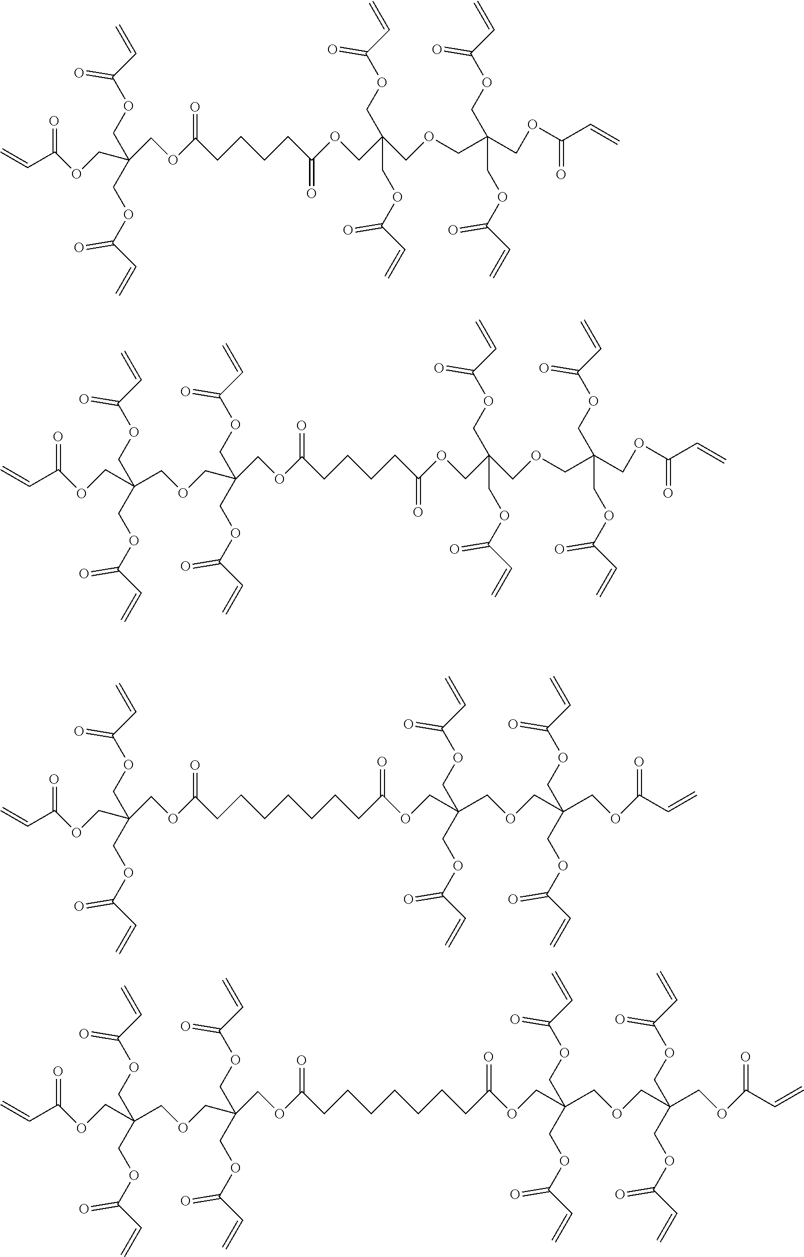

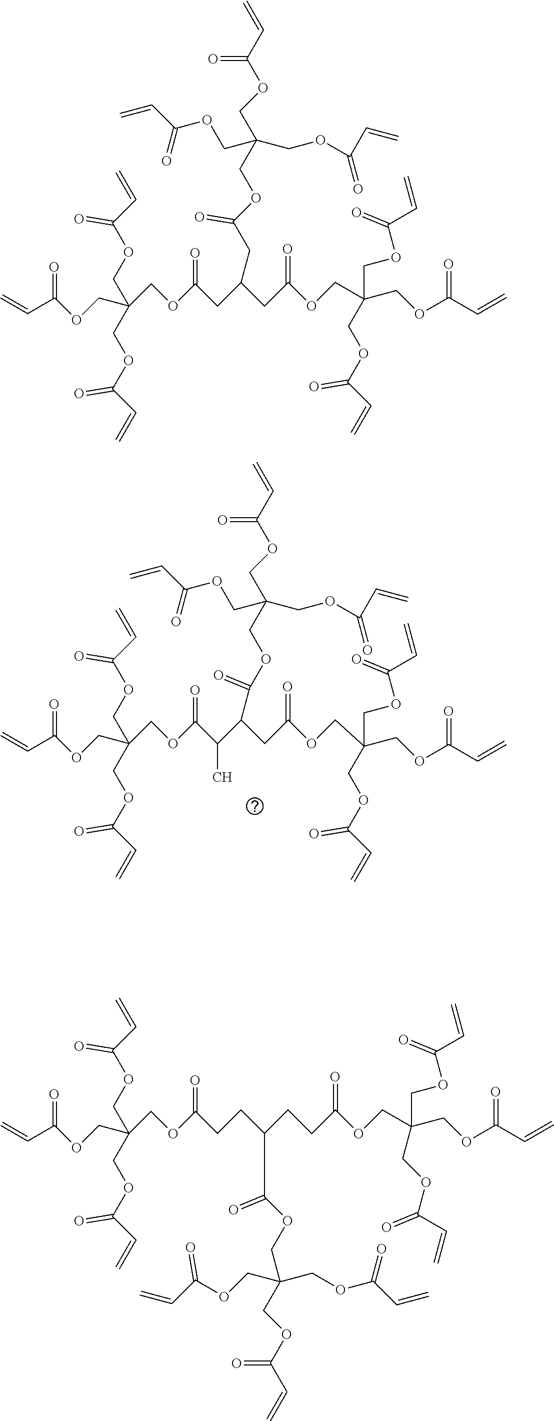

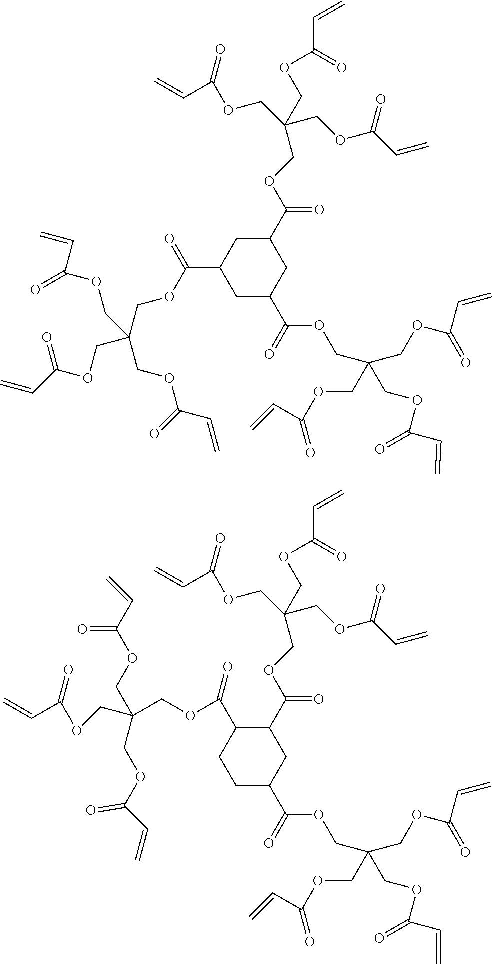

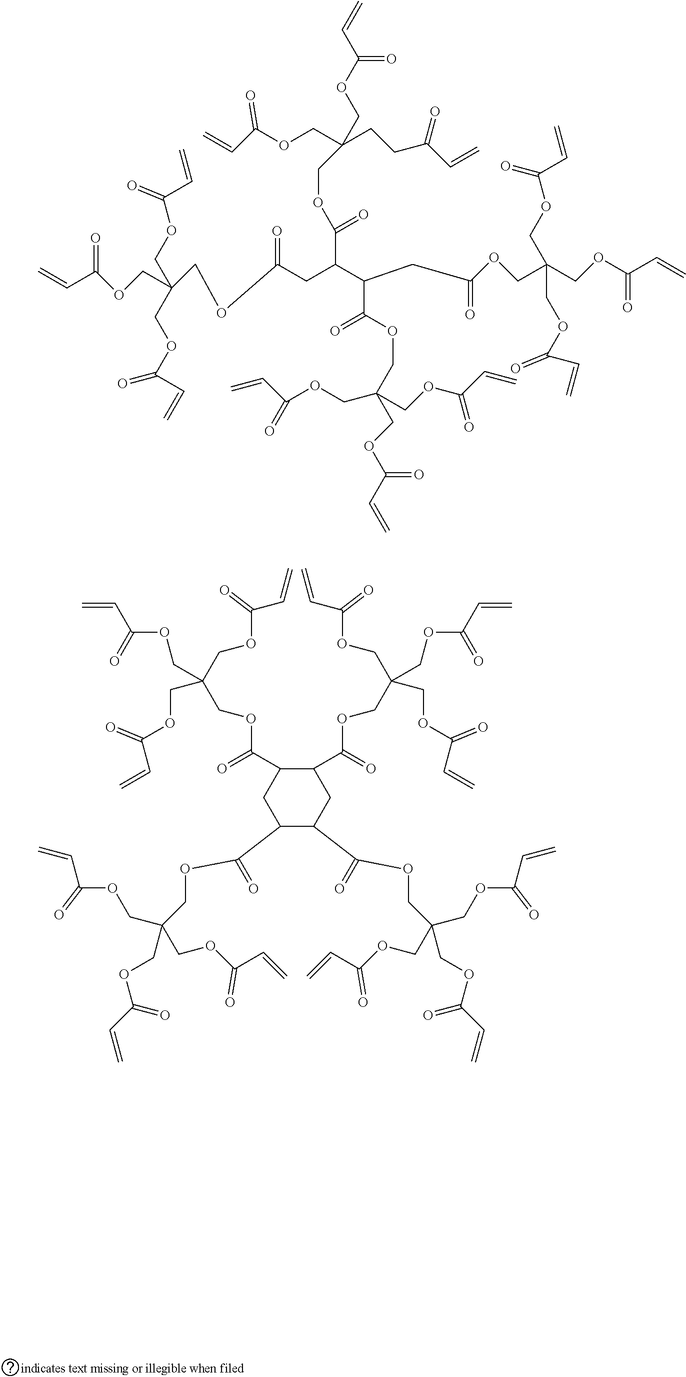

Among them, the following compounds (1-1) to (1-6) are preferred from the viewpoint of the solubility and the electrical characteristics, the compounds (1-1) to (1-5) are more preferred, and the compound (1-2) is particularly preferred, from the viewpoint of the electrical characteristics.

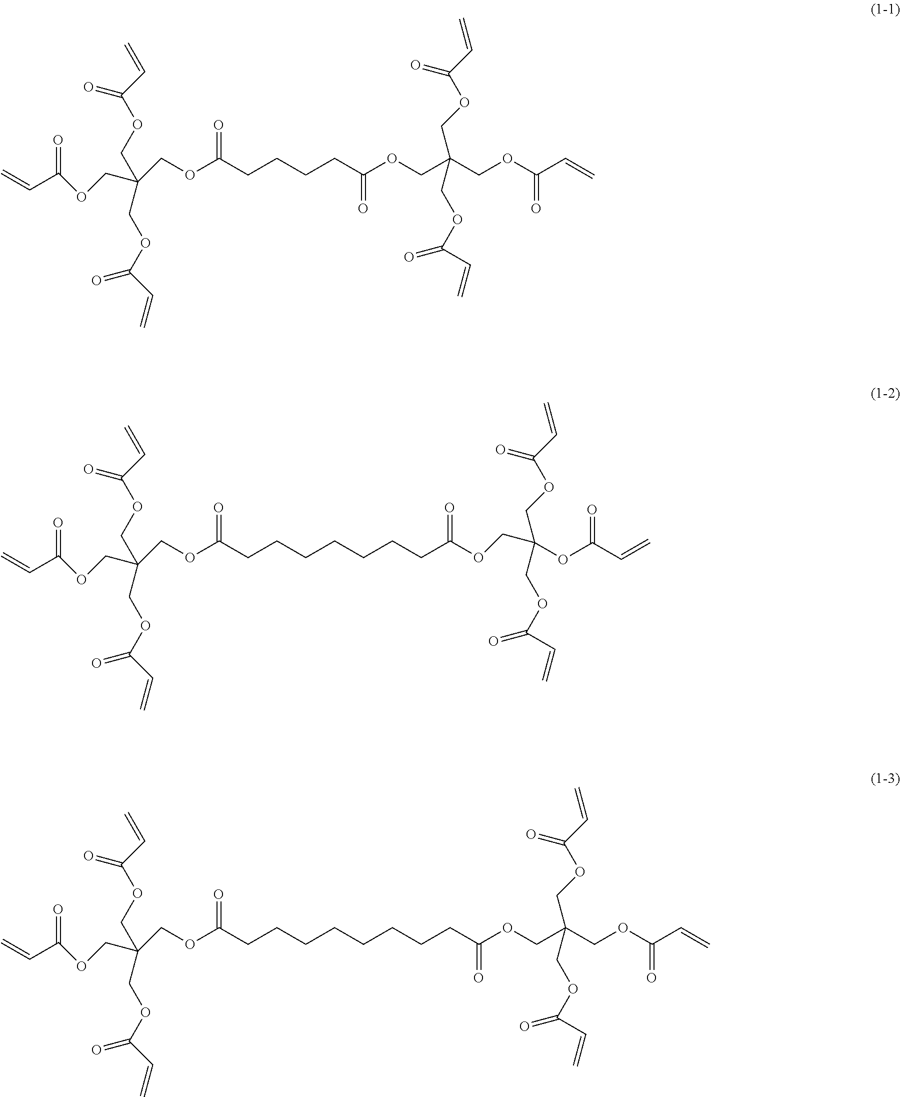

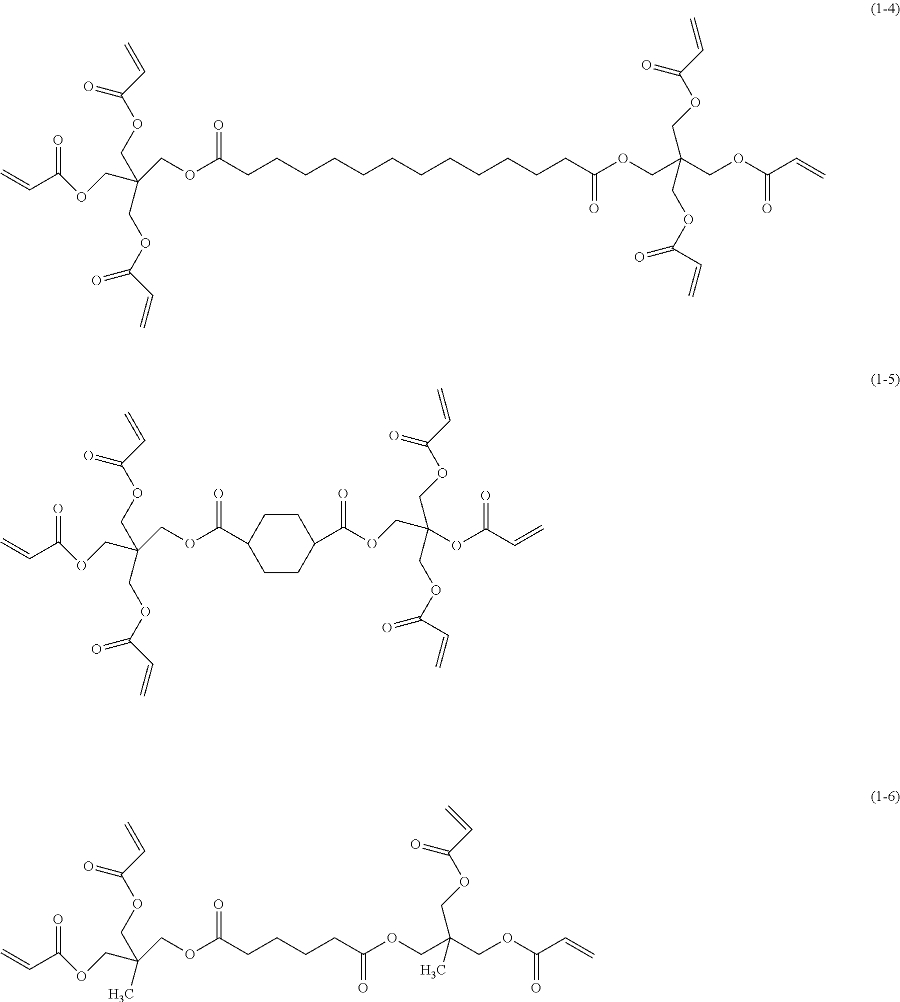

(Polymerization Method of Polymer Contained in Protective Layer (Outermost Layer))

The polymer contained in the protective layer (the outermost layer) may be polymerized by a method such as radical polymerization in which a reaction is initiated by applying energy such as heat, light, and radiant rays to the above raw material. However, the polymerization method is not particularly limited as long as the polymer can be obtained.

(Partial Structure of Polymer Contained in Protective Layer (Outermost Layer))

Each of the above polymers contained in the protective layer (the outermost layer) preferably further has a “partial structure having a charge transporting ability” from the viewpoint of improving the mechanical strength and charge transportability of the protective layer (the outermost layer).

When each of the above polymers contained in the protective layer (the outermost layer) further has a “partial structure having a charge transporting ability”, the raw material is not particularly limited. Among them, it is preferred to obtain the polymer by polymerizing each of the above compounds as raw materials of the polymer contained in the protective layer (the outermost layer) and a chain polymerizable functional group-containing charge transport material.

Examples of the chain polymerizable functional group in the chain polymerizable functional group-containing charge transport material include an acryloyl group, a methacryloyl group, a vinyl group, and an epoxy group. Among them, an acryloyl group or a methacryloyl group is preferred from the viewpoint of curability.

Examples of a structure of a charge transport material portion of the chain polymerizable functional group-containing charge transport material, that is, a partial structure having a charge transporting ability in the polymer include structures derived from electron-donating materials such as heterocyclic compounds such as a carbazole derivative, an indole derivative, an imidazole derivative, an oxazole derivative, a pyrazole derivative, a thiadiazole derivative, and a benzofuran derivative, an aniline derivative, a hydrazone derivative, an arylamine derivative, a stilbene derivative, a butadiene derivative, and an enamine derivative, a compound in which a plurality of these compounds are bonded together, and a polymer having, in a main chain or a side chain thereof, a group constituted of at least one of these compounds. Among them, from the viewpoint of the electrical characteristics, structures derived from a carbazole derivative, an arylamine derivative, a stilbene derivative, a butadiene derivative, an enamine derivative, and a compound in which a plurality of these compounds are bonded together are preferred, and a structure derived from an arylamine derivative is more preferred.

The structure derived from an arylamine derivative is preferably a triarylamine structure.

When the partial structure having a charge transporting ability is a triarylamine structure, a content ratio (a mass ratio) of the hydrocarbon structure X to the triarylamine structure is preferably 0.2 or more and 4 or less, and more preferably 0.4 or more or 2 or less.

Each of the above polymers contained in the protective layer (the outermost layer) preferably further has a structure represented by the following formula (4).

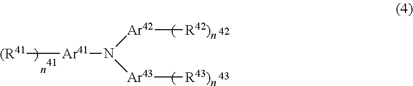

In the formula (4), Ar⁴¹ to Ar⁴³ are aromatic groups. R⁴¹ to R⁴³ are each independently a hydrogen atom, an alkyl group, an alkoxy group, an aryl group, a halogenated alkyl group, a halogen atom, a benzyl group, or a group represented by the following formula (5). n⁴¹ to n⁴³ are each independently an integer of 1 or more. When n⁴¹ is 1, R⁴¹ is a group represented by the formula (5), and when n⁴¹ is an integer of 2 or more, 2 or more R⁴¹'s may be the same as or different from each other, and at least one of R⁴¹'s is a group represented by the formula (5). When n⁴² is an integer of 2 or more, 2 or more R⁴²'s may be the same as or different from each other. When n⁴³ is an integer of 2 or more, 2 or more R⁴³'s may be the same as or different from each other.

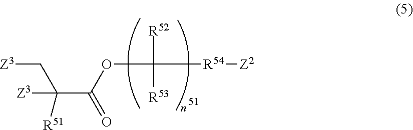

In the formula (5), R⁵¹ represents a hydrogen atom or a methyl group, R⁵² and R⁵³ each independently represent a hydrogen atom, a hydrocarbon group, or an alkoxy group, R⁵⁴ represents a single bond or an oxygen atom, and n⁵¹ represents an integer of 0 or more and 10 or less. Z² represents a bond to Ar⁴¹ to Ar⁴³ in the formula (4), and Z³ represents a bond to any atom.

In the formula (4), Ar⁴¹ to Ar⁴³ are aromatic groups.

R⁴¹ to R⁴³ are each independently a hydrogen atom, an alkyl group, an alkoxy group, an aryl group, a halogenated alkyl group, a halogen atom, a benzyl group, or a group represented by the formula (5). Among them, the number of carbon atoms in the alkyl group, the alkoxy group, and the halogenated alkyl group is generally 1 or more, and on the other hand, is generally 10 or less, preferably 8 or less, more preferably 6 or less, and even more preferably 4 or less.

Specific examples of the alkyl group include a methyl group, an ethyl group, a propyl group, an isopropyl group, a butyl group, a tert-butyl group, an isobutyl group, and a cyclohexyl group. Specific examples of the alkoxy group include a methoxy group, an ethoxy group, a propoxy group, and a cyclohexoxy group. Examples of the aryl group include a phenyl group and a naphthyl group. Examples of the halogenated alkyl group include a chloroalkyl group and a fluoroalkyl group. Examples of the halogen atom include a fluorine atom, a chlorine atom, and a bromine atom. More preferred are a methyl group, an ethyl group, and a phenyl group.

n⁴¹ to n⁴³ are each independently an integer of 1 or more, are generally 1 or more, and are generally 5 or less, preferably 3 or less, and most preferably 1.

When n⁴¹ is 1, R⁴¹ is a group represented by the formula (5), and when n⁴¹ is an integer of 2 or more, 2 or more R⁴¹'s may be the same as or different from each other, and at least one of R⁴¹'s is a group represented by the formula (5).

When n⁴² is an integer of 2 or more, 2 or more R⁴²'s may be the same as or different from each other, and when n⁴³ is an integer of 2 or more, 2 or more R⁴³'s may be the same as or different from each other.

From the viewpoint of the strength of the cured film, it is preferred that n⁴¹ to n⁴³ are 1, R⁴¹ is a group represented by the formula (5) and either R⁴² or R⁴³ is a group represented by the formula (5), or n⁴¹ to n⁴³ are 1, and R⁴¹ to R⁴³ are a group represented by the formula (5).

From the viewpoint of the solubility, it is more preferred that n⁴¹ to n⁴³ are 1, R⁴¹ is a group represented by the formula (5), and either R⁴² or R⁴³ is a group represented by the formula (5).

Examples of R⁵² and R⁵³ are equivalent to those for the above R²² and R²³, respectively.

n⁵¹ is an integer of 0 or more and 10 or less, is generally 0 or more, and is generally 10 or less, preferably 6 or less, more preferably 4 or less, and even more preferably 3 or less.

As the chain polymerizable functional group-containing charge transport material, a compound having a structure represented by the following formula (4′) is preferred.

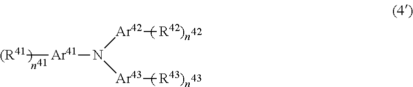

In the formula (4′), Ar⁴¹ to Ar⁴³ are aromatic groups.

R⁴¹ to R⁴³ are each independently a hydrogen atom, an alkyl group, an alkoxy group, an aryl group, a halogenated alkyl group, a halogen atom, a benzyl group, or a group represented by the following formula (5′).

n⁴¹ to n⁴³ are each independently an integer of 1 or more. When n⁴¹ is 1, R⁴¹ is a group represented by the formula (5′), and when n⁴¹ is an integer of 2 or more, 2 or more R⁴¹'s may be the same as or different from each other, and at least one of R⁴¹'s is a group represented by the formula (5′). When n⁴² is an integer of 2 or more, 2 or more R⁴²'s may be the same as or different from each other, and when n⁴³ is an integer of 2 or more, 2 or more R⁴³'s may be the same as or different from each other.

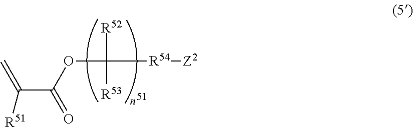

In the formula (5′), R⁵¹ represents a hydrogen atom or a methyl group. R⁵² and R⁵³ each independently represent a hydrogen atom, a hydrocarbon group, or an alkoxy group. R⁵⁴ represents a single bond or an oxygen atom. n⁵¹ represents an integer of 0 or more and 10 or less. Z² represents a bond to Ar⁴¹ to Ar⁴³ in the formula (4′).

The compound having the structure represented by the formula (4′) is exemplified below.

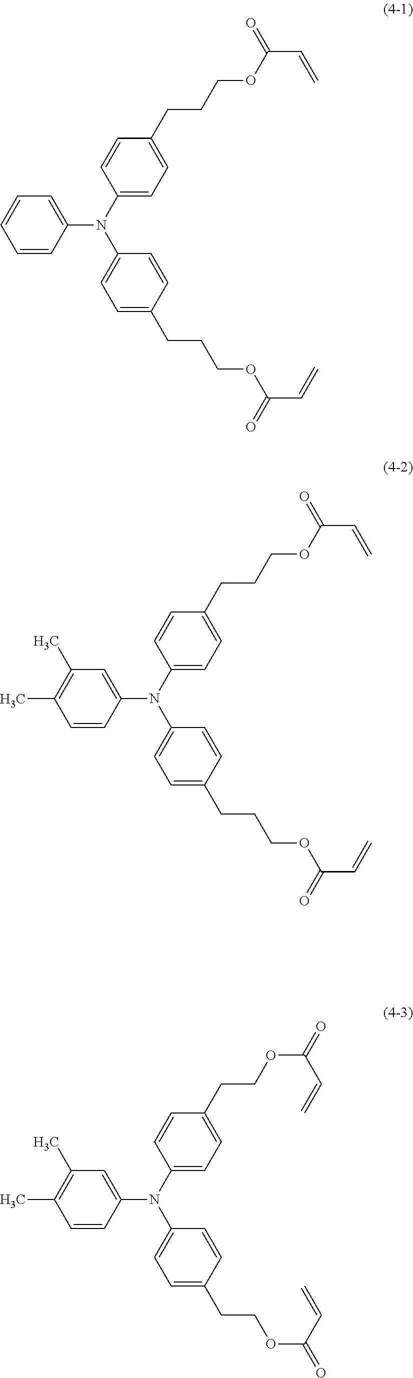

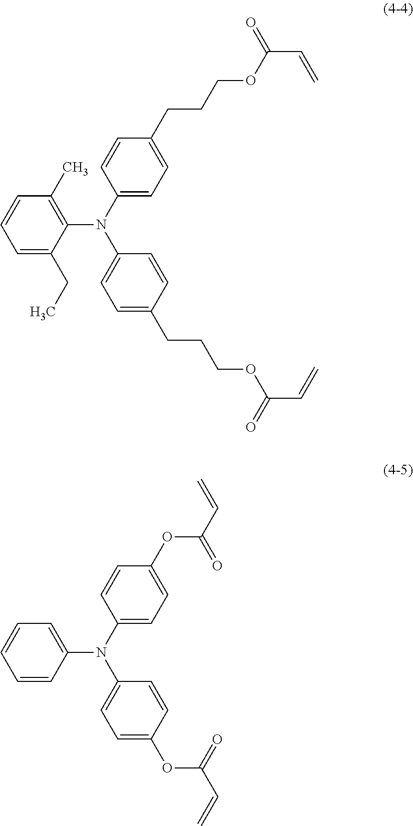 [SMILES: C=CC(=O)OCCCc1ccc(N(c2ccc(CCCOC(=O)C=C)cc2)c2c(C)cccc2CC)cc1 ; C=CC(=O)Oc1ccc(N(c2ccccc2)c2ccc(OC(=O)C=C)cc2)cc1]

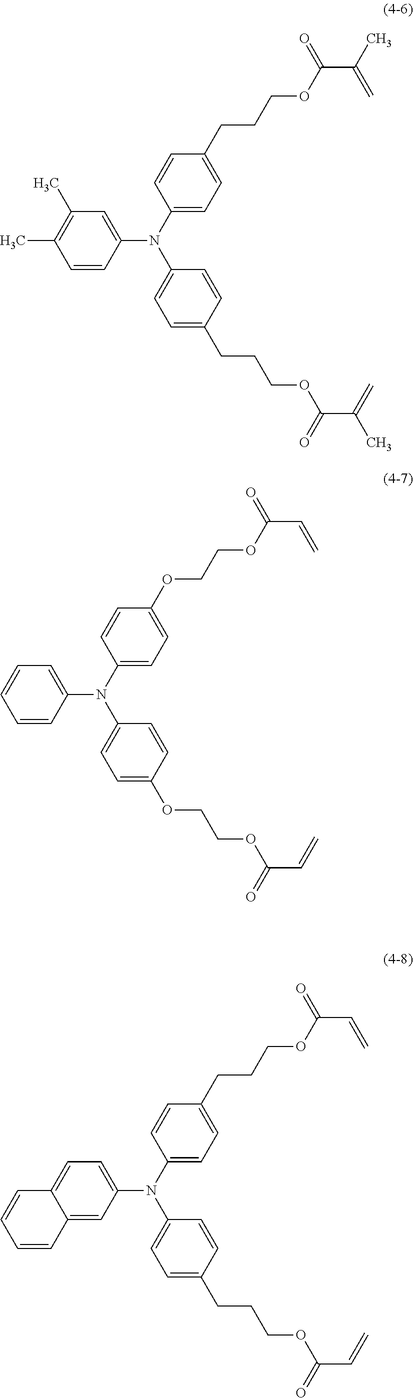 [SMILES: C=C(C)C(=O)OCCCc1ccc(N(c2ccc(CCCOC(=O)C(=C)C)cc2)c2ccc(C)c(C)c2)cc1 ; C=CC(=O)OCCOc1ccc(N(c2ccccc2)c2ccc(OCCOC(=O)C=C)cc2)cc1 ; C=CC(=O)OCCCc1ccc(N(c2ccc(CCCOC(=O)C=C)cc2)c2ccc3ccccc3c2)cc1]

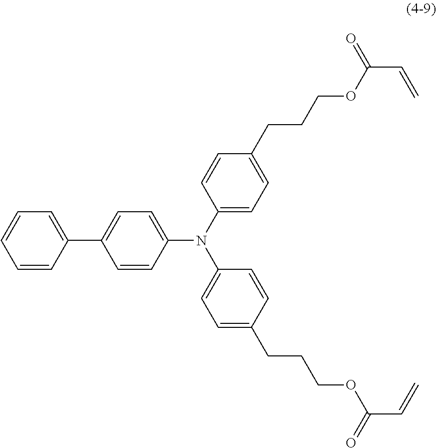 [SMILES: C=CC(=O)OCCCc1ccc(N(c2ccc(CCCOC(=O)C=C)cc2)c2ccc(-c3ccccc3)cc2)cc1]

Among the above compounds, from the viewpoint of the electrical characteristics, the compounds represented by the formula (4-1), formula (4-2), formula (4-3), formula (4-4), formula (4-6), and formula (4-7) are preferred, and the compounds represented by the formula (4-1), formula (4-2), and formula (4-3) are more preferred.

When each of the above polymers contained in the protective layer (the outermost layer) further has the structure represented by the formula (4), a content ratio (a mass ratio) of the structure represented by the formula (A), formula (B), or formula (1) to the structure represented by the formula (4) in each of the polymers is generally 0.2 or more, and preferably 0.4 or more, and is generally 4 or less, and preferably 2 or less.

Each of the above polymers contained in the protective layer (the outermost layer) may further have other partial structures from the viewpoint of adjusting the mechanical strength of the protective layer (the outermost layer).

The raw material of such a polymer is not particularly limited. For example, it is preferred to obtain the polymer by polymerizing each of the above compounds as the raw material of the polymer contained in the protective layer (the outermost layer) and a chain polymerizable functional group-containing compound.

Examples of the chain polymerizable functional group in the chain polymerizable functional group-containing compound include an acryloyl group, a methacryloyl group, a vinyl group, and an epoxy group. The chain polymerizable functional group-containing compound is not particularly limited as long as it is a known material, and from the viewpoint of curability, a monomer, an oligomer or a polymer having an acryloyl group or a methacryloyl group is preferred.

Preferred examples of the chain polymerizable functional group-containing compound are shown below.

Examples thereof include trimethylolpropane triacrylate (TMPTA), trimethylolpropane trimethacrylate, HPA-modified trimethylolpropane triacrylate, EO-modified trimethylolpropane triacrylate, PO-modified trimethylolpropane triacrylate, caprolactone-modified trimethylolpropane triacrylate, HPA-modified trimethylolpropane trimethacrylate, pentaerythritol triacrylate, pentaerythritol tetraacrylate, glycerol triacrylate, ECH-modified glycerol triacrylate, EO-modified glycerol triacrylate, PO-modified glycerol triacrylate, tris(acryloxyethyl) isocyanurate, caprolactone-modified tris(acryloxyethyl) isocyanurate, EO-modified tris(acryloxyethyl) isocyanurate, PO-modified tris(acryloxyethyl) isocyanurate, dip entaerythritol hexaacrylate, cap rolactone-modified dip entaerythritol hexaacrylate, dipentaerythritol hydroxypentaacrylate, alkyl-modified dipentaerythritol pentaacrylate, alkyl-modified dipentaerythritol tetraacrylate, alkyl-modified dipentaerythritol triacrylate, dimethylolpropane tetraacrylate, pentaerythritol ethoxytetraacrylate, EO-modified phosphoric acid triacrylate, 2,2,5,5, -tetrahydroxymethylcyclopentanone tetraacrylate, 2-hydroxy-3-acryloyloxypropyl methacrylate, polyethylene glycol diacrylate, polypropylene glycol diacrylate, polytetramethylene glycol diacrylate, EO-modified bisphenol A diacrylate, PO-modified bisphenol A diacrylate, 9,9-bis[4-(2-acryloyloxyethoxy)phenyl]fluorene, tricyclodecanedimethanol diacrylate, decanediol diacrylate, hexanediol diacrylate, ethylene glycol dimethacrylate, polyethylene glycol dimethacrylate, EO-modified bisphenol A dimethacrylate, PO-modified bisphenol A dimethacrylate, tricyclodecanedimethanol dimethacrylate, decanediol dimethacrylate, and hexanediol dimethacrylate.

Here, E0 means ethylene oxide, PO means propylene oxide, HPA means 2-hydroxypropyl acrylate, and ECH means epichlorohydrin.

Examples of the oligomer or the polymer having an acryloyl group or a methacryloyl group include a known urethane acrylate, ester acrylate, acrylic acrylate, and epoxy acrylate.

Examples of the urethane acrylate include “EBECRYL (registered trademark) 8301”, “EBECRYL¹²⁹⁰”, “EBECRYL¹⁸³⁰”, and “KRM 8200” (all manufactured by Daicel-Allnex Ltd.), and “UV 1700B”, “UV 7640B”, “UV 7605B”, “UV 6300B”, and “UV 7550B” (all manufactured by Mitsubishi Chemical Corporation).

Examples of the ester acrylate include “M-7100”, “M-7300K”, “M-8030”, “M-8060”, “M-8100”, “M-8530”, “M-8560”, and “M-9050” (all manufactured by Toagosei Co., Ltd.).

Examples of the acrylic acrylate include “8BR-600”, “8BR-930 MB”, “8KX-078”, “8KX-089”, and “8KX-168” (all manufactured by Taisei Fine Chemical Co., Ltd.).

These may be used alone or in combination of two or more kinds thereof.

[Other Materials]

The protective layer (the outermost layer) of the present electrophotographic photoreceptor may contain, in addition to each of the above polymers, a charge transport material or metal oxide particles for the purpose of imparting charge transporting ability.

A polymerization initiator may be contained in order to accelerate the polymerization reaction.

For the purpose of reducing frictional resistance and abrasion of the electrophotographic photoreceptor surface, the protective layer (the outermost layer) may contain a fluorine resin, a silicone resin, or the like, or may contain particles of these resins or particles of an inorganic compound such as aluminum oxide.

Next, the charge transport material, the metal oxide particles, and the polymerization initiator will be described in detail as the “material other than the polymer” which may be contained in the protective layer (the outermost layer). These materials include those used as raw materials for forming the protective layer (the outermost layer).

[Charge Transport Material]

The charge transport material contained in the protective layer (the outermost layer) can be the same as the charge transport material used in the photosensitive layer.

An amount of the charge transport material to be used in at least one protective layer (outermost layer) of the present electrophotographic photoreceptor is not particularly limited. The amount is preferably 10 parts by mass or more, more preferably 30 parts by mass or more, and particularly preferably 50 parts by mass or more with respect to 100 parts by mass of the binder resin, from the viewpoint of the electrical characteristics. The amount is preferably 300 parts by mass or less, more preferably 200 parts by mass or less, and particularly preferably 150 parts by mass or less, from the viewpoint of maintaining good surface resistance. Here, the charge transport material does not include the “chain polymerizable functional group-containing charge transport material” and the metal oxide particles to be described later.

[Metal Oxide Particles]

The protective layer (the outermost layer) may contain metal oxide particles from the viewpoint of imparting charge transporting ability and improving mechanical strength.

As the metal oxide particles, any metal oxide particles that can be generally used in an electrophotographic photoreceptor can be used.

Specific examples of the metal oxide particles include metal oxide particles containing one metal element such as titanium oxide, tin oxide, aluminum oxide, silicon oxide, zirconium oxide, zinc oxide, and iron oxide, and metal oxide particles containing a plurality of metal elements such as calcium titanate, strontium titanate, and barium titanate. Among them, metal oxide particles having a band gap of 2 eV to 4 eV are preferred.

As for the metal oxide particles, only one kind of particles may be used, or a plurality of kinds of particles may be mixed and used. Among the metal oxide particles, titanium oxide, tin oxide, aluminum oxide, silicon oxide, and zinc oxide are preferred, and titanium oxide and tin oxide are more preferred. Titanium oxide is particularly preferred.

As a crystal form of the titanium oxide particles, any one of rutile, anatase, brookite, and amorphous can be used. In addition, from the titanium oxide particles of different crystal states, titanium oxide particles of a plurality of crystal states may be contained.

The surface of the metal oxide particles may be subjected to various surface treatments. For example, the metal oxide particles may be treated with an inorganic compound such as tin oxide, aluminum oxide, antimony oxide, zirconium oxide, and silicon oxide, or with an organic compound such as stearic acid, a polyol, and an organosilicon compound. In particular, when titanium oxide particles are used, they are preferably surface-treated with an organosilicon compound.

Examples of the organosilicon compound include: silicone oils such as dimethylpolysiloxane and methylhydrogenpolysiloxane; organosilanes such as methyldimethoxysilane and dip henyldimethoxysilane; silazanes such as hexamethyldisilazane; and silane coupling agents such as 3-methacryloyloxypropyltrimethoxysilane, 3-acryloyloxypropyltrimethoxysilane, vinyltrimethoxysilane, γ-mercap to propyltrimethoxysilane, and γ-aminopropyltriethoxysilane. In particular, 3-methacryloyloxypropyltrimethoxysilane, 3-acryloyloxypropyltrimethoxysilane, or vinyltrimethoxysilane having a chain polymerizable functional group is preferred from the viewpoint of improving the mechanical strength of the protective layer (the outermost layer).

The outermost surface of the surface-treated particles may be treated with a treatment agent such as aluminum oxide, silicon oxide, or zirconium oxide before being treated with such a treatment agent.

Metal oxide particles having an average primary particle diameter of 500 nm or less are generally preferably used, metal oxide particles having an average primary particle diameter of 100 nm or less are more preferably used, and metal oxide particles having an average primary particle diameter of 50 nm or less are even more preferably used, and metal oxide particles having an average primary particle diameter of 1 nm or more are more preferably used, and metal oxide particles having an average primary particle diameter of 5 nm or more are even more preferably used.

The average primary particle diameter can be obtained based on an arithmetic average value of particle diameters directly observed with a transmission electron microscope (hereinafter also referred to as TEM).

Among the metal oxide particles according to the present invention, specific examples of a trade name of the titanium oxide particles include: ultrafine titanium oxides “TTO-55 (N)” and “TTO-51 (N)” not surface-treated, ultrafine titanium oxides “TTO-55 (A)” and “TTO-55 (B)” coated with Al₂O₃, ultrafine titanium oxide “TTO-55 (C)” surface-treated with stearic acid, ultrafine titanium oxide “TTO-55 (5)” surface-treated with Al₂O₃ and organosiloxane, high-purity titanium oxide “C-EL”, sulfate process titanium oxides “R-550”, “R-580”, “R-630”, “R-670”, “R-680”, “R-780”, “A-100”, “A-220”, and “W-10”, chloride process titanium oxides “CR-50”, “CR-58”, “CR-60”, “CR-60-2”, and “CR-67”, and conductive titanium oxide “ET-300W” (all manufactured by Ishihara Sangyo Kaisha, Ltd.); titanium oxides such as “R-60”, “A-110”, and “A-150”, “SR-1”, “R-GL”, “R-5N”, “R-5N-2”, “R-52N”, “RK-1”, and “A-SP” coated with Al₂O₃, “R-GX” and “R-7E” coated with SiO₂ and Al₂O₃, “R-650” coated with ZnO, SiO₂ and Al₂O₃, and “R-61N” coated with ZrO₂ and Al₂O₃ (all manufactured by Sakai Chemical Industry Co., Ltd.); in addition to “TR-700” surface-treated with SiO₂ and Al₂O₃, and “TR-840” and “TA-500” surface-treated with ZnO, SiO₂ and Al₂O₃, titanium oxides not surface-treated such as “TA-100”, “TA-200”, and “TA-300”, and “TA-400” surface-treated with Al₂O₃ (all manufactured by Fuji Titanium Industry Co., Ltd.); and “MT-150W” and “MT-500B” not surface-treated, “MT-100SA” and “MT-500SA” surface-treated with SiO₂ and Al₂O₃, “MT-100SAS” and “MT-500SAS” surface-treated with SiO₂, Al₂O₃ and organosiloxane (all manufactured by Tayca Corporation).

Specific examples of a trade name of aluminum oxide particles include “Aluminum Oxide C” (manufactured by Nippon Aerosil Co., Ltd.).

Specific examples of a trade name of silicon oxide particles include “200CF”, and “R972” (manufactured by Nippon Aerosil Co., Ltd.), and “KEP-30” (manufactured by Nippon Shokubai Co., Ltd.).

Specific examples of a trade name of tin oxide particles include “SN-100P” and “SN-100D” (manufactured by Ishihara Sangyo Kaisha, Ltd.), “Sn02” (manufactured by CIK Nanotech Corporation), and “S-2000”, phosphorus-doped tin oxide “SP-2”, antimony-doped tin oxide “T-1”, and indium-doped tin oxide “E-ITO” (manufactured by Mitsubishi Materials Corporation).

Specific examples of a trade name of zinc oxide particles include “MZ-305S” (manufactured by Tayca Corporation). The metal oxide particles usable in the present invention are not limited thereto.

A content of the metal oxide particles in at least one protective layer (outermost layer) of the present electrophotographic photoreceptor is not particularly limited. The content is preferably 10 parts by mass or more, more preferably 20 parts by mass or more, and particularly preferably 30 parts by mass or more with respect to 100 parts by mass of the binder resin, from the viewpoint of the electrical characteristics. The content is preferably 300 parts by mass or less, more preferably 200 parts by mass or less, and particularly preferably 100 parts by mass or less, from the viewpoint of maintaining good surface resistance.

A content of the metal oxide particles in the protective layer (the outermost layer) is preferably 300 parts by mass or less, more preferably 200 parts by mass or less, even more preferably 160 parts by mass or less, and still more preferably 120 parts by mass or less with respect to 100 parts by mass of the polymer contained in the protective layer (the outermost layer), from the viewpoint of maintaining surface charge. On the other hand, the content is preferably 20 parts by mass or more, more preferably 60 parts by mass or more, and even more preferably 80 parts by mass or more, from the viewpoint of the electrical characteristics.

[Polymerization Initiator]

Examples of the polymerization initiator include a thermal polymerization initiator and a photopolymerization initiator.

Examples of the thermal polymerization initiator include peroxide-based compounds such as 2,5-dimethylhexane-2,5-dihydroperoxide, and azo-based compounds such as 2,2′-azobis(isobutyronitrile).

The photopolymerization initiator can be classified into a direct cleavage type and a hydrogen abstraction type depending on a difference in a radical generation mechanism. The direct cleavage type photopolymerization initiator generates a radical by partly cleaving a covalent bond in one molecule thereof upon absorption of light energy. On the other hand, in the hydrogen abstraction type photopolymerization initiator, a molecule in a state of being excited by absorbing light energy abstracts hydrogen from a hydrogen donor to generate a radical.

Examples of the direct cleavage type photopolymerization initiator include: acetophenone-based or ketal-based compounds such as acetophenone, 2-benzoyl-2-propanol, 1-benzoylcyclohexanol, 2,2-diethoxyacetophenone, benzyl dimethyl ketal, and 2-methyl-4′-(methylthio)-2-morpholinopropiophenone; benzoin ether-based compounds such as benzoin, benzoin methyl ether, benzoin ethyl ether, benzoin isobutyl ether, benzoin isopropyl ether, and O-tosyl benzoin; and acylphosphine oxide-based compounds such as diphenyl(2,4,6-trimethylbenzoyl)phosphine oxide, phenylbis(2,4,6-trimethylbenzoyl)phosphine oxide, and lithium phenyl(2,4,6-trimethylbenzoyl)phosphonate.

Examples of the hydrogen abstraction type photopolymerization initiator include: benzophenone-based compounds such as benzophenone, 4-benzoylbenzoic acid, 2-benzoylbenzoic acid, methyl 2-benzoylbenzoate, methyl benzoylformate, benzyl, p-anisyl, 2-benzoylnaphthalene, 4,4′-bis(dimethylamino)benzophenone, 4,4′-dichlorobenzophenone, and 1,4-dibenzoylbenzene; and anthraquinone-based or thioxanthone-based compounds such as 2-ethylanthraquinone, 2-isopropylthioxanthone, 2-chlorothioxanthone, 2,4-dimethylthioxanthone, 2,4-diethylthioxanthone, and 2,4-dichlorothioxanthone. Examples of other photopolymerization initiators include camphorquinone, 1-phenyl-1,2-propanedione-2-(o-ethoxycarbonyl)oxime, acridine-based compounds, triazine-based compounds, and imidazole-based compounds.

The photopolymerization initiator preferably has an absorption wavelength in a wavelength region of a light source used for light irradiation in order to efficiently absorb light energy to generate a radical. Among them, it is preferred to contain an acylphosphine oxide-based compound having an absorption wavelength on a relatively long wavelength side.

It is more preferred to use the acylphosphine oxide-based compound and the hydrogen abstraction type initiator in combination, from the viewpoint of supplementing the curability of the surface of the protective layer (the outermost layer).

A content proportion of the hydrogen abstraction type initiator to the acylphosphine oxide-based compound is not particularly limited. The content proportion is preferably 0.1 parts by mass or more with respect to 1 part by mass of the acylphosphine oxide-based compound from the viewpoint of supplementing surface curability, and is preferably 5 parts by mass or less from the viewpoint of maintaining internal curability.

In addition, a compound having a photopolymerization accelerating effect may be used alone or in combination with the photopolymerization initiator. Examples thereof include triethanolamine, methyldiethanolamine, ethyl 4-dimethylaminobenzoate, isoamyl 4-dimethylaminobenzoate, (2-dimethylamino)ethyl benzoate, and 4,4′-dimethylaminobenzophenone.

The polymerization initiator may be used alone or in combination of two or more kinds thereof. A content of the polymerization initiator is 0.5 parts by mass to 40 parts by mass, and preferably 1 part by mass to 20 parts by mass with respect to 100 parts by mass of a total content having radical polymerizability as a composition of the raw material forming the protective layer (the outermost layer). The polymerization initiator is consumed in the process of forming the protective layer (the outermost layer).

(Method for Forming Protective Layer (Outermost Layer))

Next, a method for forming the protective layer (the outermost layer) will be described.

The method for forming the protective layer (the outermost layer) is not particularly limited. For example, the protective layer (the outermost layer) can be formed by applying a coating liquid, which is obtained by dissolving a binder resin, a charge transport material, metal oxide particles, and other materials in a solvent or a coating liquid obtained by dispersing a binder resin, a charge transport material, metal oxide particles, and other materials in a dispersion medium.

The protective layer (the outermost layer) containing the polymer is formed by applying and polymerizing a coating liquid obtained by dissolving the above-described compounds, which are raw materials of the polymer, in a solvent.

Hereinafter, the solvent or dispersion medium used for forming the protective layer (the outermost layer), and the coating method will be described.

[Solvent Used in Coating Liquid for Forming Protective Layer (Outermost Layer)]

As the organic solvent used in the coating liquid for forming the protective layer (the outermost layer), any organic solvent can be used as long as it can dissolve the materials according to the present invention.

Specific examples thereof include: alcohols such as methanol, ethanol, propanol, and 2-methoxyethanol; ethers such as tetrahydrofuran, 1,4-dioxane, and dimethoxyethane; esters such as methyl formate and ethyl acetate; ketones such as acetone, methyl ethyl ketone, and cyclohexanone; aromatic hydrocarbons such as benzene, toluene, xylene, and anisole; chlorinated hydrocarbons such as dichloromethane, chloroform, 1,2-dichloroethane, 1,1,2-trichloroethane, 1,1,1-trichloroethane, tetrachloroethane, 1,2-dichloroprop ane, and trichlorethylene; nitrogen-containing compounds such as n-butylamine, isopropanolamine, diethylamine, triethanolamine, ethylenediamine, and triethylenediamine; and aprotic polar solvents such as acetonitrile, N-methylpyrrolidone, N,N-dimethylformamide, and dimethylsulfoxide. A solvent mixture of these organic solvents in any combination and in any proportion can also be used.

Even an organic solvent that does not dissolve the materials for the protective layer (the outermost layer) according to the present invention by itself can be used as long as the materials can be dissolved in the solvent mixture with the organic solvent.

In general, when a solvent mixture is used, coating unevenness can be reduced. When a dip coating method is used in the coating method to be described later, it is preferred to select a solvent that does not dissolve a lower layer. From this viewpoint, it is preferred to contain alcohols having low solubility in polycarbonates and polyarylates that are suitably used in the photosensitive layer.

An amount ratio of the organic solvent used in the coating liquid for forming the protective layer (the outermost layer) to a solid content varies depending on the coating method of the coating liquid for forming the protective layer (the outermost layer), and may be appropriately changed and used such that a uniform coating film is formed in the coating method to be applied.

[Coating Method]

The coating method of the coating liquid for forming the protective layer (the outermost layer) is not particularly limited. Examples thereof include a spray coating method, a spiral coating method, a ring coating method, and a dip coating method.

After a coating film is formed by the above coating method, the coating film is dried. At this time, a drying temperature and a drying time are not limited as long as necessary and sufficient drying can be obtained. In the case where the protective layer (the outermost layer) is applied only by air drying after the photosensitive layer is coated, it is preferred to dry sufficiently by the method described in [Coating Method] of the photosensitive layer.

As for a thickness of the protective layer (the outermost layer), an optimum thickness is appropriately selected depending on the material to be used and the like. The thickness is preferably 0.1 μm or more, more preferably 0.2 μm or more, and particularly preferably 0.5 μm or more, from the viewpoint of life. The thickness is preferably 10 μm or less, more preferably 5 μm or less, and particularly preferably 3 μm or less, from the viewpoint of the electrical characteristics. [Method for Curing Protective Layer (Outermost Layer)]

The protective layer (the outermost layer) is formed by applying such a coating liquid and then curing the coating liquid by externally applying energy. The external energy used at this time includes heat, light, and radiation. Heat energy can be applied by heating from a coating surface side or a support side using gas such as air and nitrogen, steam, various heat media, infrared rays, or electromagnetic waves.

A heating temperature is preferably 100° C. or higher and 170° C. or lower. When the heating temperature is equal to or higher than the lower limit temperature, the reaction rate is sufficient and the reaction proceeds completely. When the heating temperature is equal to or lower than the upper limit temperature, the reaction proceeds uniformly, and the generation of large strain in the protective layer (the outermost layer) can be prevented. In order to proceed the curing reaction uniformly, a method of heating at a relatively low temperature of lower than 100° C. and then further heating to 100° C. or higher to complete the reaction is also effective.

As light energy, an ultraviolet (UV) irradiation light source such as a high-pressure mercury lamp, a metal halide lamp, an electrodeless lamp bulb, or a light emitting diode having an emission wavelength mainly for UV can be used, and a visible light source can be selected according to an absorption wavelength of the chain polymerizable compound or the photopolymerization initiator.

A light emitting amount is preferably 0.1 J/cm² or more, more preferably 1 J/cm² or more, and particularly preferably 10 J/cm² or more, from the viewpoint of the curability. The light emitting amount is preferably 200 J/cm² or less, more preferably 100 J/cm² or less, and particularly preferably 50 J/cm² or less, from the viewpoint of the electrical characteristics.

Examples of radiation energy include those using an electron beam (EB).

Among the energy, light energy is preferred from the viewpoint of ease of reaction rate control, simplicity of apparatus, and length of pot life.

After the protective layer (the outermost layer) is cured, a heating step may be added from the viewpoint of alleviating residual stress, alleviating residual radicals, and improving the electrical characteristics. A heating temperature is preferably 60° C. or higher, and more preferably 100° C. or higher, and is preferably 200° C. or lower, and more preferably 150° C. or lower.

<Undercoat Layer>

The present electrophotographic photoreceptor may include an undercoat layer between the photosensitive layer and the conductive support.

As the undercoat layer, for example, a resin or a resin with an organic pigment or metal oxide particles dispersed therein can be used.

Examples of the organic pigment to be used in the undercoat layer are not particularly limited. For example, a phthalocyanine pigment and an azo pigment used as the above charge generation material can be used.

Examples of the metal oxide particles to be used in the undercoat layer include metal oxide particles containing one metal element such as titanium oxide, aluminum oxide, silicon oxide, zirconium oxide, zinc oxide, and iron oxide, and metal oxide particles containing a plurality of metal elements such as calcium titanate, strontium titanate, and barium titanate. As for the undercoat layer, only one kind of particles may be used, or a plurality of kinds of particles may be mixed and used in any ratio and in any combination.

Among the metal oxide particles, titanium oxide and aluminum oxide are preferred, and titanium oxide is particularly preferred. The surface of the titanium oxide particles may be treated with, for example, an inorganic compound or an organic compound.

A particle diameter of the metal oxide particles to be used in the undercoat layer is not particularly limited. In terms of characteristics of the undercoat layer and stability of the solution for forming the undercoat layer, an average primary particle diameter of the metal oxide particles is preferably 10 nm or more, and is preferably 100 nm or less, and more preferably 50 nm or less.

Here, the undercoat layer is preferably formed by dispersing particles in a binder resin. The binder resin to be used in the undercoat layer can be selected from insulating resins such as a polyvinyl butyral resin, a polyvinyl formal resin, a polyvinyl acetal resin, a polyarylate resin, a polycarbonate resin, a polyester resin, a phenoxy resin, an acrylic resin, a methacrylic resin, a polyamide resin, a polyurethane resin, an epoxy resin, a silicone resin, a polyvinyl alcohol resin, a styrene-alkyd resin, a silicone-alkyd resin, and a phenol-formaldehyde resin, but is not limited to these polymers. The binder resin may be used alone, may be used in combination of two or more kinds thereof, or may be used in a form of being cured together with a curing agent. Among them, a polyvinyl butyral resin, a polyvinyl formal resin, a polyvinyl acetal resin, and a polyamide resin are preferred because of exhibiting good dispersibility and coatability.

A mixing ratio of the particles to the binder resin can be freely selected, and among them, it is preferred to use the particles in a range of 10 mass % to 500 mass % in terms of stability and coatability of the dispersion liquid.

A thickness of the undercoat layer may be freely selected, and among them, the thickness is generally preferably 0.1 μm or more and 20 μm or less from the viewpoint of the characteristics of the electrophotographic photoreceptor and the coatability of the dispersion liquid. In addition, the undercoat layer may contain a known antioxidant or the like.

<Other Layers>

The present electrophotographic photoreceptor may include other layers as necessary in addition to the conductive support, the photosensitive layer, the protective layer (the outermost layer), and the undercoat layer described above.

<<Electrophotographic Photoreceptor Cartridge>>

An electrophotographic photoreceptor cartridge according to the present invention includes the electrophotographic photoreceptor.

As for other configurations of the electrophotographic photoreceptor cartridge, known ones in the related art can be used by known methods. For example, at least one device selected from the group consisting of an electrophotographic photoreceptor, a charging device that charges the electrophotographic photoreceptor, an exposure device that exposes the charged electrophotographic photoreceptor to form an electrostatic latent image, and a developing device that develops the electrostatic latent image formed on the electrophotographic photoreceptor is provided.

<<Image Forming Apparatus>>

An image forming apparatus according to the present invention includes the electrophotographic photoreceptor.

As for other configurations of the image forming apparatus, known ones in the related art can be used by known methods. For example, an electrophotographic photoreceptor, a charging device that charges the electrophotographic photoreceptor, an exposure device that exposes the charged electrophotographic photoreceptor to form an electrostatic latent image, and a developing device that develops the electrostatic latent image formed on the electrophotographic photoreceptor are provided.

<<Description of Phrases>>

In the present invention, unless otherwise specified, “X to Y” (X and Y are any numbers) includes a meaning of “X or more and Y or less”, and also includes a meaning of “preferably larger than X” or “preferably smaller than Y”.

In addition, “X or more” (X is any number) or “Y or less” (Y is any number) also includes an intention of “preferably larger than X” or “preferably smaller than Y”.

### EXAMPLES

The present invention will be further described with reference to the following Examples. However, Examples are not intended to limit the present invention by any method.

In addition, “part” in the following Examples and Comparative Examples indicates “part by mass” unless otherwise specified.

### Production Example 1: Production of Compound (1-1)

To a 200 mL four neck reaction vessel were weighed adipic acid (2.15 g) and pentaerythritol (10.00 g), and were added toluene (30.00 g), acrylic acid (22.23 g), hydroquinone (0.05 g), p-toluenesulfonic acid monohydrate (1.58 g), and copper (II) chloride (0.05 g). The temperature was increased to cause a reflux state, and stirring was continued for 4 hours while water generated together with the progress of the reaction was distilled off, followed by cooling to 60° C. and adding 50 mL of water. An organic layer was separated, washed twice with a 0.1 N aqueous sodium hydroxide solution (50 mL), then washed with a 0.05 N aqueous hydrochloric acid solution (50 mL), and further washed twice with desalted water (50 mL). To the obtained organic layer, 4-methoxyphenol (2 mg) was added, and the mixture was concentrated under reduced pressure to obtain 23.43 g of a reaction product containing the above compound (1-1) as a yellow oil.

The reaction product was analyzed by gel permeation chromatography (GPC) to find that number average molecular weight (Mn)=745, mass average molecular weight (Mw)=1086, and Mw/Mn=1.459.

Incidentally, a polymer of the compound (1-1) is the polymer according to the first, second, third, fourth, or fifth embodiment.

### Production Example 2: Production of Compound (1-2)

In the same manner as in Production Example 1 except that azelaic acid (2.76 g) was used instead of the adipic acid used in Production Example 1, 23.48 g of a reaction product containing the compound (1-2) was obtained as a yellow oil.

The reaction product was analyzed by GPC to find that Mn=768, Mw=1262, and Mw/Mn=1.643.

Incidentally, a polymer of the compound (1-2) is the polymer according to the first, second, third, fourth, or fifth embodiment.

### Production Example 3: Production of Compound (1-3)

In the same manner as in Production Example 1 except that sebacic acid (2.97 g) was used instead of the adipic acid used in Production Example 1, 26.28 g of a reaction product containing the compound (1-3) was obtained as a yellow oil.

The reaction product was analyzed by GPC to find that Mn=764, Mw=1280, and Mw/Mn=1.675.

Incidentally, a polymer of the compound (1-3) is the polymer according to the first, second, third, fourth, or fifth embodiment.

### Production Example 4: Production of Compound (1-4)

In the same manner as in Production Example 1 except that tetradecanedioic acid (3.80 g) was used instead of the adipic acid used in Production Example 1, 26.62 g of a reaction product containing the compound (1-4) was obtained as a yellow oil.

The reaction product was analyzed by GPC to find that Mn=765, Mw=1330, and Mw/Mn=1.739.

Incidentally, a polymer of the compound (1-4) is the polymer according to the first, second, third, fourth, or fifth embodiment.

### Production Example 5: Production of Compound (1-5)

In the same manner as in Production Example 1 except that 1,4-cyclohexanedicarboxylic acid (2.53 g) was used instead of the adipic acid used in Production Example 1, 24.08 g of a reaction product containing the compound (1-5) was obtained as a yellow oil.

The reaction product was analyzed by GPC to find that Mn=752, Mw=1080, and Mw/Mn=1.436.

Incidentally, a polymer of the compound (1-5) is the polymer according to the first, second, third, fourth, or fifth embodiment. [Production Example 6: Production of Compound (1-6)]

In the same manner as in Production Example 1 except that trimethylolethane (2.53 g) was used instead of the pentaerythritol used in Production Example 1 and adipic acid (2.92 g), toluene (36.00 g), acrylic acid (23.03 g), hydroquinone (0.06 g), p-toluenesulfonic acid monohydrate (1.61 g), and copper (II) chloride (0.06 g) were used, 27.29 g of a reaction product containing the compound (1-6) was obtained as a yellow oil.

The reaction product was analyzed by GPC to find that Mn=537, Mw=675, and Mw/Mn=1.257.

Incidentally, a polymer of the compound (1-6) is the polymer according to the first, second, third, fourth, or fifth embodiment.

### Production Example 7: Production of Compound (2)

Isophthalic acid chloride (manufactured by Tokyo Chemical Industry Co., Ltd.) (5.00 g) and pentaerythritol triacrylate (57% triester) (trade name: NK Ester A-TMM-3LM-N, manufactured by Shin-Nakamura Chemical Co, Ltd.) (22.04 g) were weighed into a 200 mL four-neck reaction vessel and dissolved in toluene (90 mL). Subsequently, a mixed solution of triethylamine (7.48 g) and toluene (10 mL) was added dropwise over 20 minutes to the reaction vessel cooled to 0° C. to 5° C. After the reaction temperature was brought to room temperature and stirring was continued for 5 hours, 0.1 N hydrochloric acid (80 mL) was added to perform acid washing. Next, an organic layer was separated, the organic layer was washed twice with 0.1 N hydrochloric acid (80 mL), and further washed twice with desalted water (80 mL). Thereafter, 1 mg of 4-methoxyphenol was added to the separated organic layer, and the mixture was concentrated to obtain a reaction product containing the following compound (2).

A chemical structure of the compound (2) is as follows.

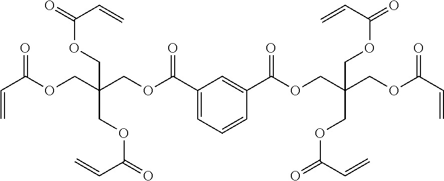 [SMILES: C=CC(=O)OCC(COC(=O)C=C)(COC(=O)C=C)COC(=O)c1cccc(C(=O)OCC(COC(=O)C=C)(COC(=O)C=C)COC(=O)C=C)c1]

<Preparation of Multi-layered Photoreceptor>

A multi-layered photoreceptor was prepared by the following procedure.

(Formation of Undercoat Layer)

A surface-treated titanium oxide, which was obtained by use a Henschel mixer to mix rutile-type titanium oxide having an average primary particle diameter of 40 nm (“TTO55N” manufactured by Ishihara Sangyo Kaisha, Ltd.) and 3 mass % of methyldimethoxysilane (“TSL⁸¹¹⁷” manufactured by Toshiba Silicone Co., Ltd.) with respect to the titanium oxide, was dispersed in a methanol solvent by a bead mill to obtain a dispersion slurry of the surface-treated titanium oxide.

The dispersion slurry, a solvent mixture of methanol/1-propanol/toluene, and pellets of a copolyamide having a composition molar ratio of ε-caprolactam/bis(4-amino-3-methylcyclohexyl)methane/hexamethylenediamine/decamethylenedicarboxylic acid/octadecamethylenedicarboxylic acid of 60%/15%/5%/15%/5% were stirred and mixed while heating to dissolve the polyamide pellets, followed by a ultrasonic dispersion treatment.

In this manner, a coating liquid for an undercoat layer containing methanol/1-propanol/toluene in a mass ratio of 7/1/2 and surface-treated titanium oxide/copolyamide in a mass ratio of 3/1 and having a solid content concentration of 18.0% was prepared.

On a cylinder (a conductive support) made of an aluminum alloy having an outer diameter of 30 mm, a length of 254 mm, and a wall thickness of 0.75 mm, the coating liquid was dip-coated such that a film thickness after drying was 1.5 μm, followed by air drying to form an undercoat layer.

(Formation of Charge Generation Layer)

As a charge generation material, 20 parts of D-form titanyl phthalocyanine exhibiting a clear peak at a diffraction angle 2θ±0.2° of 27.3° in powder X-ray diffraction using CuKα rays and 280 parts of 1,2-dimethoxyethane were mixed with each other, and the mixture was pulverized with a sand grind mill for 2 hours to be subjected to an atomization dispersion treatment. Subsequently, 400 parts of a 2.5% 1,2-dimethoxyethane solution of polyvinyl butyral (trade name “DENKA BUTYRAL” #6000C manufactured by Denki Kagaku Kogyo Co., Ltd.) and 170 parts of 1,2-dimethoxyethane were mixed to prepare a coating liquid for a charge generation layer.

On the undercoat layer, the coating liquid was dip-coated such that a film thickness after drying was 0.4 μm, followed by air drying to form a charge generation layer.

(Formation of Charge Transport Layer)

75 parts of a hole transport material 1 having the following structure, 100 parts of a binder resin¹ having the following structure, 4 parts of an antioxidant 1 having the following structure, and 0.05 parts of silicone oil (“KF-96” manufactured by Shin-Etsu Chemical Co., Ltd.) as a leveling agent were mixed with 616 parts of a solvent mixture of tetrahydrofuran (hereinafter, appropriately abbreviated as THF) and toluene (hereinafter, appropriately abbreviated as TL) (THF: 80 mass %, and TL: 20 mass %) to prepare a coating liquid for a charge transport layer.

A chemical structure of the hole transport material 1 is shown below.

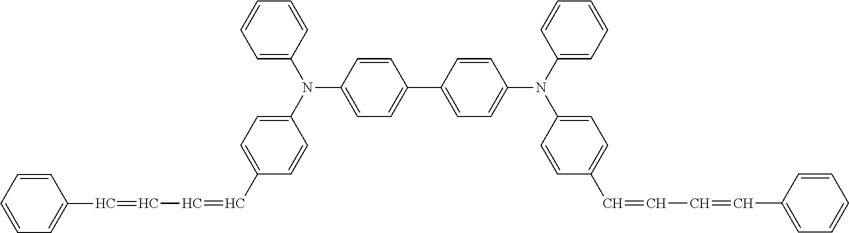 [SMILES: C(C=Cc1ccc(N(c2ccccc2)c2ccc(-c3ccc(N(c4ccccc4)c4ccc(C=CC=Cc5ccccc5)cc4)cc3)cc2)cc1)=Cc1ccccc1]

On the charge generation layer, the coating liquid was dip-coated such that a film thickness after drying was about 30 μm, followed by drying at 125° C. for 24 minutes to form a charge transport layer.

Binder resin¹: viscosity average molecular weight: 45,700

The binder resin¹ has the following chemical structure.

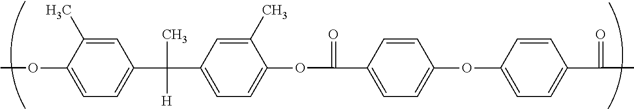

A chemical structure of the antioxidant 1 is as follows.

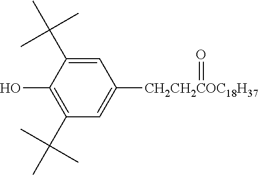

### Example 1

<Formation of Protective Layer>

100 parts of the reaction product obtained in Production Example 1, 55 parts of titanium oxide particles (“TT055N” manufactured by Ishihara Sangyo Kaisha, Ltd.) surface-treated with 7 mass % of 3-methacryloyloxypropyltrimethoxysilane with respect to particles, 1 part of benzophenone as a photopolymerization initiator, 2 parts of diphenyl(2,4,6-trimethylbenzoyl)phosphine oxide were mixed with 720 parts of a solvent mixture of methanol, 1-propanol, and toluene (methanol: 70 mass %, 1-propanol: 10 mass %, toluene: 20 mass %) to prepare a coating liquid for a protective layer.

On the charge transport layer of the multi-layered photoreceptor prepared as described above, the coating liquid was dip-coated such that a film thickness after curing was about 1 μm. UV light was emitted from a surface side of the coating film using a UV light emission device equipped with a UV-LED lamp having a peak wavelength at 385 nm so as to obtain an accumulated light amount of 30 J/cm² to polymerize the reaction product obtained in Production Example 1. Further, after heating at 125° C. for 5 minutes, the coating film is cooled to 25° C. to form a protective layer, thereby obtaining a multi-layered photoreceptor (a sample) having the protective layer as an outermost layer.

### Examples 2 to 7 and Comparative Examples 1 to 6

Multi-layered photoreceptors (samples) having a protective layer were obtained in the same manner as in Example 1 except that compounds to be used and a part by mass of the titanium oxide particles were changed as shown in Table 1, instead of 100 parts of the reaction product obtained in Production Example 1.

<Preparation of Single-layered Photoreceptor>

A single-layered photoreceptor was prepared by the following procedure.

(Formation of Undercoat Layer)

20 parts of D-form titanyl phthalocyanine exhibiting a clear peak at a diffraction angle 2θ±0.2° of 27.3° in powder X-ray diffraction using CuKα rays and 280 parts of 1,2-dimethoxyethane were mixed with each other, and the mixture was pulverized with a sand grind mill for 2 hours to be subjected to an atomization dispersion treatment. Subsequently, 400 parts of a 2.5% 1,2-dimethoxyethane solution of polyvinyl butyral (trade name “DENKA BUTYRAL” #6000C manufactured by Denki Kagaku Kogyo Co., Ltd.) and 170 parts of 1,2-dimethoxyethane were mixed to prepare a coating liquid for an undercoat layer.

On a cylinder (a conductive support) made of an aluminum alloy having an outer diameter of 30 mm, a length of 244 mm, and a wall thickness of 0.75 mm, the coating liquid was dip-coated such that a film thickness after drying was 0.4 μm, followed by air drying to form an undercoat layer.

(Formation of Single-layered Photosensitive Layer)

2.6 parts of D-form titanyl phthalocyanine exhibiting a clear peak at a diffraction angle 2θ±0.2° of 27.3° in powder X-ray diffraction using a CuKα ray, 1.3 parts of a perylene pigment 1 having the following structure, 100 parts of a hole transport material 2 having the following structure, 60 parts of the electron transport material represented by ET-2, 100 parts of a binder resin² having the following structure, and 0.05 parts of silicone oil (“KF-96” manufactured by Shin-Etsu Chemical Co., Ltd.) as a leveling agent were mixed with 792 parts of a solvent mixture (THF: 80 mass %, and TL: 20 mass %) to prepare a coating liquid for a single-layered photosensitive layer.

On the undercoat layer, the coating liquid was dip-coated such that a film thickness after drying was about 30 μm, followed by drying at 100° C. for 24 minutes to form a single-layered photosensitive layer.

A chemical structure of the hole transport material 2 is shown below.

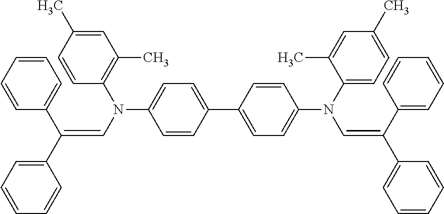 [SMILES: Cc1ccc(N(C=C(c2ccccc2)c2ccccc2)c2ccc(-c3ccc(N(C=C(c4ccccc4)c4ccccc4)c4ccc(C)cc4C)cc3)cc2)c(C)c1]

A chemical structure of the perylene pigment 1 is as follows.

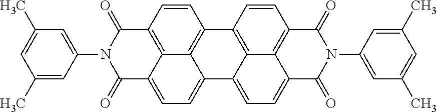 [SMILES: Cc1cc(C)cc(N2C(=O)c3ccc4c5ccc6c7c(ccc(c8ccc(c3c48)C2=O)c75)C(=O)N(c2cc(C)cc(C)c2)C6=O)c1]

Binder resin²: viscosity average molecular weight: 49,400

The binder resin² has the following chemical structure.

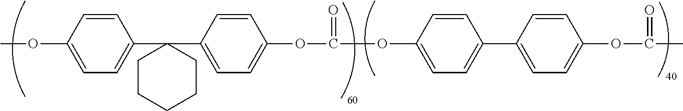

### Examples 8 to 10 and Comparative Example 7

Single-layered photoreceptors (samples) having a protective layer were obtained in the same manner as in Example 1 except that the single-layered photoreceptor was used instead of the multi-layered photoreceptor, compounds to be used and a part by mass of the titanium oxide particles were changed as shown in Table 1, instead of 100 parts of the reaction product obtained in Production Example 1.

<Measurement of Martens Hardness and Elastic Deformation Ratio of Photosensitive Layer>

A multi-layered photoreceptor (a sample) without a protective layer was obtained in the same manner as in Example 1 except that the protective layer was not formed. A single-layered photoreceptor (a sample) without a protective layer was obtained in the same manner as in Example 9 except that the protective layer was not formed.

Next, a Martens hardness and an elastic deformation ratio of the multi-layered photosensitive layer and the single-layered photosensitive layer used in Examples were measured using the multi-layered photoreceptor (the sample) without a protective layer and the single-layered photoreceptor (the sample) without a protective layer by the above methods.

As a result, the multi-layered photosensitive layer had a Martens hardness of 195 N/mm² and an elastic deformation ratio of 43%, and the single-layered photosensitive layer had a Martens hardness of 234 N/mm² and an elastic deformation ratio of 41%.

<Measurement of Martens Hardness and Elastic Deformation Ratio of Photoreceptor Surface>

With respect to the multi-layered photoreceptor (the sample) and the single-layered photoreceptor (the sample) having the protective layer (the outermost layer) and prepared as described above, a Martens hardness and an elastic deformation ratio of the photoreceptor surface were measured in the same manner as in the measurement of the Martens hardness and the elastic deformation ratio of the photosensitive layer. The measurement results are shown in Table 1.

In the present invention, a case where the Martens hardness of the photoreceptor surface was 240 N/mm² or more was evaluated as “acceptable (◯)”, a case where the Martens hardness was less than 240 N/mm² was evaluated as “unacceptable (X)”, a case where the elastic deformation ratio of the photoreceptor surface was 40% or more was evaluated as “acceptable (◯)”, and a case where the elastic deformation ratio of the photoreceptor surface was less than 40% was evaluated as “unacceptable (X)”.

<Measurement of Glass Transition Temperature of Photosensitive Layer>

A multi-layered photoreceptor (a sample) without a protective layer was obtained in the same manner as in Example 1 except that the protective layer was not formed. A single-layered photoreceptor (a sample) without a protective layer was obtained in the same manner as in Example 9 except that the protective layer was not formed.

Next, the surface of the multi-layered photoreceptor (the sample) without a protective layer was cut with a cutter, and a photosensitive layer was peeled from the undercoat layer to obtain a sample for measuring a glass transition temperature of the multi-layered photosensitive layer. Similarly, the surface of the single-layered photoreceptor (the sample) without a protective layer was cut with a cutter, and a photosensitive layer was peeled from the undercoat layer to obtain a sample for measuring a glass transition temperature of the single-layered photosensitive layer.

The glass transition temperature measurement samples of the multi-layered photosensitive layer and the single-layered photosensitive layer were subjected to differential scanning calorimetry measurement (DSC measurement). Measurement conditions were set as follows, and the glass transition temperature was determined from a DSC chart obtained by heating once, then rapidly cooling, and heating again.

<Measurement Conditions>

Measurement device: DSC-60 manufactured by Shimadzu Corporation

Temperature range: 30° C. to 150° C.

Temperature increase rate: 10° C./min

Atmosphere: N₂ flow (50 mL/min)

As a result of the measurement, the glass transition temperature of the multi-layered photosensitive layer was 100° C., and the glass transition temperature of the single-layered photosensitive layer was 83° C.

<Electrical Characteristic Test>

Each of the photoreceptors (the samples) obtained in Examples and Comparative Examples was mounted on an electrophotographic characteristic evaluation apparatus (described in Electrophotography: Bases and Applications, edited by The Society of Electrophotography of Japan, CORONA PUBLISHING CO., LTD, pp. 404-405) prepared according to the standards of the Society of Electrophotography of Japan, and subjected to electrical characteristic evaluation with cycles of charging, exposure, potential measurement, and charge elimination. Under an environment of a temperature of 25° C. and a relative humidity of 50%, the photoreceptor was charged so as to have an initial surface potential V0 of −700 V in the case of a multi-layered photoreceptor and of +700 V in the case of a single-layered photoreceptor, and was irradiated with monochromatic light having 780 nm and obtained from a halogen lamp with an interference filter, and the surface potential was measured at any exposure amount. At this time, a time from the exposure to the potential measurement was 60 milliseconds, and the surface potential after irradiation with 0.9 pJ/cm² was measured. In accordance with an absolute value of the obtained surface potential, the electrical characteristics were evaluated according to the following criteria. The results are shown in Table 1.

⊚: The absolute value of the surface potential is 40 or less.

◯: The absolute value of the surface potential is more than 40 and 50 or less.

Δ: The absolute value of the surface potential is more than 50 and 70 or less.

X: The absolute value of the surface potential is more than 70.

<Image Deletion Evaluation>

Each of the multi-layered photoreceptors (the samples) obtained in Examples and Comparative Examples was mounted on an electrophotographic printer (ML-6510ND, manufactured by Samsung), printing was performed under an environment of a temperature of 32° C. and a relative humidity of 80%, and an image was observed under normal temperature and normal humidity. A case where image deletion (image blur) was not observed at all was evaluated as “0”, a case where image deletion (image blur) was slightly observed was evaluated as “Δ”, a case where image deletion (image blur) was clearly observed was evaluated as “X”, and a case where image deletion (image blur) was remarkably observed was evaluated as “XX ”. A degree of the image deletion was evaluated in four levels of ◯/Δ/X/XX.

Next, each of the single-layered photoreceptors (the samples) obtained in Examples and Comparative Examples was mounted on an electrophotographic printer, and a degree of image deletion was evaluated in the same manner as in the case of the multi-layered photoreceptor (the sample). The results are shown in Table 1.

<Observation of Mixed Layer>

A cross section of each of the multi-layered photoreceptors (the samples) and the single-layered photoreceptors (the samples) obtained in Examples and Comparative Examples was observed using a scanning electron microscope (device name: ultra 55 manufactured by ZEISS) under the condition of an acceleration voltage of 3 kV.

It was observed whether a mixed layer of the protective layer and the charge transport layer or single-layered photosensitive layer was present at an interface between the two layers in the obtained image. The results are shown in Table 1.

A case where the mixed layer was not observed was evaluated as “◯ (very good)”, a case where the mixed layer was slightly observed was evaluated as “Δ (good)”, and a case where the mixed layer was clearly observed was evaluated as “X (poor)”.

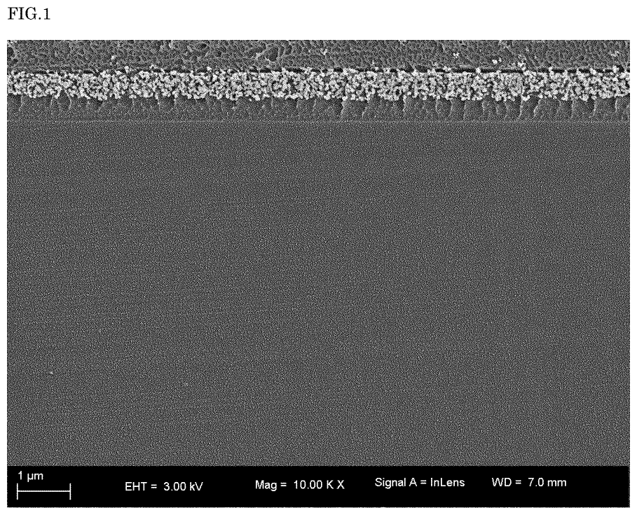

As an example of the observed image, a scanning electron microscopic image (SEM image) of the cross section of the multi-layered photoreceptor obtained in Comparative Example 4 is shown in FIG. 1. An upper part in FIG. 1 is a protective layer side.

<Comprehensive Evaluation>

A comprehensive evaluation of the electrical characteristics, the image deletion, and the Martens hardness and the elastic deformation ratio of the photoreceptor surface was evaluated according to the following criteria. In the present invention, a case where the comprehensive evaluation was “A” or “B” was evaluated as comprehensive “acceptable”.

A: Both of the electrical characteristics and the image deletion are evaluated as ◯ or ⊚, and the Martens hardness and the elastic deformation ratio of the photoreceptor surface are acceptable.

B: One of the electrical characteristics and the image deletion is evaluated as ◯ or ⊚, the other is evaluated as Δ, and the Martens hardness and the elastic deformation ratio of the photoreceptor surface are acceptable.

C: One of the electrical characteristics and the image deletion is evaluated as ◯ or ⊚, the other is evaluated as Δ, and at least one of the Martens hardness and the elastic deformation ratio of the photoreceptor surface is unacceptable.

D: Both of the electrical characteristics and the image deletion are evaluated as Δ (regardless of whether the Martens hardness and the elastic deformation ratio of the photoreceptor surface are acceptable).

E: At least one of the electrical characteristics and the image deletion is evaluated as X or XX (regardless of whether the Martens hardness and the elastic deformation ratio of the photoreceptor surface are acceptable).

TABLE 1

| | | Protective layer | | | | | | | | | |
|---|---|---|---|---|---|---|---|---|---|---|---|
| | | (outermost layer) | | | | | | | | | |
| | | | Metal | | | | | | | | |
| | | | oxide | Presence | | | | | | | |
| | | | particles | or absence | Electrical | | | | Elastic | | |
| | Photosensitive | | (part by | of mixed | characteristic | Image | Martens hardness | | deformation ratio | | Comprehensive |
| | layer | Polymer | mass) | layer | evaluation | deletion | (N/mm²) | Evaluation | | (%) Evaluation | evaluation |
| Example 1 | Multi-layered | Production | 55 | ◯ | ⊚ | ◯ | 338 | ◯ | 57 | ◯ | A |
| | | Example 1 | | | | | | | | | |
| Example 2 | Multi-layered | Production | 55 | ◯ | ⊚ | ◯ | 330 | ◯ | 51 | ◯ | A |
| | | Example 2 | | | | | | | | | |
| Example 3 | Multi-layered | Production | 55 | ◯ | ⊚ | ◯ | 318 | ◯ | 59 | ◯ | A |
| | | Example 3 | | | | | | | | | |
| Example 4 | Multi-layered | Production | 55 | ◯ | ⊚ | ◯ | 240 | ◯ | 47 | ◯ | A |
| | | Example 4 | | | | | | | | | |
| Example 5 | Multi-layered | Production | 55 | ◯ | ⊚ | ◯ | 353 | ◯ | 64 | ◯ | A |
| | | Example 5 | | | | | | | | | |
| Example 6 | Multi-layered | Production | 55 | Δ | Δ | ◯ | 261 | ◯ | 41 | ◯ | B |
| | | Example 6 | | | | | | | | | |
| Comparative | Multi-layered | UV6300B | 55 | ◯ | ⊚ | X | 323 | ◯ | 52 | ◯ | E |
| Example 1 | | | | | | | | | | | |
| Comparative | Multi-layered | Production | 55 | ◯ | Δ | Δ | 386 | ◯ | 55 | ◯ | D |
| Example 2 | | Example 7 | | | | | | | | | |
| Example 7 | Multi-layered | Production | 74 | ◯ | ⊚ | Δ | 376 | ◯ | 55 | ◯ | B |
| | | Example 2 | | | | | | | | | |
| Comparative | Multi-layered | UV6300B | 74 | ◯ | ⊚ | X X | 333 | ◯ | 55 | ◯ | E |
| Example 3 | | | | | | | | | | | |
| Comparative | Multi-layered | ABE300 | 74 | X | X | ◯ | 189 | X | 25 | X | E |
| Example 4 | | | | | | | | | | | |
| Comparative | Multi-layered | A-DCP | 74 | X | Δ | ◯ | 260 | ◯ | 35 | X | C |
| Example 5 | | | | | | | | | | | |
| Comparative | Multi-layered | A-BPEF | 74 | X | X | ◯ | 228 | X | 33 | X | E |
| Example 6 | | | | | | | | | | | |
| Example 8 | Single-layered | Production | 100 | ◯ | Δ | ◯ | 430 | ◯ | 46 | ◯ | B |
| | | Example 2 | | | | | | | | | |
| Example 9 | Single-layered | Production | 150 | ◯ | Δ | ◯ | 486 | ◯ | 51 | ◯ | B |
| | | Example 2 | | | | | | | | | |
| Example 10 | Single-layered | Production | 200 | ◯ | Δ | ◯ | 559 | ◯ | 52 | ◯ | B |
| | | Example 2 | | | | | | | | | |
| Comparative | Single-layered | UV6300B | 100 | ◯ | Δ | X | 422 | ◯ | 46 | ◯ | E |
| Example 7 | | | | | | | | | | | |

In Table 1, the polymers of Comparative Examples 1 to 5 and 7 were obtained by curing the following commercially available products, respectively.

UV6300B: urethane acrylate oligomer (manufactured by Mitsubishi Chemical Corporation)

ABE300: EO-modified bisphenol A diacrylate (manufactured by Shin-Nakamura Chemical Co, Ltd.)

A-DCP: tricyclodecanedimethanol diacrylate (manufactured by Shin-Nakamura Chemical Co, Ltd.)

A-BPEF: 9,9-bis[4-(2-acryloyloxyethoxy)phenyl]fluorene (manufactured by Shin-Nakamura Chemical Co, Ltd.)

<Measurement of Water Absorption Rate>

Water absorption rates of the reaction products obtained in Production Examples 1 to 7 and the commercially available acrylic monomers used in Comparative Examples were measured as follows.

100 parts of each of the reaction products obtained in Production Examples 1 to 7 or the commercially available acrylic monomers used in Comparative Examples, 1 part of benzophenone as a photopolymerization initiator, and 2 parts of diphenyl(2,4,6-trimethylbenzoyl)phosphine oxide were mixed under stirring.

The obtained mixture was formed into a film on a glass plate to obtain a coating film having a thickness of 200 μm. The surface of the coating film was irradiated with UV light using a UV light emission device equipped with a UV-LED lamp having a peak wavelength at 385 nm so as to obtain an accumulated light amount of 30 J/cm² to obtain a polymerization reaction product. The obtained polymerization reaction product was peeled off from the glass plate and pulverized to obtain a sample for water absorption rate measurement.

A value obtained according to the following equation was defined as the water absorption rate, where X (g) was a weight of the sample for water absorption measurement in an environment of a temperature of 25° C. and a relative humidity of 50%, and Y (g) was a weight after standing still in an environment of a temperature of 32° C. and a relative humidity of 80% for two days and nights. The results are shown in Table 2.

Water absorption rate (%)=100×[(Y−X)/X]

TABLE 2

| | Water absorption rate (%) |
|---|---|
| Production Example 1 | 1.1 |
| Production Example 2 | 0.7 |
| Production Example 3 | 0.8 |
| Production Example 4 | 1.1 |
| Production Example 5 | 1.2 |
| Production Example 6 | 1.4 |
| Production Example 7 | 1.7 |
| UV6300B | 2.3 |
| ABE300 | 1.0 |
| A-DCP | 0.8 |
| A-BPEF | 0.5 |

### Discussion

From the above Examples and Comparative Examples and the results of the tests conducted by the present inventor, the following was found.

It is presumed that, in the related-art photoreceptor including the protective layer containing the cured product of a (meth)acrylic monomer as the outermost layer as in Comparative Examples, when the acrylic resin portion in the protective layer absorbs moisture, the hydrogen ions or the hydroxide ions forming water molecules increase the ion conductivity and decrease the surface resistance of the photoreceptor, and accordingly, the charges in the unexposed portion of the photoreceptor surface move and the contrast between the exposed portion and the unexposed portion decreases, resulting in deletion of the electrostatic latent image formed by the charges (image blur).

As a means for preventing such image deletion, it is considered to select and use a monomer having a low hygroscopic (meth)acrylic monomer structure, for example, a structure with a bonded substituent having a (meth)acryloyl group, and it is presumed that when a monomer having a high affinity for the low hygroscopic structure and the components in the photosensitive layer is selected and used among the monomers having such a structure, a mixed layer is formed between the two layers, the charge transport from the photosensitive layer to the protective layer is inhibited, and the electrical characteristics may be deteriorated.

On the other hand, when the protective layer as the outermost layer has the hydrocarbon structure X selected from an alkylene structure, an alkenylene structure, and an alkynylene structure having low polarity, and a structure substituted with a structure having 2 to 3 (meth)acryloyl groups (referred to as the “formula (A) structure”), the polarity of the hydrocarbon structure X is low, so that even in a high-humidity environment, the moisture adsorption amount is reduced, and a decrease in resistance due to moisture absorption can be prevented. Therefore, it is considered that the movement of the charges in the unexposed portion of the photoreceptor surface can be prevented, the contrast between the exposed portion and the unexposed portion does not decrease, and the deletion of the electrostatic latent image can be prevented. At the same time, since the formula (A) structure is located around the hydrocarbon structure X to provide steric protection, the mixing of the polymer with the components contained in the photosensitive layer can be prevented, the formation of the mixed layer can be prevented, and the charge transport from the photosensitive layer to the protective layer can be sufficiently performed, so that the deterioration of the electrical characteristics can be prevented.

1. An electrophotographic photoreceptor comprising:
a conductive support; and
a photosensitive layer and a protective layer sequentially disposed on the conductive support, wherein
the protective layer comprises a polymer comprising a structure represented by formula (a),
A¹-L¹-X-L²-A² (a)
in which
X represents a hydrocarbon having 4 or more and 20 or less carbon atoms, wherein the hydrocarbon comprises an alkylene, an alkenylene, or an alkynylene,
L¹ and L² each independently represent —O—, —CO—, —O(C═O)—, —(C═O)—O—, or —O(C═O)O—, and
A¹ and A² each independently represent formula (A), 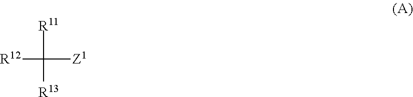
in which
R¹¹ to R¹³ are each independently a hydrogen atom, a hydrocarbon group, an alkoxy group, a methylol group, or a group represented by formula (2), with the proviso that at least two among R¹¹ to R¹³ have a structure represented by formula (2), and
Z¹ represents a bond to any atom in L¹ or L², 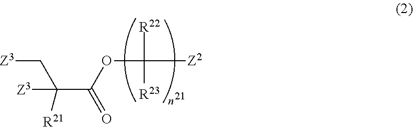
in which
R²¹ represents a hydrogen atom or a methyl group,
R²² and R²³ each independently represent a hydrogen atom, a hydrocarbon group, or an alkoxy group,
n²¹ represents an integer of 1 or more and 10 or less,
Z² represents a bond to a carbon atom to which R¹¹ to R¹³ in formula (A) are bonded, and
Z³ represents a bond to any atom.

2. An electrophotographic photoreceptor comprising:
a conductive support;
a photosensitive layer disposed on one surface of the conductive support; and
an outermost layer disposed on an opposite surface of the conductive support, wherein
the outermost layer comprises a polymer comprising a structure represented by formula (a),
A¹-L¹-X-L²-A² (a)
in which
X represents a hydrocarbon having 4 or more and 20 or less carbon atoms, wherein the hydrocarbon comprises an alkylene, an alkenylene, or an alkynylene,
L¹ and L² each independently represent —O—, —CO—, —O(C═O)—, —(C═O)—O—, or —O(C═O)O—, and
A¹ and A² each independently represent formula (A), 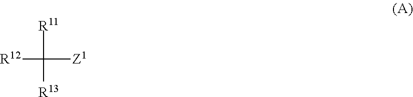
in which
R¹¹ to R¹³ are each independently a hydrogen atom, a hydrocarbon group, an alkoxy group, a methylol group, or a structure represented by formula (2), and
at least two among R¹¹ to R¹³ have a structure represented by formula (2), and
Z¹ represents a bond to any atom in L¹ or L², 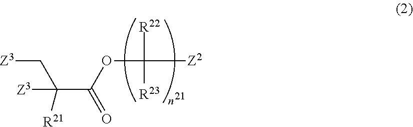
in which
R²¹ represents a hydrogen atom or a methyl group,
R²² and R²³ each independently represent a hydrogen atom, a hydrocarbon group, or an alkoxy group,
n²¹ represents an integer of 1 or more and 10 or less,
Z² represents a bond to a carbon atom to which R¹¹ to R¹³ in the formula (A) are bonded, and
Z³ represents a bond to any atom.

3. The electrophotographic photoreceptor according to claim 1, wherein
the polymer comprises a polymer of a compound represented by formula (a′),
A¹-L¹-X-L²-A² (a′)
in which
X represents a hydrocarbon having 4 or more and 20 or less carbon atoms, wherein the hydrocarbon comprises an alkylene structure, an alkenylene, or an alkynylene,
L¹ and L² each independently represent —O—, —CO—, —O(C═O)—, —(C═O)—O—, or —O(C═O)O—, and
A¹ and A² each independently represent by formula (A′), 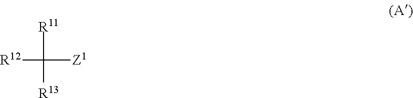
in which
R¹¹ to R¹³ each independently represent a hydrogen atom, a hydrocarbon group, an alkoxy group, a methylol group, or a group represented by formula (2′), with the proviso that at least two among R¹¹ to R¹³ have a structure represented by formula (2′), and
Z¹ represents a bond to any atom 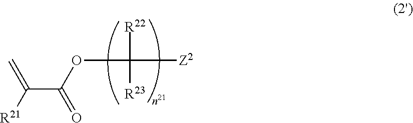
in which
R²¹ represents a hydrogen atom or a methyl group,
R²² and R²³ each independently represent a hydrogen atom, a hydrocarbon group, or an alkoxy group,
n²¹ represents an integer of 1 or more and 10 or less, and
Z² represents a bond to a carbon atom to which R¹¹ to R¹³ in formula (A′) are bonded.

4. An electrophotographic photoreceptor comprising:
a conductive support; and
a photosensitive layer and a protective layer sequentially disposed on the conductive support, wherein
the protective layer comprises a polymer comprising a partial structure represented by formula (b) and a partial structure represented by formula (A),
—CO—X—CO— (b)
in which
X represents a hydrocarbon having 4 or more and 20 or less carbon atoms, and the hydrocarbon comprises an alkylene, an alkenylene, or an alkynylene) 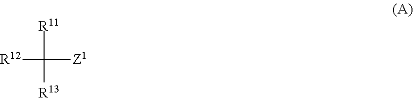
in which
R¹¹ to R¹³ are each independently a hydrogen atom, a hydrocarbon group, an alkoxy group, a methylol group, or a structure represented by formula (2), with the proviso that at least two among R¹¹ to R¹³ have a structure represented by formula (2), and
Z¹ represents a bond to any atom, 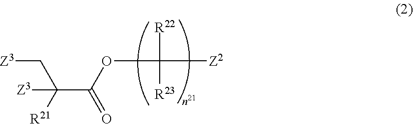
in which
R²¹ represents a hydrogen atom or a methyl group, R²² and R²³ each independently represent a hydrogen atom, a hydrocarbon group, or an alkoxy group, n²¹ represents an integer of 1 or more and 10 or less,
Z² represents a bond to a carbon atom to which R¹¹ to R¹³ in formula (A) are bonded, and
Z³ represents a bond to any atom.

5. An electrophotographic photoreceptor comprising:
a conductive support;
a photosensitive layer disposed on one surface of the conductive support; and
an outermost layer disposed on an opposite surface of the conductive support wherein
the outermost layer comprises a polymer comprising a partial structure represented by formula (b) and a partial structure represented by formula (A),
—CO—X—CO— (b)
in which
X represents a hydrocarbon having 4 or more and 20 or less carbon atoms, wherein the hydrocarbon comprises an alkylene, an alkenylene, or an alkynylene, 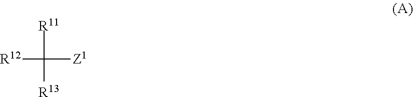
in which
R¹¹ to R¹³ are each independently a hydrogen atom, a hydrocarbon group, an alkoxy group, a methylol group, or a structure represented by formula (2), with the proviso that at least two among R¹¹ to R¹³ have a structure represented by formula (2), and
Z¹ represents a bond to any atom, 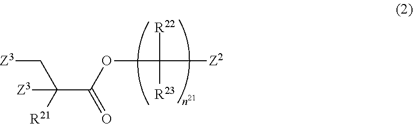
in which
R²¹ represents a hydrogen atom or a methyl group,
R²² and R²³ each independently represent a hydrogen atom, a hydrocarbon group, or an alkoxy group,
n²¹ represents an integer of 1 or more and 10 or less,
Z² represents a bond to a carbon atom to which R¹¹ to R¹³ in formula (A) are bonded, and
Z³ represents a bond to any atom.

6. The electrophotographic photoreceptor according to claim 4, wherein
the polymer comprises a polymer comprising the partial structure represented by formula (b) and a partial structure represented by formula (A′) in a same molecule, 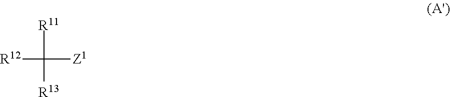
in which
R¹¹ to R¹³ each independently represent a hydrogen atom, a hydrocarbon group, an alkoxy group, a methylol group, or a structure represented by formula (2′), with the proviso that at least two among R¹¹ to R¹³ has a structure represented by formula (2′), and
Z¹ represents a bond to any atom, 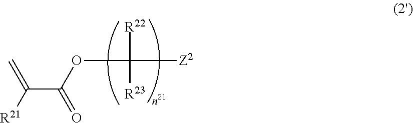
in which
R²¹ represents a hydrogen atom or a methyl group,
R²² and R²³ each independently represent a hydrogen atom, a hydrocarbon group, or an alkoxy group,
n²¹ represents an integer of 1 or more and 10 or less, and
Z² represents a bond to a carbon atom to which R¹¹ to R¹³ in formula (A′) are bonded.

7. An electrophotographic photoreceptor comprising:
a conductive support; and
a photosensitive layer and a protective layer sequentially disposed on the conductive support, wherein
the protective layer comprises a polymer comprising a partial structure X and a partial structure represented by formula (B), and
X represents a hydrocarbon having 4 or more and 20 or less carbon atoms, wherein the hydrocarbon comprises an alkylene, an alkenylene, or an alkynylene, 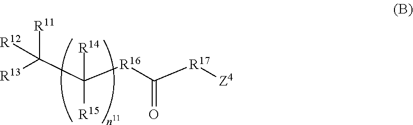
in which
R¹¹ to R¹³ each independently represent a hydrogen atom, a hydrocarbon group, an alkoxy group, a methylol group, a structure represented by formula (2), or a structure represented by formula (3), with the proviso that at least two among R¹¹ to R¹³ have a structure represented by formula (2) or a structure represented by formula (3),
R¹⁴ and R¹⁵ each independently represent a hydrogen atom, a hydrocarbon group, or an alkoxy group,
R¹⁶ is a single bond or an oxygen atom,
R¹⁷ is a single bond,
n¹¹ represents an integer of 1 or more and 10 or less, and
Z⁴ represents a bond to any atom, 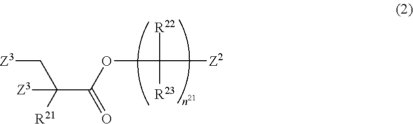
in which
R²¹ represents a hydrogen atom or a methyl group,
R²² and R²³ each independently represent a hydrogen atom, a hydrocarbon group, or an alkoxy group,
n²¹ represents an integer of 1 or more and 10 or less,
Z² represents a bond to a carbon atom to which R¹¹ to R¹³ in formula (B) are bonded, and
Z³ represents a bond to any atom, 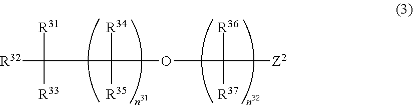
in which
R³¹ to R³³ each independently represent a hydrogen atom, a hydrocarbon group, an alkoxy group, a methylol group, or a structure represented by formula (2), with the proviso that at least two among R³¹ to R³³ have a structure represented by formula (2),
R³⁴ to R³⁷ each independently represent a hydrogen atom, a hydrocarbon group, or an alkoxy group,
n³¹ and n³² each independently represent an integer of 1 or more and 10 or less, and
Z² represents a bond to a carbon atom to which R¹¹ to R¹³ in formula (B) are bonded.

8. The electrophotographic photoreceptor according to of claim 1, wherein
the polymer comprises a structure represented by formula (1), 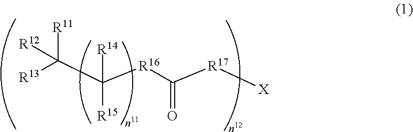
in which
X is a hydrocarbon having 4 or more and 20 or less carbon atoms, wherein the hydrocarbon is an alkylene, an alkenylene, or an alkynylene,
R¹¹ to R¹³ each independently represent a hydrogen atom, a hydrocarbon group, an alkoxy group, a methylol group, a structure represented by formula (2), or a structure represented by formula (3), with the proviso that at least two among R¹¹ to R¹³ have a structure represented by formula (2) or a structure represented by formula (3),
R¹⁴ and R¹⁵ each independently represent a hydrogen atom, a hydrocarbon group, or an alkoxy group,
R¹⁶ is a single bond or an oxygen atom,
R¹⁷ is a single bond,
n¹² is 2, and
n¹¹ represents an integer of 1 or more and 10 or less, 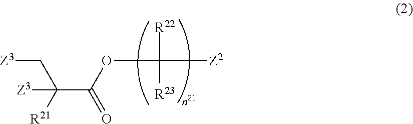
in which
R²¹ represents a hydrogen atom or a methyl group,
R²² and R²³ each independently represent a hydrogen atom, a hydrocarbon group, or an alkoxy group,
n²¹ represents an integer of 1 or more and 10 or less,
Z² represents a bond to a carbon atom to which R¹¹ to R¹³ in formula (1) are bonded, and
Z³ represents a bond to any atom, 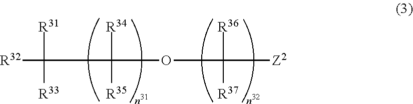
in which
R³¹ to R³³ each independently represent a hydrogen atom, a hydrocarbon group, an alkoxy group, a methylol group, or a structure represented by the formula (2), with the proviso that at least two among R³¹ to R³³ have a structure represented by formula (2),
R³⁴ to R³⁷ each independently represent a hydrogen atom, a hydrocarbon group, or an alkoxy group,
n³¹ and n³² each independently represent an integer of 1 or more and 10 or less, and
Z² represents a bond to a carbon atom to which R¹¹ to R¹³ in formula (1) are bonded.

9. The electrophotographic photoreceptor according to claim 1, wherein
all of R¹¹, R¹², and R¹³ have a structure represented by formula (2), 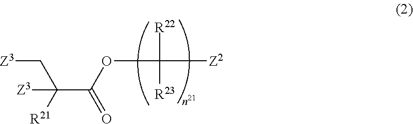
in which
R²¹ represents a hydrogen atom or a methyl group,
R²² and R²³ each independently represent a hydrogen atom, a hydrocarbon group, or an alkoxy group,
n²¹ represents an integer of 1 or more and 10 or less,
Z² represents a bond to a carbon atom to which RP to R¹³ in formula (A) are bonded, and
Z³ represents a bond to any atom.

10. The electrophotographic photoreceptor according to claim 3, wherein
all of R¹¹, R¹², and R¹³ have a structure represented by formula (2′), 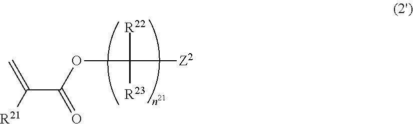
in which
R²¹ represents a hydrogen atom or a methyl group,
R²² and R²³ each independently represent a hydrogen atom, a hydrocarbon group, or an alkoxy group,
n²¹ represents an integer of 1 or more and 10 or less, and
Z² represents a bond to a carbon atom to which R¹¹ to R¹³ in formula (A′) are bonded.

11. The electrophotographic photoreceptor according to claim 1, wherein
X has 10 or less carbon atoms.

12. The electrophotographic photoreceptor according to claim 1, wherein
X is a chain structure including carbon atoms and hydrogen atoms.

13. An electrophotographic photoreceptor comprising:
a conductive support; and
a photosensitive layer and a protective layer sequentially disposed on the conductive support, wherein
the protective layer comprises a polymer obtained by polymerizing a reaction product of an aliphatic dicarboxylic acid or an aliphatic dicarboxylic acid chloride, a polyhydric alcohol, and at least one selected from the group consisting of acrylic acid, methacrylic acid, acrylic acid chloride, and methacrylic acid chloride.

14. The electrophotographic photoreceptor according to claim 1 or 2, wherein
the photosensitive layer in contact with the protective layer or the outermost layer comprises a charge transport material, and
a concentration of the charge transport material in the photosensitive layer is 30 mass % or more and 70 mass % or less with respect to a total mass of the photosensitive layer.

15. The electrophotographic photoreceptor according to claim 2, wherein
the photosensitive layer in contact with the protective layer or the outermost layer has a glass transition temperature of 50° C. or higher and 130° C. or lower.

16. The electrophotographic photoreceptor according to claim 1, wherein
the protective layer or the outermost layer is obtained by being cured by irradiation with ultraviolet light and/or visible light.

17. The electrophotographic photoreceptor according to claim 2, wherein
the protective layer or the outermost layer comprises metal oxide particles.

18. The electrophotographic photoreceptor according to claim 17, wherein
a content of the metal oxide particles in the protective layer or the outermost layer is 300 parts by mass or less with respect to 100 parts by mass of the polymer in the protective layer or the outermost layer.

19. The electrophotographic photoreceptor according to claim 1, wherein
the photosensitive layer is a multi-layered photosensitive layer.

20. An electrophotographic photoconductor cartridge comprising:
the electrophotographic photoconductor according to claim 1.

21. An image forming apparatus comprising:
the electrophotographic photoreceptor according to claim 1.
